(19) United States
(12) Patent Application Publication
(10) Pub. No.: US 2026/0184874 A1
(43) Pub. Date: Jul. 2, 2026

(54) SYSTEMS AND METHODS FOR MAKING AND USING SUPERABSORBENT POROUS GELS

(71) Applicant: University of Maryland, College Park, College Park, MD (US)

(72) Inventors: Srinivasa R. Raghavan, Columbia, MD (US); Hema Choudhary, Hyattsville, MD (US)

(21) Appl. No.: 18/812,268

(22) PCT Filed: Mar. 1, 2023
(86) PCT No.: PCT/US2023/063482

§ 371 Date: Aug. 22, 2024

Related U.S. Application Data
(60) Provisional application No. 63/268,741, filed on Mar. 1, 2022.
(60) Provisional application No. 63/386,092, filed on Dec. 5, 2022.
(60) Provisional application No. 63/487,462, filed on Feb. 28, 2023.

(51) Int. Cl. C08J 9/20; B01J 20/26; B01J 20/28; B01J 20/32; C08J 3/24; C08J 9/08; C08J 9/236

(52) U.S. Cl. CPC C08J 9/20; B01J 20/267; B01J 20/28045; B01J 20/28047; B01J 20/3282; C08J 3/242; C08J 9/08; C08J 9/236; C08J 2201/026; C08J 2203/06; C08J 2333/14; C08J 2405/00

(57) ABSTRACT

Superabsorbent and rapidly expanding porous gels can be made from the in situ foaming of a monomer solution (e.g., acrylic acid and acrylamide) using a double-barreled syringe having an acid and a base in respective barrels. Gas (e.g., CO₂) can be generated at the mixing tip of the syringe by the acid-base reaction, and gas bubbles may be stabilized by an amphiphilic polymer in one of the barrels. Monomers can be polymerized by ultraviolet (UV) light to form the gel around the bubbles, and the material can be dried under ambient conditions to yield a porous solid. A resulting gel can absorb water at an extremely high rate until equilibrium is achieved, for example, at ˜300 times its weight and/or at more than 3 times its size. Such expansion can be used to lift weight, in mechanical work, in new designs for mechano-chemical engines, in artificial muscles, etc.

### CROSS-REFERENCE TO RELATED APPLICATIONS

This application is a by-pass continuation of PCT/US2023/063482, filed Mar. 1, 2023, which claims priority under 35 U.S.C. § 119 to provisional patent application U.S. Ser. No. 63/268,741, titled “Systems and Methods for Making and Using Porous Gel Material with Sponge-like or Fabric-like Texture,” filed Mar. 1, 2022, provisional patent application U.S. Ser. No. 63/386,092, titled “Systems and Methods for Making and Using Superabsorbent Gel-sheets with Fabric-Like Flexibility,” filed Dec. 5, 2022, and provisional patent application U.S. Ser. No. 63/487,462, titled “Systems and Methods for Making and Using Fabric-Like Superabsorbent Materials,” filed Feb. 28, 2023. These patent applications are hereby incorporated by reference herein each in their respective entirety, including without limitation, the specification, claims, and abstract, as well as any figures, tables, appendices, or drawings thereof.

### TECHNICAL FIELD

The present disclosure generally relates to absorbent materials and, more particularly, to porous, gel materials with sponge-like and/or fabric-like textures.

### BACKGROUND

Materials that can absorb aqueous liquids (including blood) have been in use throughout the course of human history. Common absorbent materials include cloth towels (which are woven from natural or synthetic fibers) as well as paper towels, napkins or pads. These materials generally have a porous structure, which helps in imbibing water through capillary action. Sponges or fibrous mats are other classes of porous materials commonly used in homes or labs for absorbing spilled liquids. Absorbents also find use in healthcare (e.g., wound dressings made of gauze to mop up blood), see Chaturvedi et al., “Hydrophobically Modified Chitosan Gauze: A Novel Topical Hemostat.” J. Surg. Res. 2017, 207, 45-52, which hereby is incorporated by reference herein in its entirety, and in agriculture. Recently, new classes of porous materials have been developed as absorbents, and the technical names for these dry materials include aerogels, xerogels, and nanofiber mats.

Although cloth and paper are the most common absorbents for water, their water-absorption capacity is limited. It is well-known that much higher extents of absorption can be achieved through the use of hydrogels made from superabsorbent polymers (often abbreviated as SAPs). See Cipriano et al., “Superabsorbent Hydrogels that are Robust and Highly Stretchable”, Macromolecules 2014, 47, 4445-4452. Hydrogels are three dimensional (3-D) networks of polymer chains crosslinked by covalent bonds.

Superabsorbent polymer gels can absorb large amounts of water (100 to 1000× their dry weight). For the last fifty (50) years, many scientists have proposed to extract mechanical work from gel expansion/contraction, which could pave the way for ‘artificial muscles’. However, slow rates of gel expansion have limited these efforts: macroscale (˜cm) gels take over twenty four hours (24 h) to expand to their equilibrium size. Gels can be made to expand faster if their characteristic length scale is reduced, e.g., by making a macroscopic gel porous. Still, gels that are both superabsorbent and able to expand rapidly have not yet been realized.

Polymer hydrogels have been crosslinked networks of polymer chains that are swollen in water. When a bulk (centimeter-scale) SAP gel is dried, it usually becomes a brittle solid. Therefore, for SAPs to be used in diapers, they are made in the form of microbeads. The small sizes of these beads ensures adequate mechanical properties and also a fast swelling rate. Still, it is worth noting that a diaper is very different from a cloth or paper towel. In a diaper, the need for different layers to sequester the SAP beads means that the material is thicker and not flexible or foldable like towels.

In recent years, researchers have looked to integrate SAP gels onto fibers (e.g. by coating fibers with gel-beads) to achieve a combination of cloth-like flexibility as well as high absorption capacity. However, these studies are yet to translate into commercially viable absorbents because the synthesis is difficult or laborious. In parallel, researchers have also tried to introduce pores into SAP hydrogels. The most common strategy for this is foam-templating, where a monomer solution is foamed and the polymerization is then done around the bubbles in the foam. When such a porous gel is ambient-dried or freeze-dried (lyophilized), a dry porous solid is obtained. However, these are brittle solids and moreover, are usually prepared in small sizes (with their largest dimension usually being a few millimeters). The same limitations hold true for other absorbent materials like aerogels, cryogels, and electrospun mats of nanofibers.

Spills of crude oil or organic solvents contaminate water bodies and adversely affect the surrounding ecosystem. Over the past 30 years, major oil spills have included the Exxon Valdez event in 1989 and the Deepwater Horizon event in 2010. The continued disposal of solvents such as toluene, cyclohexane, dichloromethane, etc. by the chemical industry is another source of water pollution. Common methods to clear immiscible liquids from water are by using dispersants or absorbents. See Athas et al., “An effective dispersant for oil spills based on food-grade amphiphiles.” Langmuir 2014, 30, 9285-9294, which hereby is incorporated by reference herein in its entirety. If the pores of an absorbent are oleophilic, they can imbibe oils through capillary action and thereby separate the oil from water. However, typical absorbents are in powder or flake form. Additionally, if a powder is sprinkled on oil to remove it from a water body, it is not easy to extract the oil-soaked powder (a skimmer will be typically needed). The powder itself can become a source of water contamination.

In contrast, spills of oil on a countertop (at a home or lab) are typically mopped up the same way spills of water and other liquids are. One uses a paper towel, a cloth towel, or a sponge. Because towels are flexible and foldable sheets, they are most convenient to use, and can be spread over the spilled liquid. However, neither common fabrics (cotton, nylon, etc.) nor paper have oleophilic (oil-loving) surfaces. Instead, they are hydrophilic and thus are suited to absorbing water, not oil. Thus, the absorption capacity of paper or cloth towels for organic solvents is low, but they are still used widely because of their convenient form-factor. Turning to sponges, such as those based on polyurethane or melamine, they too are hydrophilic in their native state due to amino and carboxylate groups on the polymer chains. Attempts to make the sponges hydrophobic have been published, but those techniques are cumbersome and often use materials that are toxic to the environment like carbon nanotubes or graphene. Besides, sponges are still relatively small and bulky objects—to absorb an oil spill on a large water body, enormous sponges would be required, which seem impractical both to manufacture and transport.

Thus, sponges may suffice for small oil spills, but they neither have the form factor nor the oil-absorbing capacity for use with large ones. Large, fabric-like sheets that can be rolled up into a compact size would be preferable by far.

One route to better oil-absorbents could be via superabsorbent polymers (SAPs). SAP-based polyelectrolyte gels for water can swell and absorb >100−their dry weight. See Choudhary et al., 2014. Recently, oleophilic gels have also been reported that can swell and absorb organic solvents, albeit to a lower extent.

Thus, there exists a need for macroscale superabsorbent porous gel that has a fast rate of expansion. There further exists a need for superabsorbent materials that simultaneously achieve the convenience and durability of cloth or paper as well as the absorbency of SAPs. There even further exists a need for superabsorbent materials that absorb oils utilizing SAP-like oleophilic gels.

### SUMMARY

Research on fast-swelling porous gels over the past two decades has focused on increasing the swelling rate by enhancing the porosity, while simultaneously ensuring that the gel is mechanically robust. Various strategies have been pursued to introduce pores into gels, including porogen-leaching, lyophilization, ice-templating, cryogelation and foam-templating. The latter is the most popular strategy and involves making a foam, i.e., a dispersion of gas bubbles in a monomer solution, prior to polymerization. To ensure high porosity of the final gel (e.g., greater than (>90%)), it is necessary to have a high density of bubbles in the foam and to keep the bubbles stable during polymerization. The bubbles then have to be removed, leaving behind a porous gel. Various surfactants or amphiphiles have been used to stabilize the above foams. The best examples of porous gels so far are those that can swell to equilibrium within a minute; however, their swelling extents are low (˜50 times) and so the gels do not expand much. Gels that swell more seem to expand slower and also appear to be mechanically weak.

The present disclosure describes the creation of gels at the macroscale (˜cm or larger) that are porous, highly robust, superabsorbent and expand much faster than any gels thus far. The superabsorbent gels of the present disclosure are formed from the in situ foaming of a monomer solution (acrylic acid and acrylamide) using a double-barrelled syringe that has acid and base in its two barrels. Gas (CO₂) is generated at the mixing tip of the syringe by the acid-base reaction, and gas bubbles are stabilized by an amphiphilic polymer in one of the barrels. The monomers are then polymerized by ultraviolet (UV) light to form the gel around the bubbles, and the material is dried under ambient conditions to give a porous solid.

When the dry gel is added to water, the dry gel absorbs water at a rate of 20 g/g·s until an equilibrium is achieved at ˜300× its weight. In the process, each gel dimension increases by ˜20%/s until its final dimensions are more than 3× larger. Such rapid and appreciable expansion can be easily observed by the eye, and remarkably, the swollen gel is robust enough to be picked up by hand. SEM images reveal a porosity >90% and an interconnected network of pores. The gels are responsive to pH and a full cycle of expansion (in regular water) and contraction (at pH 10 or in ethanol) can be completed within about 60 s. Gel expansion can be used to rapidly lift weights against gravity, resulting in ˜0.4 mJ of work being done over 40 s, which translates to a power-density of 260 mW/kg. This in effect can harness the chemical potential energy from the gel to do useful mechanical work.

Materials to absorb aqueous liquids are either foldable cloth/paper towels (convenient to use but poorly absorbent), or superabsorbent polymer hydrogels (highly absorbent, but fragile when dried). The present disclosure shows, for the first time, how to prepare SAP hydrogels in an unusual, yet useful form: as large, flexible sheets. The chemistry used to make these gels involves polymerization of acrylate monomers. However, the unique sheet-like geometry arises because of a UV-polymerization around the bubbles of a foam, which is first introduced into a bag and flattened to a thin layer prior to UV exposure. The resulting gel is then plasticized with glycerol and then ambient-dried to give the final ‘gel-sheet’. The macroporous sheets have fabric-like properties: i.e., they can be folded, rolled up, and cut with scissors. At the same time, like hydrogels, they have the ability to rapidly absorb aqueous fluids. As they absorb fluid, the sheets expand, which is a remarkable property not observed with any other absorbents based on paper, cloth, or sponge.

The gel-sheets described herein combine the best attributes from easy to use commercial products and the superabsorbent polymer hydrogels. Macrosized sheets (e.g., 10×10 cm) are prepared by foam-templating, followed by plasticization and ambient drying. The dried sheets are macroporous, flexible, soft, and robust; they can be folded, rolled up, and cut with scissors, much like fabrics. At the same time, like hydrogels, superabsorbent porous gels sheets described herein substantially absorb water and expand as they absorb, which is unlike commercially sold sponges or towels. The sheets also absorb viscous liquids like blood as well as viscoelastic liquids like polymer solutions. Absorbed liquid is retained within the sheet when lifted whereas excess liquid drips from towels. Such gel-sheets can be used to clean up spills in homes, labs, and hospitals, and for absorbing biological fluids during surgeries.

The gel-sheets described herein were compared with commercial absorbents such as paper or cloth towels; gauze dressings for wounds; and sanitary pads. These comparisons have been done with water, blood, and viscous or viscoelastic liquids. In all cases, the gel-sheets outperform their commercial counterparts. The water absorption limit with the gel-sheet is around three times that of other materials. Absorbed liquids are retained within the gel-sheet when it is lifted up whereas with controls, excess liquid drips down. These findings suggest that the gel-sheet is truly better at absorbing liquids and could excel at cleaning up spills in homes, labs, and hospitals. Gel-sheets could also be useful for absorbing biological fluids during surgeries or other medical procedures (note that most bodily fluids are viscous or viscoelastic). The sheets could also find use in personal hygiene products (diapers and sanitary pads). Lastly, there is still an important need for hemostatic materials that can staunch bleeding from severe wounds. Due to their high absorbency and flexible nature, these gel-sheets could function as hemostats.

Materials that can selectively absorb oil from water can be used to clear oil spills, but known absorbents are typically either in the form of powders or small, bulky solids. In homes and labs, spills of oil are absorbed with cloth or paper towels, which are flexible and foldable, but exhibit poor absorbency. The fabric-like sheets described herein can absorb considerable oil.

Gel-sheets based on SAPs that were flexible and foldable in their dry form, but could absorb large amounts of water. The high absorbency of these sheets was due to the presence of microscale pores, which were introduced into the sheet by foam templating, i.e., by polymerizing monomers in water around the gas bubbles in a foam. Foam templating can be translated to the oil phase, however can be quite challenging because, unlike foams in water, foams in non-polar liquids are difficult to stabilize. Thus, attempts at making porous oleophilic polymers have resorted to alternative techniques such as porogen leaching, emulsion templating, and foaming with supercritical CO₂. All of these techniques are complex and difficult to scale, and none have resulted in large, fabric-like sheets.

The synthesis of ‘oleo-sheets’ (superabsorbent oragnogels) are created by templating organofoams. A foam of CO₂ bubbles in a water-in-oil emulsion is first created, with the bubbles stabilized by a silicone surfactant. Monomers in the oil phase (alkyl and urethane acrylates) are then polymerized rapidly by UV light to give a porous gel. By ambient drying this gel, the oleo-sheets (˜10×7×0.4 cm in size) and oleo-sponges (size ˜2×2×1 cm), which are both soft, pliable materials with interconnected pores. These materials are hydrophobic (water contact angle ˜130°) and they selectively absorb a range of oils (organic solvents) from water. When contacted with solvents such as toluene, dichloromethane, and chloroform, the oleo-sheet/sponge absorbs more than 50—its dry weight in solvent, and interestingly, it expands in volume as it does so. The absorption capacity exceeds that of any commercial towel, pad, or sponge, including those marketed specifically for use with oils. Oleo-sheets are sponges that could be used to mop up spills of oils or organic solvents—in labs, homes, or even an oil layer on a water tank or pond. Their absorption capacity (>50 g/g) exceeds that of commercial absorbents like polyurethane sponges or cloth pads. The present disclosure also describes how to make magnetic oleo-sponges. After a magnetic oleo-sponge absorbs oil, the magnetic oleo-sponge can be lifted by magnet(s).

Omni-sheets, which are a hybrid (‘Janus’) sheet having two distinct sides, can also be produced. One side of the omni-sheet can selectively absorb oils (or non-polar solvents) while the other does the same for water (or highly polar solvents). Thus, the omni-sheet can pick up almost any spilled liquid. The omni-sheets have application(s) in cleaning up spills due to their unique combination of convenient form factor, robust mechanical properties, and excellent absorbency. Moreover, the synthesis techniques of oleo-sheets described herein are reproducible, scalable, energy efficient (since it does not involve freeze-drying), and environment-friendly.

The following objects, features, advantages, aspects, and/or embodiments, are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to provide an ideal absorbent having a high liquid-absorption capacity, fast absorption rate, and good mechanical properties (it needs to be strong, yet flexible) in both its dry state as well as when full of liquid. For example, to absorb water-based aqueous fluids, the material should also have hydrophilic properties.

It is yet a further object, feature, and/or advantage of the present disclosure to devise a strategy to create robust porous gels that swell and expand very rapidly. One example approach involves the in situ foaming of a monomer solution (mixture of AAc and AAm) using a DBS that has acid and base in its two barrels. Gas (CO₂) is generated at the mixing tip of the DBS by the acid-base reaction, and gas bubbles are stabilized by the amphiphilic polymer hmC in the acidic barrel. The monomers are then UV-polymerized to form the gel around the bubbles, and the material is then dried under ambient conditions. Scanning electron microscope (SEM) images show a network of interconnected pores in the dried material.

It is still yet a further object, feature, and/or advantage of the present disclosure to utilize the benefit from the creation of such a superabsorbent porous gel. For example, when one example of such a superabsorbent porous gel is dry and is added to water, it absorbs water at a rate of 20 g/g·s until an equilibrium is achieved in 15 s at about 300× its weight. In the process, the gel size increases by 20%/s until its final sizes are 4× the original ones (i.e., there is a 3× increase in size). Such rapid and appreciable expansion can be easily observed by the eye, is the highest expansion rate reported for gels, and represents a significant improvement in this technical field.

It is still yet a further object, feature, and/or advantage of the present disclosure to use shrink expanded gels decreasing the pH, adding salt, and/or adding ethanol. Reversible expansion-contraction cycles, where the gel expands by absorbing one hundred times (100×) its weight in water and then contracts by expelling one hundred times (100×) its weight in water, can be completed in about sixty seconds (60 s).

It is still yet a further object, feature, and/or advantage of the present disclosure to use gel expansion to lift loads against gravity. For example, a forty milligram (40 mg) gel is able to perform ˜0.42 mJ of work over forty seconds (40 s), which translates into a power density of 260 mW/kg. This ability to harness the chemical potential of the gel to do useful mechanical work could be a game changer for many applications.

It is still yet a further object, feature, and/or advantage of the present disclosure to optimize the fabric-like texture and robustness of the sheets as well as their ability to absorb liquids, such as water, blood, and oil.

It is still yet a further object, feature, and/or advantage of the present disclosure to be able to absorb all solvents with a single gel-sheet while retaining the benefits of fabric-like flexibility.

The superabsorbent materials disclosed herein can be used in a wide variety of applications. For example, the expansion of superabsorbent porous gels can be used to lift weights against gravity, for producing mechanical work, in new designs for mechano-chemical engines, in biotechnological applications such as artificial muscles, etc.

It is preferred that the superabsorbent hydrogels and organogels described herein be safe to use, cost effective, and durable. For example, the apparatus can be adapted to resist excessive heat, static buildup, corrosion, and/or mechanical failures (e.g., cracking, crumbling, shearing, creeping, breaking, and tearing) due to excessive impacts and/or prolonged exposure to tensile and/or compressive forces acting on the hydrogels and organogels.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the hydrogels and organogels, and in some embodiments, there can be aspects that contribute to both the aesthetics and function of the superabsorbent porous materials described herein. For example, the superabsorbent porous materials described herein can take the form of a sponge, a sheet, etc.

Methods can be practiced which facilitate use, manufacture, assembly, maintenance, and repair of the superabsorbent porous materials described herein which accomplish some or all of the previously stated objectives.

The superabsorbent porous materials described herein can be incorporated into systems and/or kits which accomplish some or all of the previously stated objectives.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIGS. 1A-IC illustrate gel-swelling dynamics at different length scales. Dry gels are placed in water at t=0 and allowed to swell (expand) to their final size. Swelling occurs by diffusion of water into the dry gel. In FIG. 1A, microscale gel beads (˜10 m size) swell in seconds to their final size. In FIG. 1B, a solid macroscale gel (˜1 cm size) takes ˜24 h to expand to its final swollen size. In FIG. 1C, a macroscale gel with microscale pores expands much more rapidly compared to FIG. 1B. The porous gel of FIG. 1C is just one example of the present disclosure and is shown to expand to four times (4×) its original size within fifteen seconds (15 s).

FIGS. 2A-2D show a schematic of the procedure used to synthesize porous gels. FIG. 2A shows a foam of the monomers is prepared using a double-barrelled syringe (DBS). One barrel of the DBS is an acidic solution of monomers, crosslinkers and the hmC stabilizer, while the other barrel is a basic solution with the UV initiator. At the mixing tip of the DBS, CO2 gas is produced, and bubbles of the gas are stabilized by hmC chains. FIG. 2B shows The foam is

FIGS. 3A-3C capture a microstructure of the foam and the porous gel made using the foam as a template. The representative optical micrograph of the foam, as shown in FIG. 3A, reveals close-packed small bubbles. A representative SEM image of the dried porous gel at a first magnification at a first magnification is shown in FIG. 3A. A representative SEM image of the dried porous gel at a first magnification at a second magnification is shown in FIG. 3B. The images of FIGS. 3B-3C show a highly porous structure with interconnected pores.

FIGS. 4A-4C capture the swelling and expansion of a porous gel in water. In FIG. 4A, at time t=0, a dried gel is placed in water. Snapshots of the swelling gel at various time intervals. In FIG. 4B, swelling ratio R and size increase (ΔL/L0) (%) are plotted against time. The gel absorbs more than three hundred times (300×) its dry weight within fifteen seconds (15 s), and in the process, its size increases by three hundred percent (300%) in fifteen seconds (15 s). In FIG. 4C, after the swelling is complete, the swollen gel (4-fold larger than the original) is robust enough to be picked up and held by hand.

FIG. 5 compares the swelling-rates of porous gels in this study with past ones. The swelling-rate in this study is 20 g/g·s, whereas those in previous studies were below 5 g/g·s. See also Table 1.

FIGS. 6A-6D show the effect of ionic monomer content on gel-swelling extent and kinetics. In FIG. 6A, swelling ratios R at equilibrium of porous gels with different proportions of ionic monomer (acrylic acid, AAc) to nonionic monomer (acrylamide, AAm). Note: R=mass of swollen gel/mass of dry gel. During synthesis, the total monomer (AAc+AAm) was maintained at 25 wt % while the weight ratio of AAc:AAm was changed. For visualization of the data in FIG. 6A, the images of FIG. 6B of the various gels are shown in the dry and swollen states. All the ionic gels swell significantly. In FIG. 6C, kinetics of gel-swelling for each of the gels in FIG. 6A are shown. FIG. 6D exemplifies a zoomed-in plot of the initial data in FIG. 6C, showing that all the ionic gels swell at roughly the same rate (i.e., the initial slopes are similar).

FIGS. 7A-7B show the effect of a crosslinker concentration on gel-swelling extent. FIG. 7A shows swelling ratios R of porous gels as a function of the crosslinker concentration. The gels were synthesized with a total monomer (AAc+AAm) content of 25 wt % and with the AAc:AAm ratio at 3:1 by weight. Only the concentration of the N,N′-methylene(bis)acrylamide (BIS) crosslinker (mol % with respect to the total monomer) was varied. For visualization of the data in FIG. 7A, the images of the gels are shown in the dry and swollen states in FIG. 7B. The less crosslinked the gel, the more it swells.

FIGS. 8A-8C show the effect of stabilizer (hmC) concentration on precursor foams and the corresponding porous gels. A foam stabilized by a given concentration of the amphiphilic polymer hmC (hydrophobically modified chitosan) is injected into a vial and the time for the foam to dissipate to half its fresh height (t_{1/2}) is used as an indicator of foam stability. The bubbles in the foam are also analyzed by optical microscopy and the average bubble diameter D_{avg} is determined from the images. The plot of FIG. 8A of t_{1/2} and D_{avg} vs. hmC concentration. As hmC is increased, the bubbles become smaller and the foam stability increases. In FIG. 8B, foams with different hmC content were used to synthesize porous gels, with other compositional variables held constant: the total monomer was 25 wt %, the AAc:AAm ratio was 3:1, and the BIS was at 0.375 wt %. SEM micrographs of the dried gels are shown. Interconnected pores are seen when the hmC is 0.1 wt % (the middle image) or 0.5 wt % (the right image). FIG. 8C shows swelling ratios at equilibrium of the above porous gels.

FIGS. 9A-9B show porous gels in different shapes, before and after swelling. FIG. 9A show porous gels with the same composition are synthesized in different shapes: with circular, triangular, rectangular, and square cross-sections. The image shows the gels in their initial (dry) state. As shown in FIG. 9B, the same gels after swelling in water. All gels swell isotropically by 300× their initial weight. Each dimension of the initial shapes in FIG. 9A is increased by approximately three times (˜3×).

FIG. 10 charts the response of porous gels to pH. The gel swells (expands) at ambient and higher pH and shrinks (contracts) at low pH. Repeated cycling between pH three (3) and ten (10) is done, and the swelling ratio R during these cycles is plotted. Both swelling and shrinking occur rapidly. A full cycle is completed in approximately sixty seconds (˜60 s) for the first cycle and approximately ninety seconds (˜90 s) for subsequent cycles.

FIGS. 11A-11C exemplify the extraction of mechanical work from the expansion of a porous gel. In FIG. 11A, a cylindrical porous gel is placed in a syringe and on top of this cylinder, a load of mass m is placed (left-side image). As soon as water is added, the gel swells and expands, thereby lifting the weight by a height h (right-side image). FIG. 11B plots the height to which the load is lifted by the gel against the mass m of the load. FIG. 11C plots the work done by the gel in lifting the load m by a height h (W=mgh) against the mass m.

FIGS. 12A-12B exemplify reversible lifting and lowering of a load by the expansion and contraction of a porous gel. FIG. 12A places a cylindrical porous gel in a syringe and a load is then placed on the syringe (left-side image). When water is added, the gel absorbs water and expands, thereby lifting the load by a height h (middle image). Next, when ethanol is added, the gel contracts (by expelling solvent), and thereby, the load is lowered to its initial position (right-side image). Repeated cycling is done in water and ethanol, and the position h of the load is plotted across three such cycles in FIG. 12B. A full cycle is completed in approximately seventy (˜70 s).

FIGS. 13A-13B show gel-expansion as a way to block the flow of water. A comparison is done between a macroscopic porous gel and commercial gel-beads (both of the same weight of 40 mg). The setup involves a syringe with an open bottom that is covered by a wire mesh (see inset) and then a small piece of a paper towel. In FIG. 13A, a cylindrical porous gel is placed on the paper towel at t=0 (1). When water is added from the top, initially it flows out through the wire mesh at the bottom (2), but by 15 s, the gel is expanded and fills the syringe, thus blocking the flow (3), and no further flow is observed even after 5 min (4). In FIG. 13B, gel-beads are placed on the paper towel at t=0 (1). When water is added from the top, the beads swell and thicken the water column (2, 3), but water continues to flow out through the bottom (2, 3, 4).

FIGS. 14A-14C compare current water-absorbents and the gel-sheets. Current absorbents fall into two categories: In FIG. 14A, pads or towels made from cloth or paper, which are soft and flexible, but have low absorption capacity. In FIG. 14B, superabsorbent polymer (SAP) gels, which absorb much water, but are hard and brittle. In FIG. 14C, the gel-sheets combine the desirable properties of both the above while avoiding their drawbacks: they are soft, foldable and flexible, while also exhibiting high water absorption. Note that the sheet expands as it absorbs water. Scale bars: 1 cm.

FIGS. 15A-15C show a schematic of the procedure used to synthesize gel-sheets. In FIG. 15A, a polymerizable foam is injected into a Ziploc bag using a DBS. In the foam, bubbles of CO2 are stabilized by the polymeric stabilizer hmC. Glass slabs are used to compress the foam into a thin layer. In FIG. 15B, the foam is polymerized by UV light for two minutes (2 min). The bubbles remain intact and a polymer network is formed around the bubbles. In FIG. 15C, the water in the gel-sheet is solvent-exchanged with a 15/85 glycerol-ethanol solution, followed by ambient drying. The dry gel-sheet is soft and flexible.

FIGS. 16A-16B capture microstructure of gel-sheets 1600. FIG. 16A represents an optical image and FIG. 16B represents a scanning electron microscope (SEM) image. The images of the dry gel-sheet show a highly porous structure with interconnected pores 1601.

FIGS. 17A-17B exemplify the fabric-like nature of gel-sheets 1700. FIG. 17A shows that a gel-sheet (10×8×0.4 cm) can be folded with a single fold 1701, double fold 1702, a triple fold 1703, and returned to an unfolded state 1704 several times, without showing cracks or tears. FIG. 17B shows a gel-sheet that is includes a smooth clean cut 1706, which was created by cutting cleanly and smoothly using a pair of scissors 1705. Scale bars: 1 cm. In some embodiments, the thickness 1707 of the gel sheet 1700 can be up to one millimeter (1 mm) thick.

FIG. 18 exemplifies the texture of a thick gel-sheet. A 15-mm thick gel-sheet in cube form (2.5×2.5 cm) is compared side-by-side with a cotton ball of similar dimensions. Both materials can be squeezed between fingers several times (10 cycles) without any lasting changes in size or structure. Scale bars: 1 cm. Note: The recipe for the gel-sheet in all SI figures is the same as in the main paper unless otherwise indicated: total monomer=25%, AAc:AAm=3:1, crosslinker PEGDA=2.5 mol %, and the gel is solvent exchanged with 15/85 glycerol/ethanol before ambient drying. As shown, the gel-sheet can cycle through an initial state 1800A, a compressed state 1800B, and a released state 1800C nearly identical to the initial state 1800A, just as a cotton ball can cycle among an initial state 1801A, a compressed state 1801B, and a released state 1801C nearly identical to the initial state 1801A.

FIGS. 19A-B exemplify mechanical properties of gel-sheets. FIG. 19A graphs tensile stress vs. strain. The tensile (Young's) modulus is 4.8 kPa and the gel-sheet can be stretched by 45% until failure. FIG. 19B graphs compressive stress vs. strain. The gel-sheet is a soft, spongy material that can sustain more than 85% compression without damage. The images show that the compressed gel returns instantly to its initial size upon removing the load.

FIGS. 20A-20C identify a beneficial plasticizer concentration and type. FIG. 20A shows images of a gel-sheet prepared without glycerol as the plasticizer in the solvent-exchange step is brittle. The wet gel after polymerization is solvent-exchanged with just ethanol, followed by ambient drying. The dried sheet breaks even when slightly deformed. Scale bars: 1 cm. This shows the need for glycerol as a plasticizer. FIG. 20B graphs Tensile (Young's) modulus of gel-sheets prepared with various glycerol concentrations in the solvent-exchange step. The optimal content of glycerol is 15% (circled), i.e., glycerol:ethanol=15:85. If more glycerol is used, the tensile modulus becomes too low. FIG. 20C compares gel-sheets plasticized by propylene glycol (PG), ethylene glycol (EG), glycerol, PEG-200 and PEG-400. In all cases, the sheet is solvent-exchanged with a 15:85 plasticizer:ethanol solution. The sheets are then heated in an oven at 70° C. and the weight drop over time is the plasticizer lost by evaporation. PG and EG are completely removed within 3 h whereas only ˜30% of the other plasticizers are removed. This data shows glycerol to be an optimal plasticizer.

FIGS. 21A-21C identify the optimal crosslinker concentration and type. FIG. 21A calculates porosities of gel-sheets with different concentrations of PEGDA crosslinker. If the PEGDA content is too low, the porosity is low, indicating that most of the pores collapse during drying. This is consistent with the SEMs in FIGS. 22A-22C, infra. For this reason, the optimal PEGDA is 2.5 mol % (circled). FIG. 21B compares gel-sheets crosslinked with three different crosslinkers: BIS, TEGDA, and PEGDA (all at the same concentration of 2.5 mol % of total monomers). BIS and TEGDA are small molecules whereas the PEGDA has an MW of 575. The bar graph shows the ratio of gel-sheet volume after ambient drying (V_{dry}) to the volume before drying (V_{wet}). When crosslinked by PEGDA, V_{dry}/V_{wet}=0.9, i.e., the dry gel-sheet retains 90% of its volume, indicating that the pores are mostly intact (not collapsed). FIG. 21C shows images of the gel-sheets before and after drying, corresponding to the data in FIG. 21B. The PEGDA gel-sheet shrinks the least, consistent with the data shown in FIG. 21B. This indicates that most of the pores in the material are intact. Scale bars: 1 cm. These observations indicate that a long-chain crosslinker like PEGDA is optimal for the gel-sheets.

SEMs at two magnifications are shown for three different PEGDA concentrations in FIGS. 22A-22C: 1.5 mol % for FIG. 22A, 2.5 mol % for FIG. 22B, and 5 mol % for FIG. 22C. Pores are collapsed in FIG. 22A, whereas both FIGS. 22B-22C show open, interconnected pores. This is consistent with the data in FIG. 22A. PEGDA of 2.5 mol % (highlighted) is identified as being quite beneficial.

FIGS. 23A-23B compare water mopping by gel-sheet with controls (commercial cloth pads). At t=0, a gel-sheet having the advantages described herein (FIG. 23A) or a commercial cloth pad (Sungbo Corp.) (FIG. 23B) of identical size (10×8×0.4 cm) are placed over a spill of 25 mL water. Snapshots at various stages are shown. The gel-sheet absorbs all the water and the swollen sheet does not drip when held vertically. The commercial pad only absorbs 60% of the water, and moreover, the water drips out when held vertically. Scale bars: 2 cm.

FIG. 24 shows water mounting by a Bounty® paper towel. At t=0, a folded Bounty® paper towel of 10×8×0.4 cm size is placed over a spill of 25 mL water. Snapshots at various stages are shown. The towel only absorbs 48% of the water, and moreover, the water drips out when held vertically. Scale bars: 1 cm.

FIGS. 25A-25B quantify water absorption limit for gel-sheets. The absorption limit (or “dripping limit”) is the amount of water that can be held by a sheet at saturation—before it starts to drip. FIG. 25A plots this quantity vs. sheet size for gel-sheets as well as a commercial cloth pad (Sungbo Corp.). FIG. 25B charts this quantity for various sheets, all having a size of 10×8×0.4 cm. The gel-sheet exhibits 3× the absorption limit of the others.

FIGS. 26A-26B exemplify expansion 2601 of gel-sheets 2600 upon absorbing water 3-cm discs of a gel-sheet 2600 and a paper towel (Bounty®) are compared after adding given amounts of water. FIG. 26A captures images at different times, such as when the gel sheets are at an expanded size 2602. FIG. 26B plots of diameter vs. time. The gel-sheet expands by 80% whereas the paper towel 2607 remains at the same size and does not absorb all of the spilled water 2608. Scale bars: 1 cm.

FIGS. 27A-27B compare blood mopping by gel-sheet with controls. At t=0, a gel-sheet 2700 (FIG. 27A) or a gauze wound dressing (McKesson®) (FIG. 27B) of identical size (10×8×0.4 cm) are placed 2702 over a pool of 40 mL blood 2701. Snapshots at various stages of blood being absorbed 2703 are shown. The gel-sheet absorbs 99% 2704 of the blood and the swollen sheet 2705 does not drip 2706 when held vertically. The commercial gauze only absorbs 55% 2707 of the blood, and moreover, the blood drips 2709 out of the bloody gauze 2708 when held vertically. Scale bars: 2 cm.

FIG. 28 charts blood absorption limit for gel-sheet and commercial products. This quantity is the amount of blood that can be held by a sheet at saturation and it is compared for a gel-sheet, a gauze dressing (McKesson®), a polyurethane (PU) sponge, and an Always® sanitary pad. All have a size of 2×2×0.4 cm. The gel-sheet absorbs about 3× the blood compared to the others.

FIG. 29 charts absorption limit for viscoelastic solutions. Solutions of xanthan gum (XG) with varying zero-shear viscosities (Pa·s) were tested. The absorption limit is the amount of liquid that can be absorbed by a sheet at saturation (without dripping). It is compared for a gel-sheet and a cloth pad (Sungbo), both of size 2×2×0.4 cm.

FIGS. 30A-30C compare forming aqueous foams vs. organofoams. Foams are easily generated in water, but not in oil. For the latter, special silicone surfactants are necessary. The foams of FIGS. 30A-30C are made by mixing acid with NaHCO₃ (base) particles and a surfactant. In FIG. 30A, in water, a stable foam is easily formed using the conventional (hydrocarbon-based) nonionic surfactant T80. As shown, the foam height is about six times (6×) that of the initial liquid. In oil, using T80, little foam is produced, as shown in FIG. 30B. In the same oil, using a silicone surfactant, a foam develops slowly but it rises to a height similar to that in FIG. 30A and remains stable, as shown in FIG. 30C. A structure 3000 of a silicone surfactant is shown on the left: it is a copolymer with a silicone part 3001 and a polyether part 3002.

FIGS. 31A-31C illustrate synthesis 3100 of oleo-sheets and oleo sponges. In FIG. 31A, a foam is generated by mixing acidic water (created in an aqueous phase 3102 wherein CH₃COOH is placed in water 3101) with an oil phase 3103 containing monomers, initiator, and silicone surfactant 3105, as well as NaHCO₃ particles 3104. The acid and the base react to produce CO₂ gas bubbles, which are surrounded by a water-in-oil emulsion. Both the bubbles 3108 and water droplets 3109 are stabilized by the surfactant. In FIG. 31B, the sample is quickly transferred into either a sheet (e.g., between glass plates 3106) or a cylindrical mold 3107. In three minutes (3 min) at room temperature, a polymer network is formed around the bubbles. In FIG. 31C, the sample is then washed and dried under ambient conditions to produce soft, flexible oleo-sheets 3110 and oleo-sponges 3111.

FIGS. 32A-32B show a microstructure of the foam template and the resulting oleo sponge/sheet. FIG. 32A shows a template sample 3200A in the upper-left image that is a foam in which gas (CO₂) bubbles 3201 are surrounded by a water-in-oil emulsion, which is shown in the upper right image. Optical micrographs show both the gas bubbles 3201 in the middle-right image and at higher magnification the water droplets 3202 around the bubbles 3201 in the lower-right image. The size distribution of the gas bubbles 3201 is plotted in the lower-left image.

As shown in FIG. 32B, after drying, the bubbles become pore in the oleo-sponge/sheet 3200B (upper-left image), with a network 3204 of hydrophobic polymers existing around the pores 3203 (upper-right image). The optical micrograph of the middle-right image and the SEM micrograph of the lower-right image reveal the porous structure, and the pore size distribution from SEM is plotted in the lower-left image.

FIGS. 33A-33B show a mechanical robustness of oleo-sheets revealed by visual observations and measurements. In FIG. 33A, an oleo-sheet can be handled like a cloth or paper towel. It can be folded and unfolded as shown in the first three images of FIG. 33A, or rolled and unrolled, as shown in the fourth (right-side) image of FIG. 33A. The sheet remains intact and does not tear. Tensile tests, plotted on the left of FIG. 33B, show that the oleo-sheet can be stretched up to a 35% strain before testing and that it has a high tensile modulus of 40 kPa. As shown in the plot on the right-side of FIG. 33B, under compression, the oleo-sponge is seen to sustain more than a 90% compressive strain and yet shows no structural damage.

FIG. 34 captures images of an oleo-sponge before, during and after compression. A cylindrical oleo-sponge of diameter 2 cm and length 2.5 cm is compressed between the parallel plates of a rheometer. The cylinder is subjected to 90% compression. When the compression is released, the material reverts to its initial size instantly.

FIGS. 35A-35B compare surface properties of an oleo-sponge compared with that of a commercial polyurethane (PU) sponge. Droplets of toluene, ethanol, and water (at pH 7, 2 and 12) are placed on the sponges. Each liquid is dyed a different color. Toluene and ethanol wet the oleo-sponge and are imbibed into its pores (the upper image of FIG. 35A). Water is non-wetting and beads up, with its contact angle being one hundred thirty degrees (130°) (the lower image of FIG. 35A). This shows the hydrophobicity of the oleo-sponge. On the PU sponge, toluene and ethanol wet the surface (upper image of FIG. 35B), but water also partially wets the surface and its contact angle is 75θ (lower image of FIG. 35B). Thus, the PU sponge is slightly hydrophilic. Scale bars: 500 μm.

FIGS. 36A-36C show the oleo-sponge selectively absorbs oil whereas the PU sponge does not. In FIG. 36A, an oleo-sponge piece (2×2×0.6 cm) is immersed in oil (toluene, dyed red) atop water (left image). The sponge selectively absorbs the oil (middle image) and expands as it does so (right image). With all the oil absorbed, clear water is left behind (right image). In FIG. 36B, when a PU sponge of the same size is immersed in the same oil-water mixture (left image), it only absorbs a bit of the oil and also some of the water (middle image). The sponge size remains nearly unchanged, and at the end, much oil is still left behind (right image). Scale bars: 0.5 cm.

FIGS. 37A-37C capture images of a polyurethane (PU) sponge and an oleo-sponge after immersion into water or oil. As shown in FIG. 37A, initially both sponges have the same size with dimensions of 2×2×0.6 cm. As shown in FIG. 38B, when immersed in blue water, the oleo-sponge does not absorb water and hence stays white. The PU sponge absorbs some water and hence appears green (combination of colors from the initial yellow color of the sponge and the blue dye). As shown in FIG. 38C, when immersed in red oil, both sponges turn red due to absorbing oil. The oleo-sponge absorbs much more oil and its size is significantly increased. Scale bars: 5 mm.

FIGS. 38A-38C graph oleo-sponge absorption and swelling in various oils, and comparison with commercial oil-absorbents. FIG. 38A reports the volume expansion (final volume Vⱼ/initial volume Vᵢ) of the oleo-sponge for various solvents. FIG. 38B plots the absorption capacity C (weight of solvent-saturated sponge to initial dry sponge) for a range of solvents. FIG. 38C compares the oleo-sponge with commercial pads or sheets designed specifically for oil absorption. This comparison is made for toluene using identical sizes of each material, and the absorption capacity C is plotted. Error bars are standard deviations from n≥3 measurements.

FIGS. 39A-39B compares a large oil spill clean-up using an oleo-sheet to controls. FIG. 39A shows an oleo-sheet (10×8×0.4 cm) contacted with a 40 mL spill of oil (toluene, dyed red) (the two left-side images). The sheet absorbs all the oil and expands as it does so (middle-right image). The swollen sheet is robust enough to be picked up by hand and none of the oil drips out (right-side image). In FIG. 39B, the same test is conducted with a commercial oil-absorbent pad (Oil Eater®) of identical size (the two left-side images). The pad only absorbs 40% of the oil (middle-right image), and the oil drips out (right-side image). The entire experiment is also shown in Movie S1. Scale bars: 2 cm.

FIG. 40 exemplifies reusability of an oleo-sponge for absorbing oils. An oleo-sponge of dimensions 2×2×0.6 cm was added to a solvent and upon saturation, the solvent was squeezed out and the sponge was placed back in the solvent. This process was repeated for one hundred (100) cycles in toluene and decane and the absorption capacity C is plotted after each cycle for both solvents. The data show that C remains unchanged over the one hundred (100) cycles.

FIG. 41 shows a magnetically responsive oleo-sponge. The oleo-sponge has a brown color due to the ferromagnetic Fe2O3 nanoparticles in it (1) and it responds to an external magnet. When contacted with oil (toluene, dyed red) atop water (2), the sponge absorbs all the oil (3). The swollen sponge can be lifted off the clear water surface by the magnet (4). Scale bars: 1 cm.

FIGS. 42A-42B show omni-sheets that absorb oil on one side and water on the other. FIG. 42A shows an omni-sheet (10×7×0.8 cm) has an oleophilic side (light orange) and a hydrophilic side (white) (left-most image). First, the oleophilic side is contacted with a 30 mL spill of oil (toluene, dyed red) (middle-left and middle images). All of the oil is absorbed and held within the sheet (middle-right and right images). Next, FIG. 42B shows the sheet flipped and the hydrophilic side contacted with a 30 mL spill of water (dyed blue) (left and middle-left images). All the water is absorbed and held within the side of the sheet (middle and middle-right images). The final sheet (right image) holds on to both the oil and water on its two sides. Scale bars: 2 cm.

A person skilled in the art need not view, within isolated figure(s), the near infinite distinct combinations of features described in the following detailed description to facilitate an understanding of the present disclosure.

### DETAILED DESCRIPTION

Any experiments conducted herein are merely intended to be non-limiting examples unless aspects of said experiments are expressly claimed. It should be understood that any examples and/or results of experiments conducted, while indicating certain embodiments of the invention, are given by way of illustration only. From the following discussion, one skilled in the art can ascertain the essential characteristics of this present disclosure, and without departing from the spirit and scope thereof, can make various changes and modifications of the embodiments of the invention to adapt it to various usages and conditions. For example, mechanical, electrical, chemical, procedural, and/or other changes can be made without departing from the spirit and scope of the present disclosure. No features shown or described are essential to permit basic operation of the present disclosure unless otherwise indicated. Thus, various modifications of the embodiments of the present, in addition to those shown and described herein, will be apparent to those skilled in the art from the following description. Such modifications are also intended to fall within the scope of the appended claims.

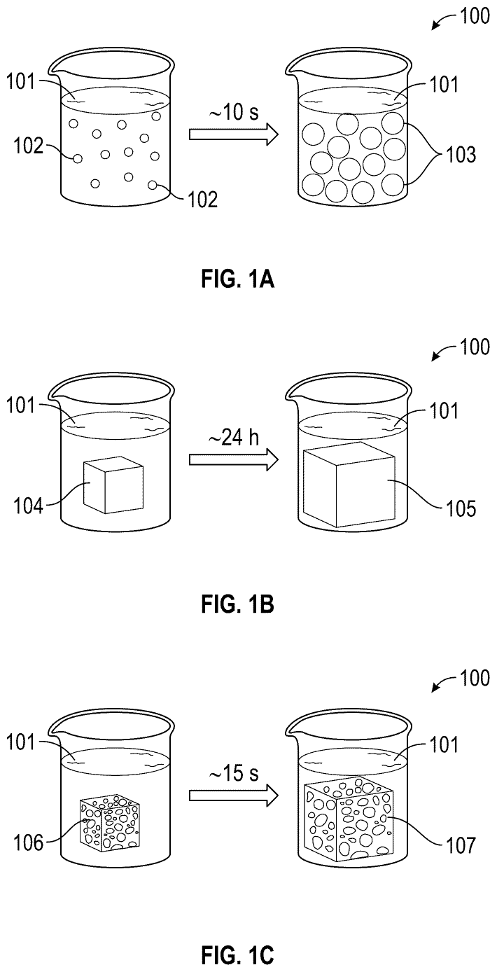

Examples 100 of swelling in water 101 are shown throughout FIGS. 1-C.

SAPs used in applications such as diapers are typically in the form of microscale beads 102, which facilitates their rapid swelling to a larger, equilibrium (swelled) size 103, as illustrated in FIG. 1A.

The same gels are commonly made in labs as macroscopic solids 104 (e.g., centimeter-scale cubes or cylinders). However, a macroscale dry gel will take a long time (˜24 h) to swell to its larger, equilibrium size 105 in water (FIG. 1B). The reason for this slow swelling is because it occurs by diffusion of water (of diffusivity D) into the gel, and the timescale T for this diffusion (r=l2/6D) depends on the length scale l of the sample. Thus, for a macro-scale gel (l˜1 cm), this timescale will be in hours, whereas for microbeads (l˜10 m, i.e., a 1000-fold smaller size), this timescale is reduced to seconds.

Gels can be engineered to absorb significant extents of water (more than 100 times their weight). See Cipriano et al., 2014, which hereby is incorporated by reference herein in its entirety. For a large piece of gel 106 to swell rapidly to its larger, equilibrium size 107, it is necessary to make it porous. The length scale relevant for diffusion will then be the pore diameter rather than the overall gel size (FIG. 1C). If the pores are microscale and are interconnected, porous gels can swell at rates that are 100 to 1000-fold higher than those of non-porous gels.

If a gel can expand rapidly such as is shown FIG. 1C, the expansion can be exploited for doing work, i.e., the chemical energy associated with gel expansion could be converted into mechanical energy. The most striking examples of natural ‘mechano-chemical engines’ are the muscles in the human body. A long-standing goal for polymer scientists has been to use polymer gels as ‘artificial muscles’. Artificial muscles are devices that can be reversibly actuated to perform muscle-like motion (expansion, contraction, and rotation) in response to external stimuli. Such motion can be harvested to perform mechanical work: for instance, a cycle of gel-expansion and contraction (in response to light temperature, or salt) can be coupled to the lifting and lowering of a weight. While gels are the ideal candidate for mimicking muscle (due to their soft and wet nature, which mimics living tissue) the timescale for actuating a macroscopic gel is currently too slow for muscle-like actuation. Thus, a desire for faster response times has led researchers to consider alternative materials for such actuators like liquid crystal elastomers or shape-memory polymers despite these systems being mostly unsuitable in a biomedical context. If gel expansion rates could be increased, they could be reconsidered for use in mechano-chemical engines.

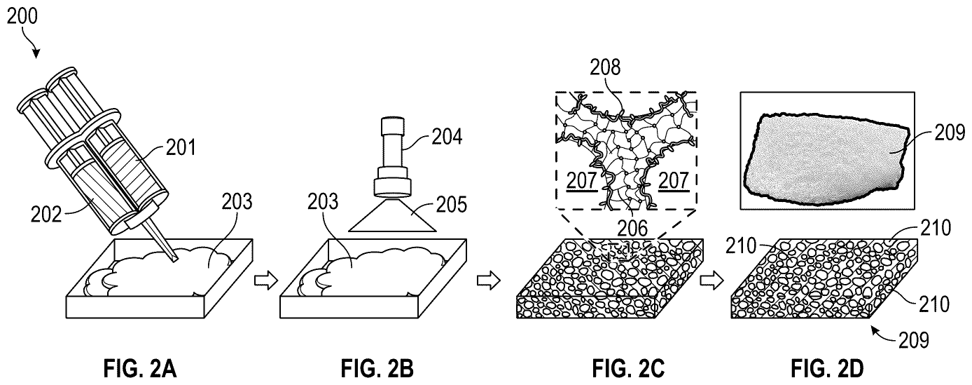

The present disclosure yields porous gels with an unprecedented combination of rapid swelling/expansion rates and high swelling extents. This involves foaming of a monomer solution by injecting it out of a double barreled syringe (DBS) 200. As shown by FIGS. 2A-2D, the foam 203 is generated in situ via the reaction of an acid and a base in the two barrels 201, 202 of the DBS 200, which combine to produce CO₂ gas 207 in the form of bubbles. The bubbles are stabilized by an amphiphilic biopolymer, hydrophobically modified chitosan (hmC), present in the first barrel 201. Monomers (acrylamide and acrylic acid, with crosslinkers) in the foam 203 are then polymerized to form a gel around the bubbles. Subsequently, this gel is dried under ambient conditions to give a porous solid 209 with a porosity >90% and pores 210 having a size around 200 μm. When this dry gel 209 is added to water, it absorbs water at a rate of 20 g/g·s until an equilibrium is achieved in 15 s at about 300× its weight. In the process, each gel dimension increases by ˜20% per second until its final sizes are four times (4×) the original ones (i.e., there is a three times (3×) increase in size). Such rapid and appreciable expansion can be easily observed by the eye, and this expansion rate is the highest reported to the knowledge of the present inventors. Moreover, the swollen gel 209 is robust enough to be picked up by hand. The gels 209 are responsive to pH and solvent quality, and a full cycle of expansion and contraction can be completed within about sixty seconds (60 s). Gel expansion is used to lift weights against gravity, and the power-density (260 mW/kg) achieved is better than in any previous gel-based actuators. Thus, rapid gel expansion allows the chemical potential energy from the gel to be captured in new ways, and this could enable many new applications.

Synthesizing porous gels 209 is shown schematically in FIGS. 2A-2D. In one barrel 201 of the DBS 200, a solution is loaded in acetic acid of the monomers acrylic acid (AAc) and acrylamide (AAm), the crosslinker N,N′-methylene-bis-acrylamide (BIS), and the stabilizer hmC. In the other barrel 202, a solution is loaded of the photoinitiator lithium acylphosphinate (LAP) in sodium bicarbonate. The acidic and basic solutions come into contact at the mixing tip of the DBS 200, whereupon the following reaction occurs:

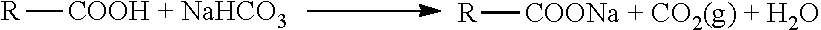

The net outcome is the release of carbon dioxide (CO₂) gas 207 in the form of bubbles. These bubbles get stabilized by the hmC present in the acidic barrel 201 of the DBS 200, thus resulting in a stable foam 203 (FIG. 2A). The foam 203 is then spread uniformly in a container and exposed to UV light 205 from a UV light source 204 at ambient temperature for two minutes (2 min) (FIG. 2B). The UV light 205 initiates the photopolymerization of the monomers, which results in a crosslinked polymer network 206 around the gas bubbles 207 (FIG. 2C). At this stage, the synthesis of the porous gel 209 is complete. For most experiments, dried cells are worked with, wherein water is completely removed from the sample. To achieve this, a solvent exchange with ethanol is done and then the gel 209 is dried under ambient conditions (FIG. 2D). The final dried material is a white sponge-like solid, as shown by the photographed portion of FIG. 2D. The dried material will herein be referred to as a ‘porous gel’.

The making of the porous gels 209 is unique in many ways. There are several key differences compared to previous approaches in the art, and these differences will be important in analyzing the microstructure and performance of the gels described herein. First, the use of a DBS 200 and the acid-base reaction to generate the foam 203 in situ whereas most researchers have simply added NaHCO₃ (base) to an acidic monomer solution including surfactant and agitated the sample to produce the foam 203. The DBS 200 gives rise to smaller bubbles and a more homogenous foam compared to agitation. Second, a polymeric stabilizer (hmC) rather than a small-molecule surfactant to stabilize the foam 203. The hmC described herein has hydrophobic n-alkyl tails attached to more than 10% of the amines along the chitosan backbone. The hmC chains 208 adsorb on the gas bubbles, with the hydrophobic tails directed towards the gas phase (see schematic in FIG. 2C). The presence of hmC at the gas-liquid interface ensures that the bubbles remain intact during the polymerization. Lastly, LAP can be used, which is a well-known UV initiator that is highly efficient at producing free-radicals upon irradiation. Thereby, the completion of UV polymerization is made possible in just two minutes (2 min). By doing the polymerization quickly, the porosity is locked-in in the final gel, without the bubbles dissipating away. For comparison, other water-soluble UV initiators were tried such as Irgacure 2959. In that case, more than thirty minutes (30 min) were needed to complete the polymerization, during which time the foam 203 largely dissipated, leaving a gel with few pores.

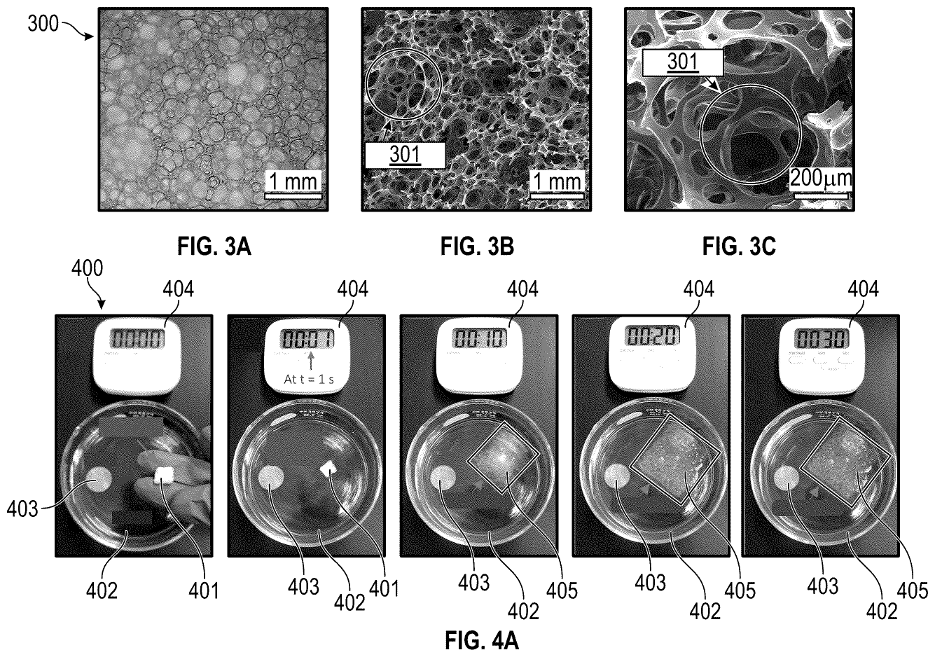

The microstructure of an initial foam 300 and the corresponding dried gel are presented in FIGS. 3A-3C. The foam 300 was prepared with a monomer composition of 18.75 wt % AAc, 6.25 wt % AAm, and 0.375 wt % BIS. 0.5 wt % hmC was used as the foam stabilizer. Optical micrographs of the foam (FIG. 3A) reveal close-packed gas bubbles with an average diameter of 400 μm. These bubbles will form the pores 301 in the gel once the monomers are polymerized around the bubbles. SEM micrographs of the gel after ambient drying (FIG. 3B) show interconnected pores 301 and thereby an extensive network of open microchannels. The average pore diameter from ImageJ analysis is 211 μm with a standard deviation of 95 μm. Comparing the SEM and optical micrographs, it appears that the majority of bubbles in the foam are retained during polymerization and thereby manifested as pores 301 in the dried gel. The porosity ε_{gel} of the dry gel can be estimated from density measurements:

$${ε}_{gel} = 1 - \frac{{ρ}_{gel}}{{ρ}_{bulk}}$$

where ρ_{gel} is the density of the dry gel and ρ_{bulk} is the density of the bulk, non-porous solid. From the measured values in this case for ρ_{gel} (0.109 g/cm³) and ρ_{bulk} (1.187 g/cm³), ε_{gel} is found to be 91%, indicating the gel is a highly porous material.

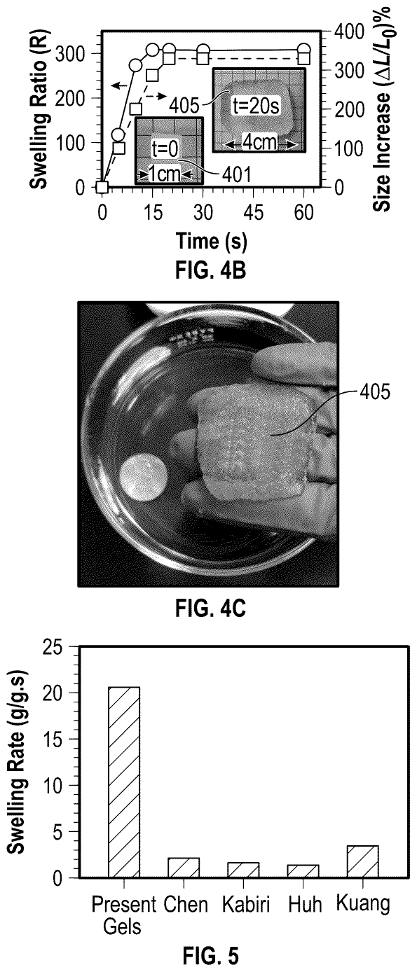

The swelling process 400 of the dried porous gels in water is shown in FIGS. 4A-C. As shown in FIG. 4A, at t=0, a dried gel 401 of dimensions 10×10×5 mm (left image) is placed in water 402 and allowed to swell (middle-left image). A coin 403 is shown in the image to facilitate an understanding of said dimensions. Within ten seconds (10 s) as shown on the clock 404, the gel expands appreciably and becomes transparent (middle image). The swelled gel 405 reaches its equilibrium size in just twenty seconds (20 s) (middle-right image), beyond which the size remains constant. The above experiment was quantified in terms of two parameters, the first being the swelling ratio R=mass of swollen gel/mass of dry gel. A plot of R vs. t is shown in FIG. 4B. R increases linearly to more than one hundred (100) in the first five seconds (5 s) and to three hundred (300) in fifteen seconds (15 s); beyond twenty seconds (20 s), R plateaus at three hundred (300). This implies a swelling rate around twenty (20) g/g·s from initial to final size. Correspondingly, the gel size increase is quantified as ΔL/L₀, where L₀ is the initial length (ten millimeters: 10 mm) and L the expanded length at time t. The gel dimensions double (i.e., increase by one hundred percent (100%)) in just five seconds (5 s) and the dimensions plateau at 4× their original values (implying a 300% increase) in fifteen seconds (15 s). These numbers translate to an expansion rate of twenty percent per second (20%/s). After the swelling is complete, the swollen gel with three hundred times (300×) its weight in water (and four times (4×) its original size) is still robust enough to be picked up by hand out of the container, as shown in FIG. 4C.

From FIGS. 4A-4C, it is evident the porous gels swell and expand rapidly and to an appreciable extent (R=300; 4× the original size). Such rapid and appreciable swelling can be easily observed by the eye in real time. In comparison with other superabsorbent gels known in the art, the superabsorbent porous gels described herein have the fastest swelling-rate.

A comparison with the best swelling rates reported for other (macroscale) porous gels is shown in FIG. 5. The porous gels of Chen et al., “Synthesis of Superporous Hydrogels: Hydrogels with Fast Swelling and Superabsorbent Properties.” J. Biomed. Mater. Res. 1999, 44, 53-62; Kabiri et al., Porous Superabsorbent Hydrogel Composites: Synthesis, Morphology and Swelling Rate.” Macromol. Mater. Eng. 2004, 289, 653-661; Huh et al., “Enhanced Swelling Rate of Poly(Ethylene Glycol)-Grafted Superporous Hydrogels.” J. Bioact. Compat. Polym. 2005, 20, 231-243; and Kuang et al., Dinu, M. V.; Ozmen, M. M.; Dragan, E. S.; Okay, 0. “Freezing as a Path to Build Macroporous Structures: Superfast Responsive Polyacrylamide Hydrogels.” Polymer 2007, 48, 195-204; all reached swelling ratios R in the 200-300 range, but only did so over timescales of a minute or more. Thus, the swelling rates calculated from these studies are 1-3 g/g·s, whereas it is nearly 10 times (10×) higher at 20 g/g·s for the super-absorbent porous gels described herein. The same data are also provided in the table below, along with details of the gel chemistry in each study.

TABLE 1
Porous gels that swell rapidly and to a high extent

| | Gel | Equilibrium | Equilibrium | Swelling | Author, |
|---|---|---|---|---|---|
| | synthesis | swelling | swelling | rate | Year/ |
| Gel chemistry | method | ratio (g/g) | time (s) | (g/g · s) | Reference |
| Acrylic acid- | Foam- | 310 | 15 | 20.6 | Present |
| Acrylamide (Ionic) | templating | | | | disclosure |
| Acrylic acid- | Foam- | 368 | 168 | 2.2 | Chen et al., |
| Acrylamide (Ionic) | templating | | | | 1999 |
| Acrylic acid (Ionic) | Foam- | 350 | 200 | 1.8 | Kabiri et al., |
| | templating | | | | 2004 |
| PEG-grafted- | Foam- | 178 | 120 | 1.5 | Huh et al., |
| Acrylic acid- | templating | | | | 2005 |
| Acrylamide (Ionic) | | | | | |
| Acryloyloxystarch | Foam- | 215 | 60 | 3.6 | Kuang et al., |
| sulfate-Acrylic acid | templating | | | | 2011 |
| (Ionic) | | | | | |

The following table shows data for a second set of porous gels made by cryogelation.

TABLE 2
Porous hydrogels that swell rapidly but to a low extent

| | Gel | Equilibrium | Equilibrium | Swelling | Author, |
|---|---|---|---|---|---|
| | synthesis | swelling | swelling | rate | Year/ |
| Gel chemistry | method | ratio (g/g) | time (s) | (g/g · s) | Reference |
| Acrylamide | Cryogelation | 40 | 4 | 10.0 | Dinu et al., |
| (Non-ionic) | | | | | 2007 |
| PEGDA (Non- | Cryogelation | 14 | 10 | 1.4 | Wu et al., |
| ionic) | | | | | 2007 |
| Chitosan- | Cryogelation + | 33.5 | 90 | 0.4 | Dinu et al., |
| hydroxyethyl | porogen | | | | 2013 |
| methacrylate | | | | | |
| (Ionic) | | | | | |
| N,N-dimethyl | Cryogelation | 22.5 | 120 | 0.2 | Dragan et |
| aminoethyl | | | | | al . . . 2016 |
| methacrylate | | | | | |
| acrylamide | | | | | |
| (Weakly ionic) | | | | | |
| N-isopropyl | Cryogelation | 35 | 40 | 0.9 | Strachota et |
| acrylamide- | | | | | al., |
| sodium | | | | | 2019 |
| methacrylate | | | | | |
| (Ionic) | | | | | |

These have higher swelling rates (up to 10 g/g·s), but their swelling ratios R are below 40. A further comparison to make is regarding the expansion rate. The expansion rate of approximately 20%/s for the present superabsorbent porous gels thus appears to be the highest reported to-date. Importantly, the ˜20%/s expansion is fast enough (and appreciable enough) to allow work to be extracted from the expanding gel, as will be demonstrated infra.

The higher swelling rate of the gels is attributed to differences in the porous microstructure (FIGS. 3A-3C). SEM micrographs of porous gels made in previous studies show well-separated, rather than interconnected pores and the porosities reported in these studies are generally lower than those of the present disclosure. The higher porosity and the interconnected pores, in turn, arise due to the different synthesis method used here, which was summarized in terms of three factors: (a) use of a DBS 200 to create an in situ foam 300; (b) use of an amphiphilic polymer rather than a small-molecule surfactant as the foam stabilizer; and (c) rapid UV polymerization around the bubbles. Thus, the novel aspects of the synthesis revolve around both colloid science (foam generation and stabilization) as well as polymer science (fast polymerization around a template).

The swelling/expansion of superabsorbent porous gels can be tuned as follows. The composition of the polymerizing mixture affects the swelling of the porous gels. The first variable contemplated is the ratio of ionic (AAc) to nonionic (AAm) monomers. The total monomer was kept at 25 wt % and varied the AAc:AAm weight ratio (0:1, 1:3, 1:1, 3:1 and 1:0). The BIS crosslinker was fixed at 0.375 wt %, and the hmC was fixed at 0.5 wt % across all these samples. Ionic gels swell much more than nonionic gels. There are two reasons for this: firstly, the charged polymer chains will electrostatically repel each other, and secondly, the osmotic pressure will be higher in ionic gels due to the counterions.

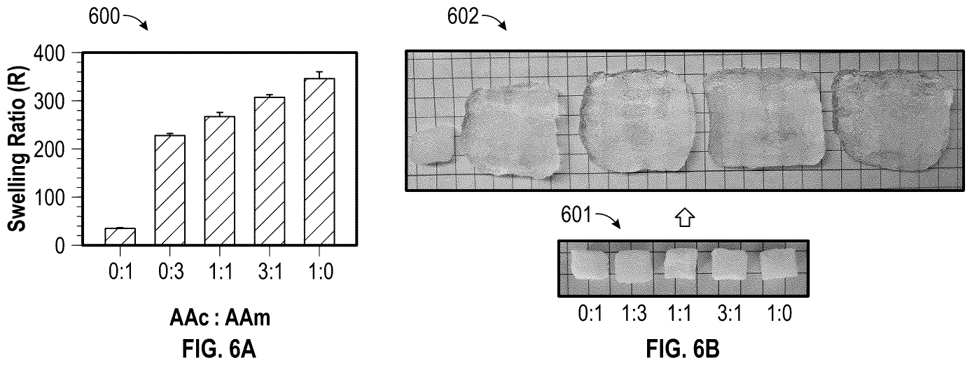

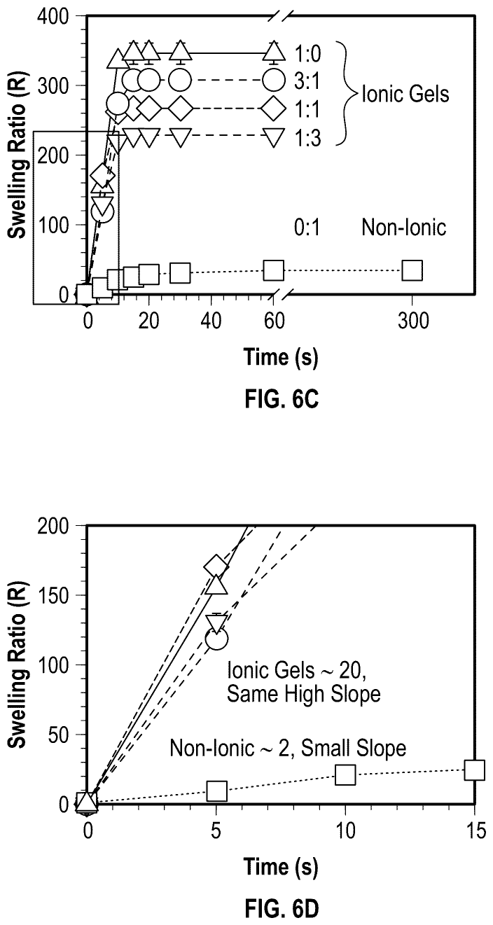

The data 600 for the swelling of different initial gels 601 and their swollen sizes 602 are shown in FIG. 6A. FIG. 6A shows that the higher the fraction of ionic monomer, the greater the swelling ratio R for the gels. Specifically, the pure nonionic gel (0:1) absorbs very little water (R=35) whereas the pure ionic gel (1:0) swells ten times (10×) as much (R=350). These differences are also evident from the images in FIG. 6B, comparing the dry and expanded gels in their swollen state. Pure ionic gel(s) can swell so quickly that care must be taken when handling. In comparison, the gel with the 3:1 AAc:AAm ratio swelled up to R=310 and still had adequate mechanical integrity in its expanded state. So, this was the composition of choice, which is employed in FIGS. 3A-3C and 4A-4C.

The swelling rate of these gels and plots of R vs. t are shown in FIGS. 6C-6D. All the ionic gels, regardless of the ionic monomer content, swelled at a high rate (˜20 g/g·s) and were fully swollen within 20 s. This result suggests that all the ionic gels have similar porosity and pore-connectivity.

Next, the effect of crosslink density on gel-swelling was examined. For this, porous gels were prepared at various concentrations of the crosslinker BIS. In the porous gels (FIGS. 3A-3C, 4A-4C), the BIS was fixed at 0.375 wt %, which corresponds to 0.7 mol % relative to the total monomer (AAc+AAm). The BIS fraction was varied from 0.2 to 7.5 mol % while keeping the total monomer at 25 wt %, the AAc:AAm ratio at 3:1, and the hmC at 0.5 wt %.

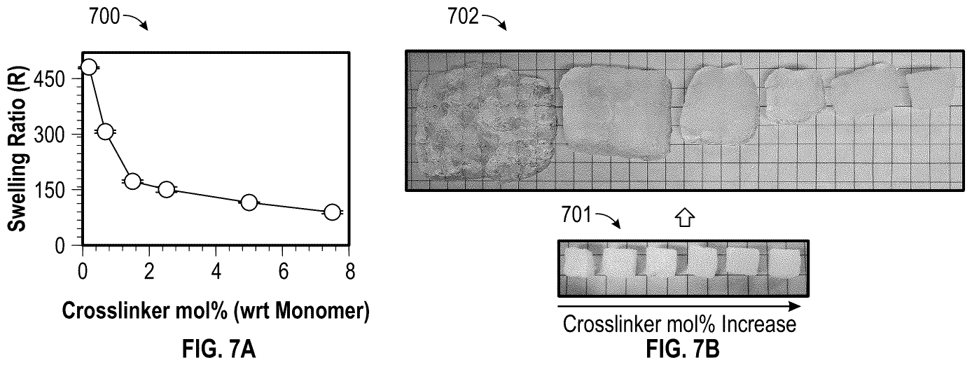

FIGS. 7A-7B shows data 700 regarding the swelling ratio R for these gels as a function of BIS mol %. R decreases as BIS increases (FIG. 7A). This is because, when the crosslink density is higher, chain segments between crosslinks will be stretched more as the gel expands and thereby pay a higher entropic penalty for swelling. Differences in R are also shown by the images in FIG. 7B comparing the sizes of the dry gels 701 and swollen gels 702. The highest R=450 is for the lowest BIS (0.2 mol %) and this gel expands the most, whereas R is reduced to 90 for the highest BIS studied (7.5 mol %). The gel with 0.2 mol % BIS lacked mechanical integrity, which is why it can be beneficial to fix BIS at approximately 0.7 mol % (i.e., 0.375 wt %).

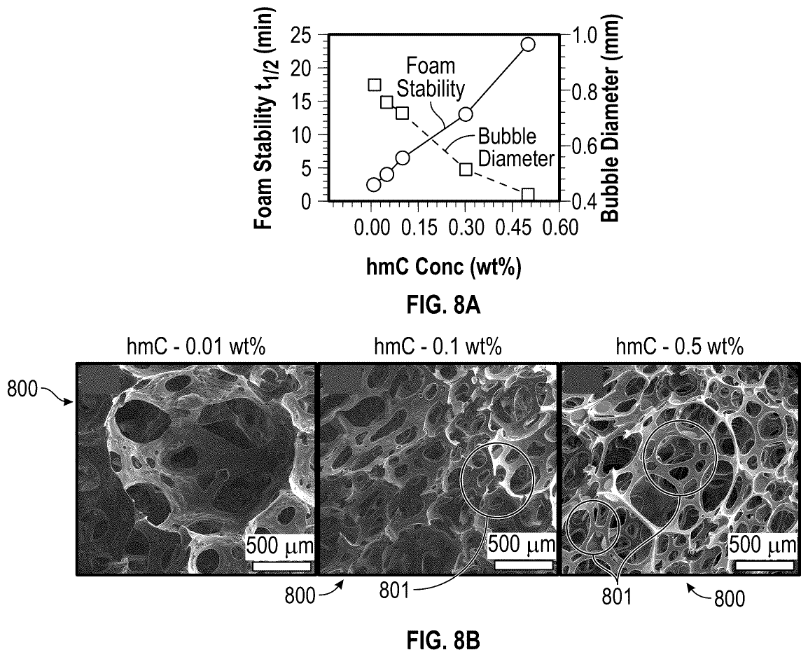

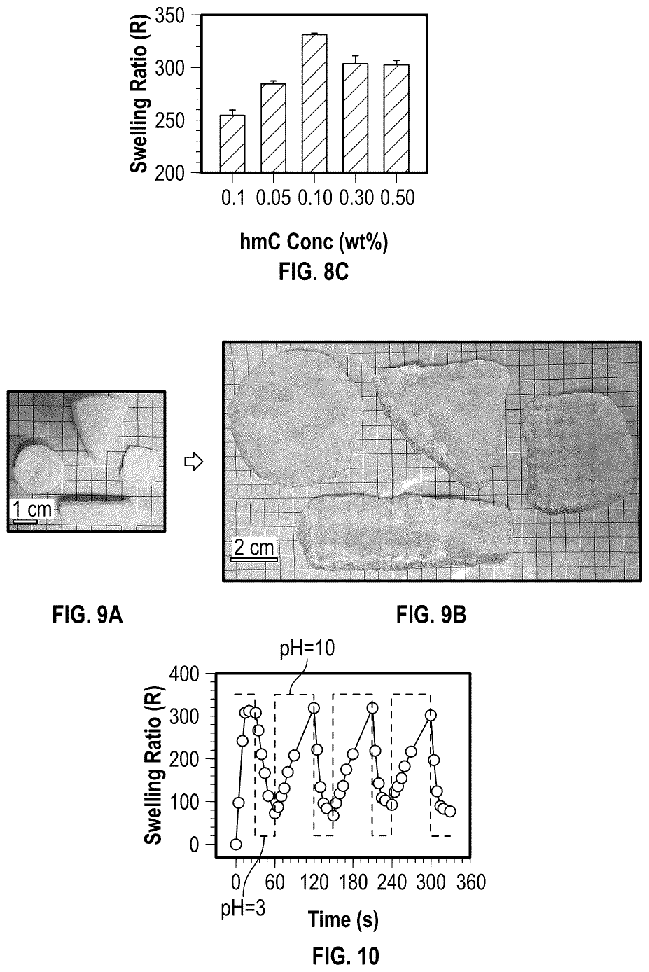

The concentration of the hmC stabilizer can also be varied. This has an effect on the stability of the foams 800 and thereby on the synthesis of the resultant porous gels. In the embodiments of FIGS. 8A-8C, the total monomer was 25 wt %, the AAc:AAm ratio at 3:1, and the BIS at 0.375 wt %. The hmC was varied between 0.01 and 0.5 wt % and first, the foams 800 were analyzed for their extent of stability as well as their microstructure. Foams were injected into vials and the foam height was recorded vs. time. The half life t_{1/2}, which is the time when the foam dissipates to half its initial height, was used as an indicator of foam stability. See Choudhary et al., “Foams with Enhanced Rheology for Stopping Bleeding.” ACS Appl. Mater. Interfaces 2021, 13, 13958-13967; and Dowling et al., “Sprayable Foams Based on an Amphiphilic Biopolymer for Control of Hemorrhage Without Compression.” ACS Biomater. Sci. Eng. 2015, 1, 440-447, both of which are hereby incorporated by reference herein each in its respective entirety.

Optical micrographs of the foams 800 were analyzed by ImageJ and the average bubble diameter D_{avg} was measured. These two parameters (t_{1/2} and D_{avg}) are plotted in FIG. 8A. As the hmC is raised, t_{1/2} increases, indicating that the foams 800 become more stable, likely because the bubbles are more densely coated with hmC chains. For instance, the t_{1/2} for 0.5 wt % hmC is around 25 min whereas for 0.01 wt % hmC, it is just two minutes. Correspondingly, the bubble diameter D_{avg} is smaller in the more stable foams—there is a halving of D_{avg} as hmC is increased from 0.01 to 0.5 wt %. This is because hmC promotes smaller bubbles (i.e., higher gas-liquid interfacial area) as hmC adsorption reduces the interfacial tension.

Porous gels produced by templating the above foams 800 were analyzed by SEM. At the lowest hmC tested (0.01 wt %), t_{1/2} for the foam 800 (two minutes) is comparable to the time it takes to generate and polymerize the foam 800 (two to three minutes). Thus, a large fraction of the bubbles in this foam 800 would have vanished or coalesced into larger bubbles before they could be entrapped by polymerization. This is reflected in the SEM images of the resulting porous gel (FIG. 8B), where only a few large pores are seen, and these do not seem to be interconnected with all their neighbors. In the case of a 0.1 wt % hmC foam, the t_{1/2} for the foam is increased to five minutes (5 min), and the SEM of the resulting porous gel reveals numerous interconnected pores 801. This indicates that the bubbles in this foam 800 do remain intact sufficiently long to get locked in by polymerization. Interestingly, the swelling ratios for these porous gels (FIG. 8C) indicate that the swelling is highest for the 0.1 wt % hmC foam (R=330) whereas upon raising the hmC to 0.5 wt %, there is a slight decrease in R to ˜300. It is to be appreciated that at 0.5 wt % hmC, the t_{1/2} of twenty five minutes is ample time for completing the polymerization (which can take just two minutes). In other words, the bubbles in the foam largely stay intact as UV polymerization is conducted.

The technique for synthesizing porous gels is versatile and allows gels to be made in various shapes. This can be done by simply taking a mold of desired shape and injecting the foam into the mold, followed by polymerization. Porous gels with circular, triangular, and rectangular cross-sections are shown in FIGS. 9A-9B. Upon swelling in water, all these gels retain their shape while swelling by R˜300. The expansion is isotropic, and each dimension of the dry gel pieces increases by ˜3× in the swollen state. Such isotropic expansion implies that the pores in the dry gel are also isotropic, i.e., oriented along random directions.

pH-Induced Expansion/Contraction of the superabsorbent porous gels can be carried out as follows. The polymer chains in the porous gels are anionic due to the ionic monomer (AAc) used, which means that there will be carboxylate (COO—) groups along the chains. These groups will remain ionized (deprotonated) as long as the pH is above the acid dissociation constant (pKₐ) of AAc (4.2). However, when the pH is reduced below the pKₐ, the groups will be protonated (to COOH) and the gel will then behave like a nonionic gel. As seen in FIG. 6A, nonionic gels swell and expand much less than ionic ones. Thus, a reduction in pH will cause an expanded ionic gel to shrink and collapse.

This was studied by repeated incubation of a gel in water at pH 3 (below the pKₐ) and pH 10 (well above the pKₐ). The results, shown in FIG. 10, are for a gel with the same composition as the embodiment of FIGS. 3A-3C and 4A-C. First, the dry gel was swollen in pH 10 water. This takes approximately twenty seconds (˜20 s). Next, the swollen gel (R=300) was removed and placed in pH 3 water. The swollen gel shrunk to a much smaller size (R=60) in just thirty seconds (30 s). A full first cycle was thus completed in about sixty seconds (60 s). Next, in a second cycle, the shrunken gel reswelled in pH 10 water and took ˜60 s to expand to its initial size (R=300), while at pH 3 the gel shrunk again to an R of sixty (60) in thirty seconds (30 s). The timescales and swelling extents were similar for the third and fourth cycles; each full cycle was completed in about ninety seconds (90 s). The results demonstrate that the porous gel is capable of fast and reversible transitions between expanded and contracted states by changing the pH. Note also that the gel is able to mechanically withstand repeated cycling.

Similar cycling between swollen and shrunken states can be induced in other ways. For example, a swollen gel can be shrunk by placing in it water (at ambient pH) including a high concentration of salt (NaCl). The shrinking in this example will occur because salt ions will screen the electrostatic repulsions between chain segments in the gel. The gel also can be shrunk by placement in a water-miscible solvent like ethanol. In this case, the shrinking can be attributed to two reasons. First, the ionic groups along the polymer chains will be less ionized (i.e., revert to their undissociated form) in a solvent of lower polarity than water. Second, the affinity of the polymer for the solvent (enthalpic contribution to gel swelling) will be reduced when in ethanol compared to water.

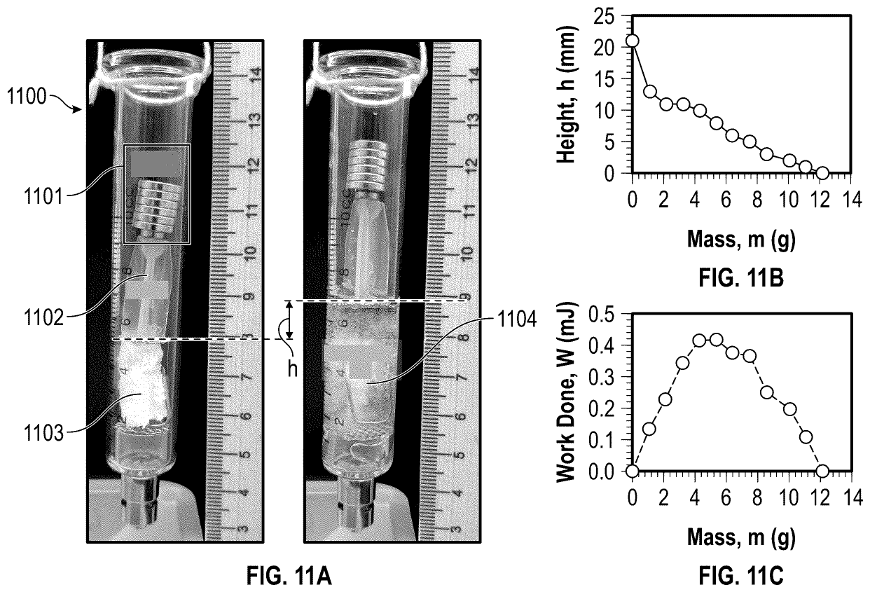

Gel expansion upon swelling can be harnessed to perform mechanical work. Converting the chemical energy in a gel to mechanical energy has been a long-standing challenge in the art. In an embodiment, a porous gel 1103 in the form of a long cylinder (˜2 cm) and a diameter of five millimeters (5 mm) weighs forty milligrams (40 mg). The porous gel 1103 was placed vertically in a glass syringe 1100 and a load 1101 of mass m was placed on top of the porous gel (FIG. 11A, left photo). Water was then added slowly from the top, which induced the gel 1103 to expand rapidly in all directions. As the gel 1103 expands, it is thereby able to lift the load 1101 up by pushing a piston 1102 by a certain height h against gravity (FIG. 11A, right photo). Because of the long cylindrical shape of the expanded gel 1104, the expansion in the vertical direction is readily visible in real time or near real-time.

The work done over the entire process in FIGS. 11A-11B is W=mgh, where g is the acceleration due to gravity. Upon increasing the load 1101, the height h to which the gel 1103 can lift the load 1101 decreases (FIG. 11B), which is to be expected—but more work is done in lifting a heavier load 1101 of six grams (6 g) than a lighter one of two to three grams (2-3 g). A plot of W vs. mass m (FIG. 11C) shows a peak in W at m˜6 g, and for higher m, W decreases. The peak in W corresponds to forty two hundredths mega joules (0.42 mJ) of energy, which is when the gel 1103 lifts a load 1101 of five and three tenths grams (5.3 g) by eight millimeters (8 mm). Lifting is done in approximately forty seconds (˜40 s), indicating a power of about ten and a half microwatts (10.5 μW), and when divided by the gel mass (40 mg), a power density of two hundred sixty megawatts per kilogram (260 mW/kg) is obtained. For comparison, a recent attempt at using microscale gel beads in an osmotic engine was able to achieve a slightly lower power density of two hundred thirty megawatts per kilogram (230 mW/kg). In the art, the gel beads were placed on a sieve (i.e., it was not a macroscopic gel), and the work done by the gel beads was used to push an external load of six kilopascals (6 kPa) over a period of ten minutes (10 min). While the load was larger, their timescale was fifteen times (15×) slower than that of the porous gels of the present disclosure.

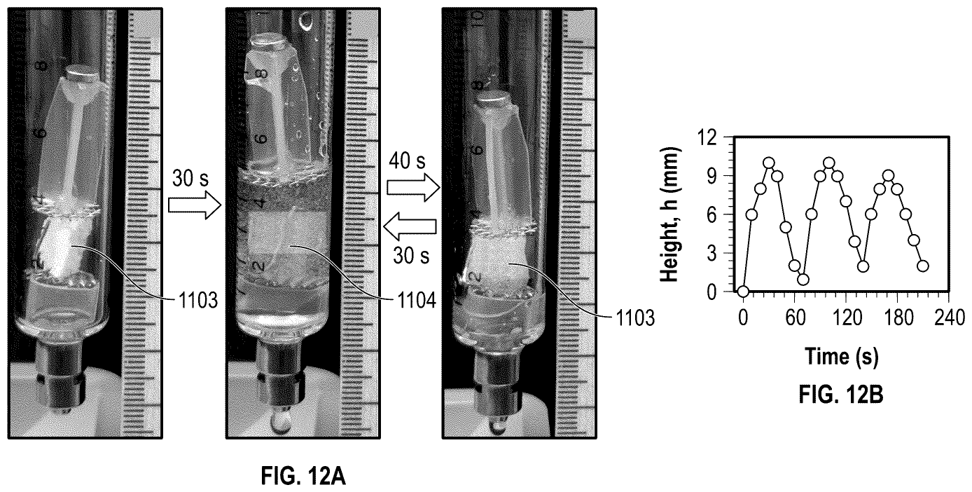

The work done by the porous gel can also be cycled in a reversible fashion, as shown in FIGS. 12A-12B. The setup is similar to that in FIGS. 11A-C, with a cylindrical gel placed vertically in the barrel of a syringe and a load of one gram (1 g) on top of it (FIG. 12A, left image). When water is added from the top, the gel expands and lifts the load up by a height of around ten millimeters (10 mm) in thirty seconds (30 s) (FIG. 12A, middle image). Next, ethanol is added from the top, and this causes the gel to contract, thereby lowering the load to roughly its initial position (FIG. 12A, right image). This contraction occurs in approximately forty seconds (40 s). The cycle is repeated by adding fresh water, followed by ethanol. The plot of load height vs. time over three cycles is shown in FIG. 12B. A full cycle takes about seventy seconds (70 s). As shown in FIG. 12B, there is a slight decrease in the height reached in cycles 2 and 3 compared to cycle 1, and this is because not all the solvent is removed from the gel from cycle to cycle. Nevertheless, rapid and reversible work can still be extracted out of the gel over timescales comparable to those shown earlier in FIGS. 4A-4C and FIG. 10.

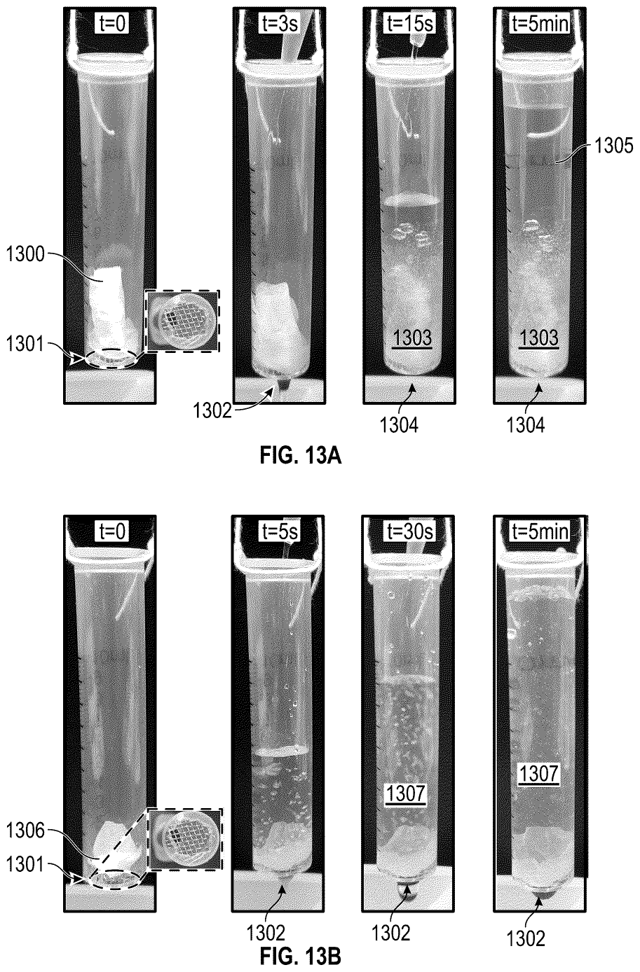

Rapid gel-expansion can also prove useful in other contexts apart from mechanical lifting of loads. One possibility is in blocking the flow of water, which can become important in homes that are in danger of flooding. There already exist products in the market (based on gel beads) that claim to be able to create a barrier that can block and divert flood water. A setup was constructed in the lab to evaluate flow-blocking—one allowing a comparison between the macroscopic porous gel 1300 and gel beads (FIGS. 13A-13B). The setup involves the barrel of a syringe whose bottom is covered with a wire mesh 1301 that allows flow 1302 of water out. A small piece of a paper towel is placed on the wire mesh 1301 and a cylindrical gel forty milligrams (40 mg) is placed on it (FIG. 13A, left image). When water is added from the top, initially it flows out of the wire mesh at the bottom (FIG. 13A, middle left image at t=3 s). But by t=fifteen seconds (15 s), the expanded gel 1303 has fully expanded and filled up the syringe, thereby completely causing a complete water blockage 1304 of the downward flow 1302 of water (FIG. 13A, middle right image). No flow 1302 of water occurs for subsequent times (FIG. 13A, right image), indicating that the expanded gel 1303 has formed an effective barrier. Note that there is a column of free water 1305 above the gel 1303 in (Figure A, middle right and right images).

For comparison, experiments were conducted with gel beads 1306. In the experiment shown in FIG. 13B, an equivalent weight of forty milligrams (40 mg) of sodium polyacrylate gel beads 1306 (that are commonly used in diapers) is placed on the paper towel (FIG. 13B, left image). When water is added from the top, the beads 1306 start swelling, but a flow 1302 of water still flows out at the bottom (FIG. 13B, middle left image). As more water is added, the beads 1306 continue to swell and become thickened gel beads 1307. The water column 1305 also gets thickened as a result. But flow 1302 of water continues to flow out through the bottom of the tube (FIG. 13B, middle left and left images), indicating that the gel beads 1306 are unable to form a sufficient barrier to water flow. The more water that is added, the more the beads tend to get ‘diluted’ in the water column. In a variation of this experiment, the beads were placed in an enclosed ‘pouch’ above the wire mesh (water could still enter the pouch). In this case, the beads swelled in the pouch, but water still flowed around the pouch and out at the bottom. Collectively, the experiments in FIGS. 13A-13B demonstrate the advantages of a macroscopic fast-expanding gel over gel beads.

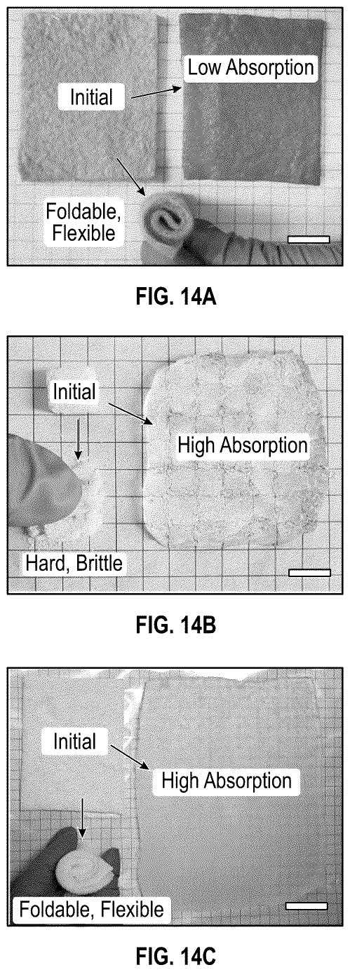

The current state-of-the-art is characterized by absorbent materials that do not simultaneously achieve the convenience and durability of cloth or paper (FIG. 14A) as well as the absorbency of SAPs (FIG. 14B).

Referring now to FIG. 14C through FIG. 29, the present disclosure shows that for the first time that absorbents can be made in a cloth or fabric-like form, e.g., as flexible sheets, a few millimeters thick, while still retaining a capacity to rapidly absorb large amounts of water. These absorbent sheets are created by a simple and scalable process that allows sheets to be prepared at macroscopic sizes (e.g., 10×10 cm) in the lab. The process involves foam templating, where a gel of acrylate monomers is formed around CO₂, bubbles, followed by ambient drying of this gel. The dried sheets are flexible and soft—they can be folded and rolled up like fabrics, (FIG. 14C). At the same time, the sheets are robust—they can sustain a tensile stress up to 2 kPa and compression by 85% without being damaged. While the sheets have a fabric-like feel, they still behave like hydrogels. Unlike any sponges or absorbents made from fabric or paper, the gel-sheet shown in FIG. 14C expands as they absorb liquids. The sheets can absorb a variety of aqueous fluids, including blood, and their absorption capacity is high. Due to their unique properties, these gel-sheets could be useful in cleaning up spilled liquids in a variety of locations, including homes, labs, and hospitals. They could also be useful tools for absorbing biological fluids during surgeries or other medical procedures.

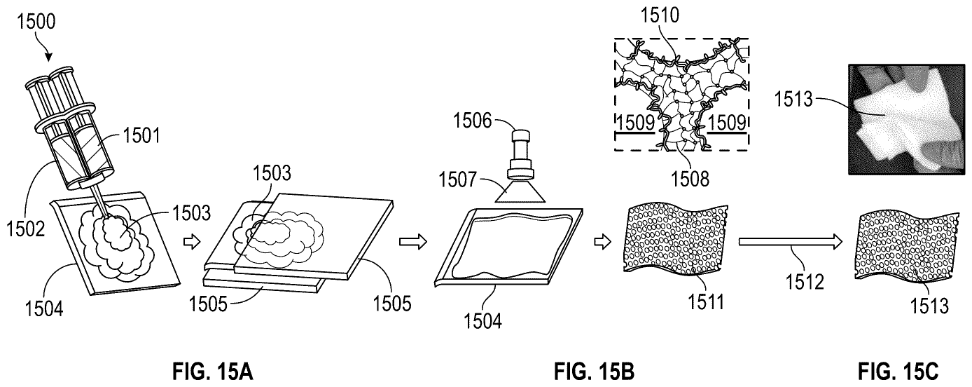

The first step in synthesizing the gel-sheets is to make a stable foam 1503 containing the monomers, which is then polymerized by ultraviolet (UV) light 1507 (FIGS. 15A-15C). To make the foam, a double barreled syringe (DBS) 1500 can be used. In a first barrel 1501 of the DBS 1500, a solution is loaded in acetic acid (CH3COOH) of the monomers acrylic acid (AAc) and acrylamide (AAm), the crosslinker polyethylene glycol diacrylate (PEGDA), and a polymeric stabilizer. In the other barrel 1502, a solution of the photoinitiator lithium acylphosphinate (LAP) is used in sodium bicarbonate (base). When both barrels 1501, 1502 of the DBS 1500 are plunged, the acid and base meet at the mixing tip, whereupon the following reaction occurs:

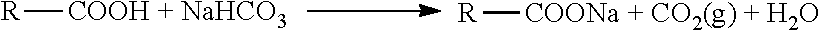

This results in the release of carbon dioxide (CO₂) gas 1509 in the form of bubbles. The polymeric stabilizer, which is hydrophobically modified chitosan (hmC), adsorbs on the bubbles and thus stabilizes them. See Dowling et al., 2011; Dowling et al., 2015; and MacIntire et al., 2020. The foam is extruded out of the DBS 1500 into a bag 1504 (e.g., Ziploc bag) whose end is then closed (FIG. 15A). The bag 1504 with the foam 1503 is then compressed between two glass slabs 1505 to spread the foams uniformly. Next, the foam 1503 is exposed to UV light 1507 from a UV light source 1506 at room temperature for a time, such as two minutes (2 min: FIG. 15B). The monomers thus get polymerized into a polymer network 1508 around the gas bubbles (FIG. 15B). At this stage, a gel with pores can be obtained by cutting the bag 1504 and taking the gel out. This porous gel 1511 is allowed to swell in water, then removed and placed in a mixture of glycerol and ethanol. After the solvent exchange 1512 is complete, the gel sheet 1511 is dried under ambient conditions (FIG. 15C). The final dried material 1513 is a soft fabric-like sheet, which is herein referred to as a ‘gel-sheet’ in the present disclosure.

A DBS utilizing an acid-base reaction to generate the foams in situ is very advantageous. See the discussion of FIG. 1C through FIG. 13B, supra, and Choudhary et al., 2021. The DBS allows the foams to be easily injected into a Ziploc bag and spread into a thin layer before polymerization. The volume of injected foam and the size of the Ziploc bag determine the dimensions of the gel-sheet and can be easily controlled. Also, as shown previously, the foams are very stable (foam half-life >25 min) due to the use of hmC as a stabilizer. Chains 1510 of this amphiphilic polymer adsorb on the bubbles and ensure that the bubbles remain mostly intact even as the foam is compressed between the glass slabs and thereafter during polymerization (which is completed in just two minutes). Thus, the porosity from the bubbles is retained in the gel-sheet. Lastly, a solvent exchange is performed with a glycerol-ethanol solution before drying under ambient conditions. Glycerol is well known to be a plasticizer for hydrophilic polymers, and it ensures that the dried gel-sheet is soft and flexible. On the other hand, ethanol due to its low surface tension prevents the pores from collapsing during drying.

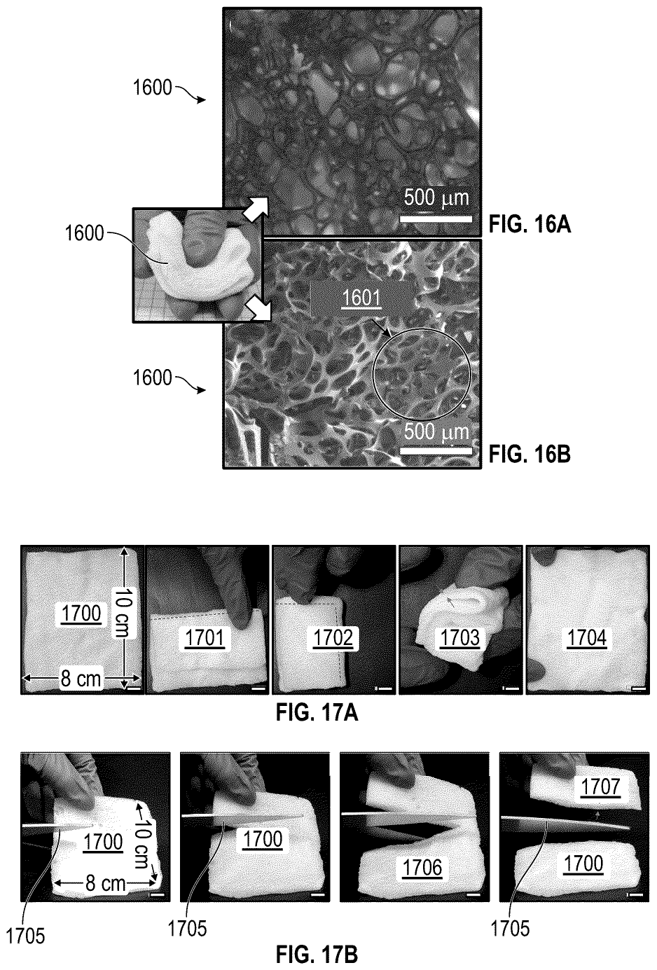

The microstructure of a gel-sheet is shown in the optical and SEM micrographs presented by way of FIGS. 16A-16B. For this, the monomers used were 18.75% AAc and 6.25% AAm, while the concentration of PEGDA crosslinker was 2.5 mol % with respect to the total monomer. The aqueous gel (with pores) was solvent-exchanged in a 15/85 glycerol/ethanol solution and then dried at ambient conditions. The dried gel-sheet looks white and is shown in a folded form in FIGS. 16A-16B.

The micrographs reveal the porous nature of the sheet, with the pores being interconnected and forming a network of open microchannels. These channels facilitate the absorption of liquids into the gel-sheet through capillary action. The porosity ε_{gel} of the dry gel-sheet can be estimated from density measurements:

$${ε}_{gel} = 1 - \frac{{ρ}_{gel}}{{ρ}_{bulk}}$$

where ρ_{gel} is the density of the dry gel and ρ_{bulk} is the density of the bulk, non-porous solid. ε_{gel} was found to be 84%, indicating that the gel is highly porous. Analysis using ImageJ revealed the average pore size to be 240 μm.

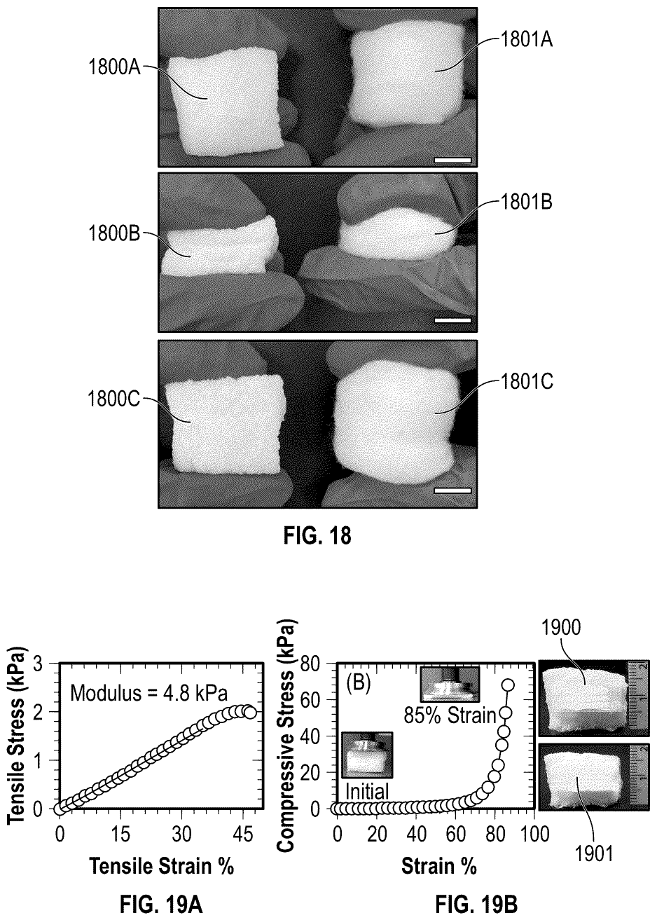

Gel-sheets of dimensions 10×8 cm and a thickness of ˜4 mm were created and are shown in FIG. 17A with the composition indicated above. The sheet's robust nature is shown by the five images of FIG. 17A: it can be folded and unfolded several times, or it can be rolled up and twisted—in all cases, there is no tearing or visible damage even after multiple cycles of such deformations. In terms of touch and feel (texture), the gel-sheet is very much like a sheet of cloth or fabric. FIG. 17B shows that the gel-sheet can be easily cut using a pair of scissors. Here again, the cut edges are smooth and clean, much like a fabric (the four images of FIG. 17B). A gel-sheet was also prepared with a higher thickness of 15 mm, and a piece 1800A (uncompressed state) of 2.5×2.5 cm size from this sheet is shown in FIG. 18, alongside a cotton ball 1801A (uncompressed state). Both these materials have a similar look and feel—e.g., both can be squeezed repeatedly between one's fingers (see compressed states 1800B, 1801B) and can resiliently return to their original configuration (see compressed states 1800C, 1801C).

The mechanical properties of the gel-sheet under tension 1900 and the gel sheet under compression 1901 are characterized as follows. For tensile tests, the sheet was cut into a dog-bone shape with an overall length of thirty five millimeters (35 mm) and a width in the narrow region of fourteen (14 mm). The piece was gripped on each end by the jaws of the instrument and stretched at a constant rate of two millimeters per minute (2 mm/min). The corresponding stress vs. strain plot (FIG. 19A) shows a tensile strength of 2 kPa (i.e., the maximum stress at break), a tensile modulus of 4.8 kPa, and a tensile strain of 45% before failure. For testing under compression, a thicker piece having the same dimensions as in FIG. 18 (15 mm thickness) was used. A plot of compressive stress vs. strain corresponding to a 50 m/s rate of compression is shown in FIG. 19B. The piece can be compressed up to 85% of its size, at which point the stress reached the instrument limit and the experiment was stopped. Upon removing the compression, the piece recovers instantly to its uncompressed state, as can be noted from the photos in FIG. 19B. Even after several such compressive cycles, no damage or plastic deformation is seen, which is consistent with the visual observations from FIG. 18. Collectively, the gel-sheet is shown to have robust mechanical properties. In its thick form, it can be likened to a sponge or cotton, whereas in its thin form it is similar to cloth or fabric. No previous hydrogel has been reported to have such tactile or mechanical properties.

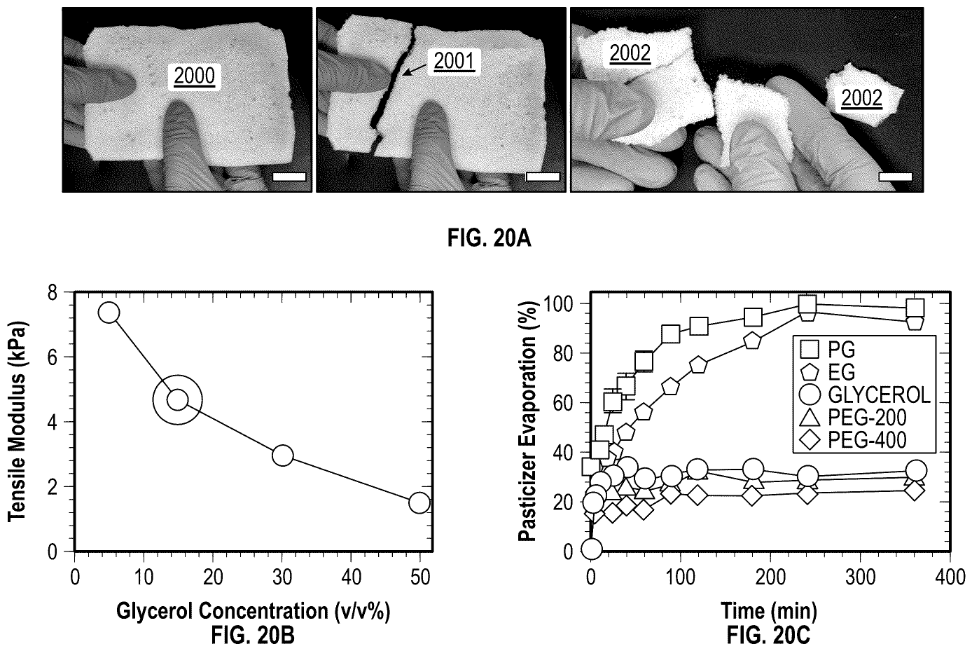

The use of glycerol as a plasticizer is key to the above properties. Plasticizers are small, non-volatile molecules that distribute between polymer chains and decrease inter-chain interactions, thereby improving the flexibility of the material. If no plasticizer is used, e.g., the gel is dried in pure ethanol, the dry gel sheet 2000 is brittle and can break along break line 2001 into pieces 2002 when slightly deformed, as shown in FIG. 20A). The concentration of glycerol was varied as a plasticizer: i.e., in the solvent exchange step, and the gels were soaked in glycerol/ethanol solutions containing 5, 15, 30, 50, and 100% v/v of glycerol before drying under ambient conditions. From these studies, 15% glycerol was determined to be particularly beneficial, optimal. If the glycerol content was higher, the tensile modulus of the gel-sheet became too low (FIG. 20B).

A range of plasticizers were examined in addition to glycerol: specifically, ethylene glycol (EG), propylene glycol (PG), and polyethylene glycol (PEG) of molecular weights (MW) 200 and 400 Da. After the ambient drying step with each of these plasticizers (15% v/v in ethanol), the residual plasticizer was analyzed in the samples by measuring the weight loss upon heating to 70° C. (FIG. 20C). In the cases of EG (boiling point, BP=197° C.) and PG (BP=188° C.), the plasticizers evaporate quickly, leading to a >95% weight loss—and in turn, the samples become brittle. With glycerol (BP=290° C.), PEG-200 and PEG-400 (BP>300° C.), the weight loss plateaus at around 30%. The PEG-plasticized samples still did become brittle after the 70° C. heating step. In contrast, the glycerolplasticized gel-sheets remained soft and flexible even after 3 days at 70° C. To summarize, glycerol is found to be an excellent plasticizer for the gel-sheets due to glycerol being a small molecule with a high boiling point (BP) (low volatility). Even after a year at room temperature, these gel-sheets remained soft and flexible—indicating that the sheets are stable and have a long shelf life.

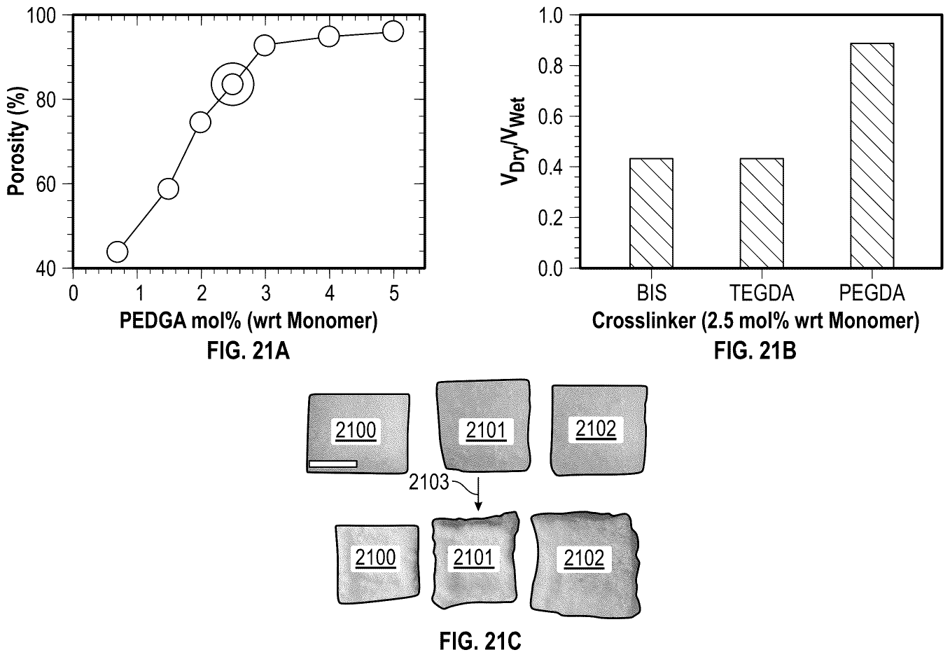

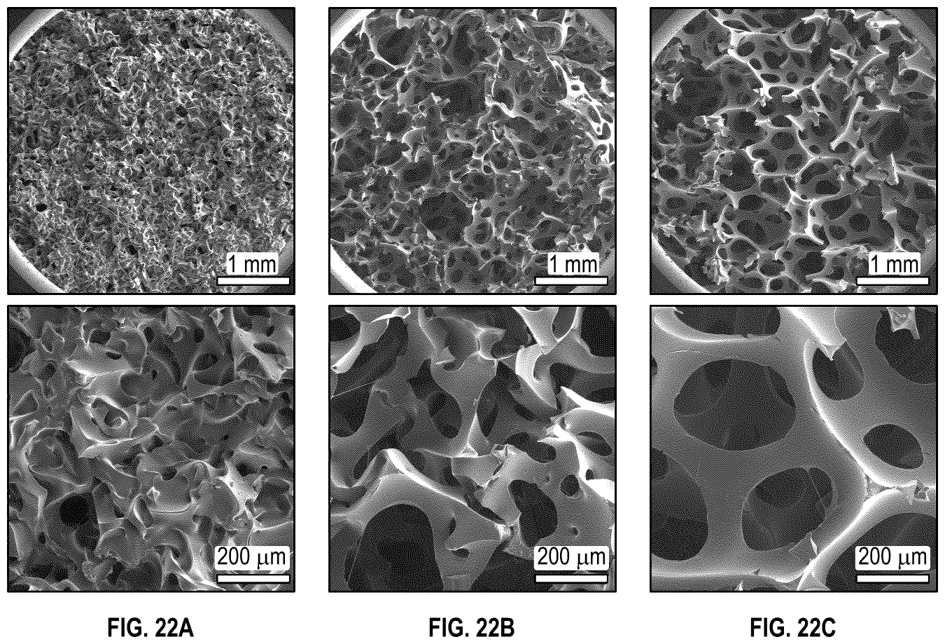

The effects of compositional variables on the gel-sheet properties are discussed herein. The main conclusions from these studies are:
1. A 3:1 ratio of ionic monomer (acrylic acid, AAc) to non-ionic monomer (acrylamide, AAm) is optimal for the gel-sheet to ensure high water absorption while retaining good strength in the swollen state. Ionic gels are known to swell more than nonionic gels (FIGS. 6A-6D). However, a pure ionic gel-sheet absorbs so much water that it is difficult to lift up by hand and to handle. Hence, the use of pure ionic gel-sheets should be avoided in some applications.
2. Foams created with the above monomers are stabilized by 0.625% of the polymeric stabilizer hmC. This concentration is sufficient to ensure that the foams remain stable during the UV polymerization. In turn, it ensures that the gel-sheet has a highly porous structure with interconnected pores.
3. PEGDA (MW of 575 Da) at 2.5 mol % of the total monomers is the optimal crosslinker concentration for obtaining soft fabriclike sheets. If the PEGDA 2102 concentration is lower, the dried sheets are sticky and SEM reveals collapsed pores (FIGS. 21A-21C, 22A-22C). If the PEGDA 2102 content is much higher, the dried sheets are stiff and absorb less water.
4. Shorter-chain crosslinkers are also possible. Examples include tetra-ethylene glycol diacrylate (TEGDA) 2101 and N,N′-methylene(bis)acrylamide (BIS) 2100. When the corresponding gels are dried, they shrink by ˜60% whereas with PEGDA 2102 as the crosslinker, the gel shrinks by less than 10% (FIGS. 21A-21C), indicating intact pores. A relatively longer chain crosslinker like the 575 Da PEGDA 2102 more easily facilitates making fabric-like sheets. See the volume change vs crosslinker type 2103 of FIG. 21B.

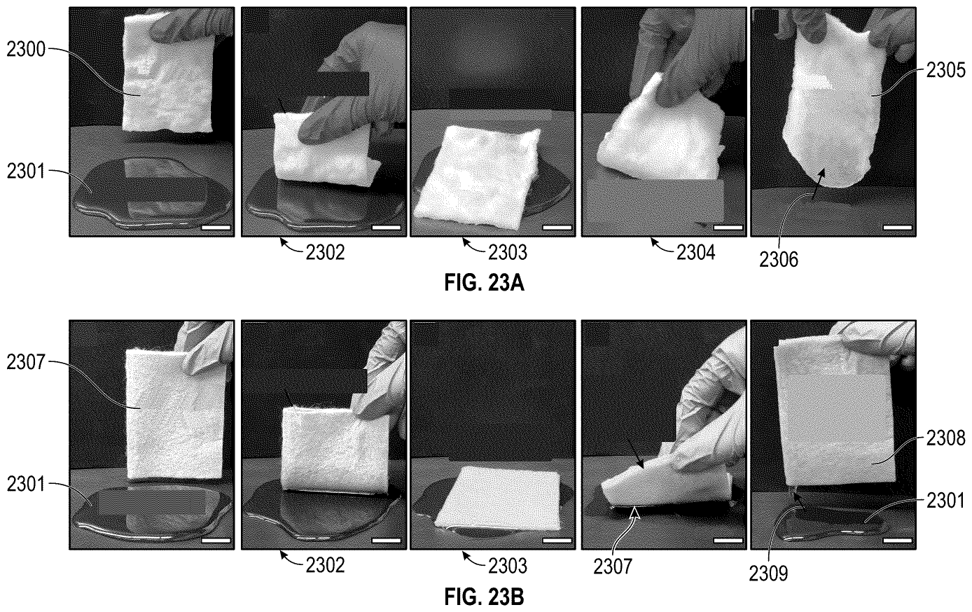

The gel-sheets 2300 have the ability to absorb liquids. First, a 25-mL spill of deionized (DI) water 2301 is created on the countertop and a gel-sheet 2300 (10×8×0.4 cm) is placed on the spill 2302 and used to absorb 2303 the liquids. FIG. 23A shows in the first four images that the gel-sheet absorbs all the spilled water 2304 within twenty seconds (20 s). The water-filled sheet 2305 remains intact and can be held up by hand (the rightmost image); note that there is no water dripping down from the sheet, as an effective water blockage 2306 has been created. For comparison, the same experiment is done with a commercially available absorbent pad (Sungbo Corp.) made of cloth. The pad is folded in two to reach the same dimensions as the sheet, and then contacted with an identical 25-mL water spill (FIG. 23B). The first four images show that the pad absorbs only some of the water: even after a minute, only an incomplete ˜60% 2307 of the initial spill is absorbed. Moreover, when the pad 2308 is lifted up, water starts dripping 2309 out of it.

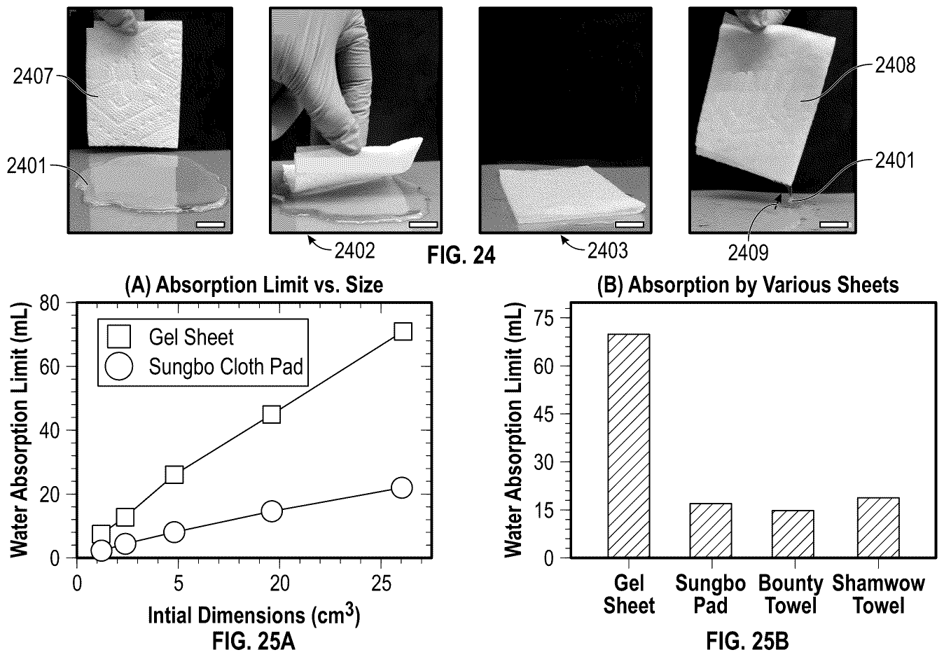

The gel and the pad were also compared with paper towels. A paper towel (Bounty® brand, made by Procter & Gamble Corp.) is again folded to dimensions of 10×8×0.4 cm and placed over a 20 mL water-spill (FIG. 24). The paper towel absorbs only 48% of the initial spill (the first three images), which is even less than the commercial pad.

Moreover, like the pad, the paper towel fails to hold onto the absorbed water: i.e., when it is lifted up, water drips out of it (rightmost image of FIG. 24). Thus, FIGS. 23A-23B and FIG. 24 show that the gel-sheet tested in FIG. 23A is superior in two ways: the gel-sheet 2300 absorbs more water, and furthermore the water is held tightly, such that there is no drip-off from the swollen sheet.

FIGS. 25A-25B further quantify the differences between the gel-sheets of the present disclosure and other absorbents. First, the gel-sheet dimensions and recorded the volume of water absorbed. Sheets with 4-mm thickness and varying sizes (3×2, 4×3, 6×4, 8×6, and 10×8 cm) were placed in DI water and allowed to attain equilibrium absorption. The saturated sheets were taken out and held vertically to remove excess water. When the dripping stopped, the sheets were weighed and the amount of absorbed water (termed the “water absorption limit” or “dripping limit”) is plotted in FIG. 25A. The same experiment is repeated with different sizes of the cloth pad (Sungbo) and those data are also plotted in FIG. 25A. The absorption limit increases with sheet size in both cases. However, the values are much higher for the gel-sheet. From the slopes of the lines in FIG. 25A, a water-absorption “capacity” is calculated of 2.2 mL/cm3 for the gel-sheet vs. 0.67 mL/cm3 for the cloth pad. When translated to a weight basis, the gel-sheet absorbs about thirty grams (30 g) of water per gram (1 g) of dry material. This is the conventional “swelling ratio” used in comparing SAP hydrogels. The weight basis can be misleading when dealing with thin sheets, and so it can be further beneficial to also compare using a size (volume) basis for the above data.

FIG. 25B compares the water absorption limit (dripping limit) of the gel-sheet and three commercial products, viz. the Sungbo pad, a Shamwow® towel, and Bounty® paper towels, all at a 10×8×0.4 cm size. Shamwow® towels are a popular commercial product and are stated to be made of chamois cloth (a type of cotton). Bounty® paper towels (tagline: “the quicker-picker-upper”) are commonly used in homes and labs. The data shows that the absorption limit of the gel-sheet is 70 mL while it is 15 to 20 mL for the others. Thus, the gel-sheet absorbs more than three times (3×) as much water as the commercial absorbents tested. The same experiment was also performed with tap water (instead of deionized water) and the absorption limit of the gel-sheet was 60 mL for this case.

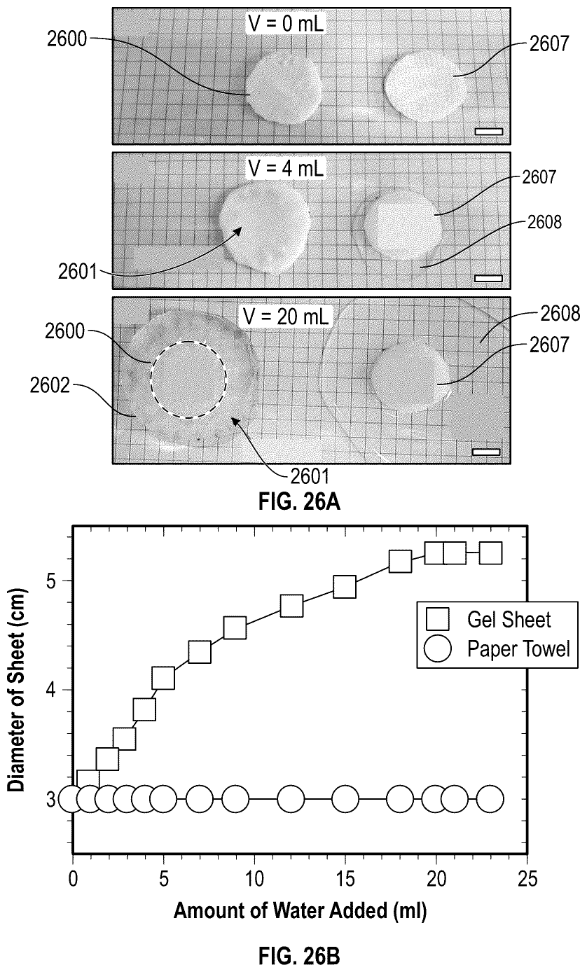

One unique aspect of the gel-sheets is that they still respond like gels—specifically, as they absorb water, they swell and expand. The swelling occurs because the anionic chains repel each other and the counterions also increase the internal osmotic pressure. In contrast, absorbents imbibe water by capillary action and do not swell. To demonstrate these differences, the gel-sheet was cut into a disc of 3-cm diameter and did the same with a Bounty® paper towel. Then water was added dropwise at the center of both discs. The gel-sheet starts expanding (FIG. 26A) and the diameter of the disc vs water amount is plotted (FIG. 26B). In contrast, the paper towel remains the same size and it gets saturated with just 3 mL of water, after which the water just pools around the disc. The gel-sheet expands by 80% in its diameter until it gets saturated at approximately twenty milliliters (˜20 mL) of water. Similar expansion is observed with the gel-sheet, regardless of the geometry. As described above, the rectangular gel-sheet of FIG. 14C expands from initial dimensions of 10×8×0.4 cm to final dimensions of 16.2×13.6×0.6 cm. Conversely, none of the commercial pads or towels expanded upon contact with water, see FIGS. 14A-B.

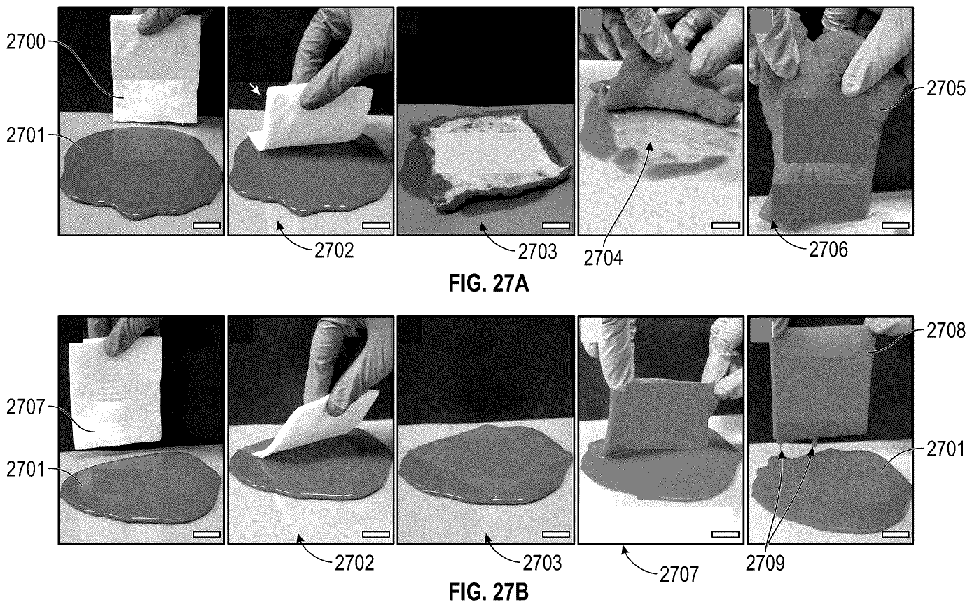

Next, absorption was tested with other liquids. One liquid of importance is blood, see Dowling et al., 2011, which has a viscosity about four times (4×) that of water. Forty milliliters (40 mL) of citrated bovine blood was poured on a benchtop and used a gel-sheet (10×8×0.4 cm) to mop up the spill. FIGS. 27A-27B demonstrate that the gel-sheet absorbs 99% of the blood within a minute (first four images). The blood-soaked sheet is then lifted up and all the blood is retained within it, i.e., there is no dripping (rightmost image). Also, note that as the sheet absorbs blood, it expands, much like in the previous case with water. For comparison, the same test was constructed with a commercially available wound dressing of the same dimensions (McKesson® 4-ply polyester/rayon nonwoven gauze). FIG. 27B shows that the gauze dressing absorbs only 55% of the blood pool (first four images). Moreover, when the blood-soaked gauze is lifted up, blood starts dripping out of it—i.e., the gauze is not able to hold the blood tightly (right image).

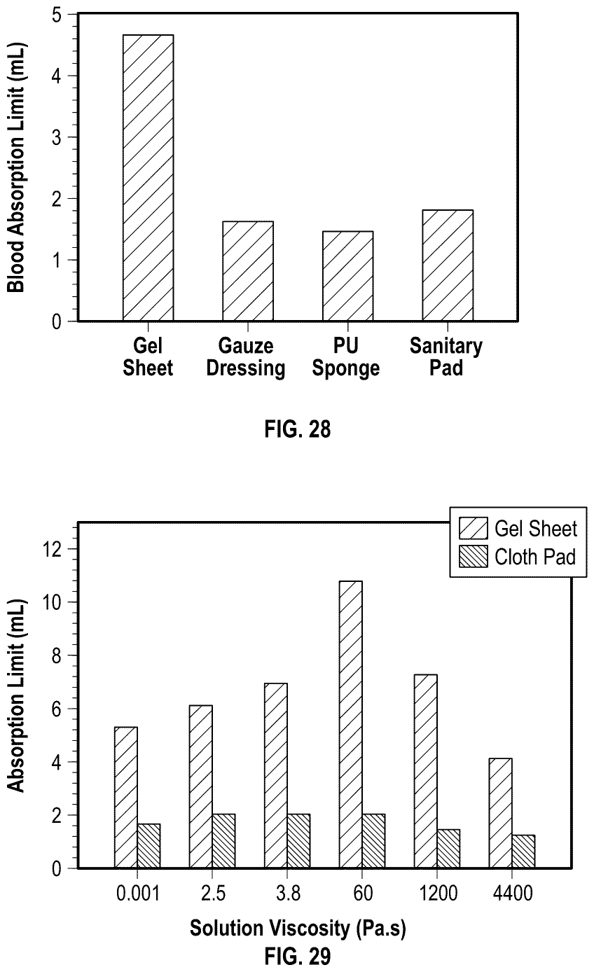

Currently many products are available for cleaning up blood from minor or traumatic wounds (dressings), during surgeries, and during menstrual bleeding (sanitary pads). Blood absorption was compared by the gel-sheet against three such products: the McKesson® gauze dressing from FIGS. 27A-27B, a sanitary pad (Always® brand, made by Procter & Gamble Corp.), and a polyurethane (PU) sponge (made by Carrand Co.). Each of the materials was cut to a size of 2×2×0.4 cm and soaked them in citrated bovine blood. Once saturated, the materials were removed and held vertically till the dripping stopped; this gives the blood absorption limit. FIG. 28 plots this quantity for the different materials. The gel-sheet absorbs 4.6 mL of blood whereas the three commercial products all absorb around 1.5 to 1.8 mL of blood. Thus, once again, the gel-sheet absorbs about 3× the blood compared to the other products.

In everyday life, spills of even more viscous liquids than blood are encountered. To test this, viscoelastic solutions of a polymer, xanthan gum (XG) in water, with the XG concentration ranging from 0.01 to 2%, were prepared. The zero-shear viscosity (η₀) of the solutions, i.e., the viscosity in the low-shear Newtonian limit, was measured by rheometry and ranged between 1 mPa·s (which is the viscosity of water) and 4400 Pa·s (which is 4 million times that of water). Note that solutions beyond an η₀ of 100 mPa·s are not only viscous but also shear-thinning. Also, even the Newtonian solutions show viscoelastic effects such as rod-climbing.

Gel-sheets of size 2×2×0.4 cm were placed in each XG solution and the absorption limit was determined in each case. For comparison, the experiments were repeated with the same size of the Sungbo pad. The results (FIG. 29) show that, regardless of the fluid rheology, the gel-sheet is able to absorb aqueous fluids. The absorbed amount actually increases with an increase in η₀ up to about 4 Pa·s and then decreases with further increase in η₀. The initial increase is because viscous liquids tend to drip less from the sheet, i.e., more of the liquid remains in the sheet. However, if the liquid is too viscous, it does not penetrate into the sheet in the first place (it forms a gooey puddle on the countertop). Still, the gel-sheet was able to absorb 4.1 mL of a XG solution having a viscosity 4 million times that of water. For comparison, the Sungbo pad only absorbed less than 1 mL of such a highly viscous fluid. Similar absorption experiments were also conducted with other viscoelastic aqueous fluids, including those based on surfactants (wormlike micelles), and the results again showed the superior absorbency of the gel-sheets.

Referring now in the collective to all of the figures from FIG. 1A to FIG. 29, the materials used in any experiments can be characterized as follows. Chitosan (medium molecular weight, 250-400 kDa, 99% deacetylated, Product Code 43020) was obtained from Primex Corp. (Iceland). Palmitic (C₁₆), decanoic (C₁₀) and lauric (C₁₂) anhydrides were purchased from TCI America. All other chemicals were from Sigma-Aldrich, including the monomers acrylamide (AAm) and acrylic acid (AAc), the crosslinkers polyethylene glycol diacrylate (PEGDA) with an MW of 575, N,N′-methylene(bis)acrylamide (BIS), the photoinitiator lithium acylphosphinate (LAP) (precise name: lithium phenyl-2,4,6-trimethylbenzoyl phosphinate), acetic acid (CH₃COOH), sodium bicarbonate (NaHCO₃) and sodium hydroxide (NaOH). All the commercial absorbents were either purchased from Amazon.com or the local supermarket including Sungbo pads, Shamwow® towels, McKesson® gauze dressing, Carrand sponge, Bounty® paper towels, and Always® sanitary pads.

Regarding the synthesis of hmC, the following procedure, adapted from work of at least one of the present inventors, was used. See Dowling et al., “A Self-Assembling Hydrophobically Modified Chitosan Capable of Reversible Hemostatic Action.” Biomaterials 2011, 32, 3351-3357; and MacIntire et al., “How Do Amphiphilic Biopolymers Gel Blood? An Investigation Using Optical Microscopy.” Langmuir 2020, 36, 8357-8366. These works are hereby incorporated by reference herein each in their respective entirety. 1 wt % chitosan was first dissolved in 0.2 M acetic acid and an equal volume of ethanol was added. The solution was then heated to 65° C. C₁₆, C₁₂ and C₁₀ anhydrides were dissolved in ethanol in separate beakers and heated to 65° C. The anhydride solutions were then added to the chitosan solution such that the stoichiometry (with respect to the amines on the chitosan) corresponded to: C₁₆ anhydride at 2 mol %, C12 anhydride at 5 mol % and C₁₀ anhydride at 10 mol %. In total, 17% of the amines on chitosan were functionalized with hydrophobic (alkyl) chains by reacting with anhydrides (the reaction is known to follow the stoichiometry). The reaction was allowed to proceed overnight or for eighteen hours (18 h), whereupon the chitosan was converted into hmC. To precipitate the hmC from this solution, the pH was increased above the pKa of chitosan (˜6.5) by adding NaOH. The precipitate was washed with ethanol several (e.g., three) times, dried, and ground into a powder.

Regarding double-barreled syringe (DBS) preparation, syringes were obtained from J Dedoes, Inc. The dimensions of the barrel and plunger of the DBS were three milliliters by three milliliters (3 mL×3 mL), while its mixing tip was a three millimeter by sixteen element) (3 mm×16 element) blunt tip. Three milliliters (3 mL) of solution was loaded into each barrel. In one barrel, a solution of monomers, crosslinker and hmC in acetic acid was loaded. In the other barrel, a solution of 0.1 wt % LAP and NaHCO₃ (dissolved to its saturation concentration at 25° C., ˜1.4 M) was loaded. This composition of the base was chosen to maximize the foam volume (note that the foam was limited by the base because the acid was in excess). The DBS was then covered with aluminum foil to avoid degradation of the photoinitiator prior to polymerization.

Regarding the synthesis of porous gels and gel-sheets, the foam including all the reaction components was injected out of the DBS into a container, as shown in FIG. 2A and FIGS. 15A. The geometry of the container was varied depending on the experimental needs. In many cases, the container was a Ziploc bag (6″×4″). The foam was spread uniformly in the container to a thickness of 0.5-1 cm and exposed to UV light for 2 min to polymerize the monomers. In the process, the foam is converted into a porous gel, with the bubbles constituting the pores. This porous gel was placed in water to remove any unreacted monomers. The water in the gel was then exchanged by placing in ethanol for two hours (2 h), followed by ambient drying overnight to give a solvent-free porous gel. Unless otherwise stated, the following composition was used in preparing the gels: a total of 25 wt % monomer, with AAc and AAm in a 3:1 weight ratio, and with BIS at 0.7 mol % with respect to the total monomer. The hmC concentration was 0.5 wt % unless otherwise stated.

Regarding gel-swelling kinetics, and for swelling studies, such as those in FIGS. 4A-4C, a porous gel (dimensions of ˜10 mm×10 mm×5 mm) was placed in deionized (DI) water and allowed to absorb water for a specific duration. The swollen gel was then removed from the water and excess liquid was wiped from the gel before measuring its weight. Afterwards, the gel was placed back into the water for another span and the weight was again measured. This procedure was repeated until the weight of the gel became constant. All swelling kinetics studies were done in replicates of at least three for each gel and the average swelling ratios are reported.

Regarding optical microscopy, a small amount of a given foam was injected onto a glass slide and allowed to sit for a few minutes. Images were then captured on a Zeiss Axiovert 135 TV inverted microscope at one hundred times (100×) magnification. Bubble size distributions were analyzed using the ImageJ program. For each foam, at least five images were analyzed to obtain the average bubble diameter.

Regarding scanning electron microscopy (SEM), the ambient-dried porous gels were further dried in a vacuum for four hours (4 h) to completely remove any residual moisture. The dried materials were cut with a sharp blade to expose the internal pore structure and then sputter-coated with gold. A Tescan GAIA FEG SEM was used to obtain images of the gels at magnifications from one hundred times (100×) to five hundred times (500×). A thin slice was cut from the gel-sheet using a sharp blade and the exposed structure was sputtercoated with gold for one minute (1 min). Images at various magnifications one hundred times (100×) to five hundred times (500×) were obtained using a Tescan GAIA FEG SEM.

Regarding tensile testing, tensile tests were performed using an Instron Model 68SC-05 instrument. Tests were conducted according to the protocol recommended by the American Society for Testing and Materials (ASTM). Gel-sheets of four millimeter (4-mm) thickness were cut into a dog-bone shape with a narrow width of fourteen millimeters (14 mm), an overall width of nineteen millimeters (19 mm) and an inner length thirty five millimeters (35 mm). Each end of the sample was covered with twenty four grit (24-grit) sandpaper and gripped between the jaws of the Instron to avoid any slippage. The sample was then stretched at a rate of 2 mm/min, and the force was recorded during this process. The data were converted to stress vs. strain plots. At least three samples were tested for each gel-sheet.

Regarding compression testing, compression experiments were performed using an AR2000 stress-controlled rheometer (TA Instruments) in squeeze-test mode. See Gharazi et al., “Nature-Inspired Hydrogels with Soft and Stiff Zones that Exhibit a 100-Fold Difference in Elastic Modulus.” ACS Appl. Mater. Interfaces 2018, 10, 34664-34673, herein incorporated by reference in its entirety. Experiments were done at twenty five degrees Celsius (25° C.) using a parallel plate geometry (forty millimeter (40 mm) diameter). Gel-sheets of thickness fifteen millimeters (15 mm) were cut to a size of twenty five by twenty five millimeters (25×25 mm) and placed between the parallel plates at the center. The piece was compressed at a constant rate of fifty microns per second (50 m/s) and the normal force was recorded during this process. This force was then converted to stress by dividing by the initial cross sectional area of the piece. The compressive strain was calculated from the gap between the plates at any instant.

Regarding rheological studies, Rheological experiments were conducted on an AR2000 stress-controlled rheometer (TA Instruments) at twenty five degrees Celsius (25° C.). A cone-and-plate geometry (two degrees (2°) cone, twenty millimeters (20 mm) diameter) was used to perform steady-shear rheology on the xanthan gum (XG) solutions. From the plots of viscosity vs. shear-rate, the zero shear viscosity of the solutions was obtained from the plateau region at low shear-rates.

Regarding absorption studies, a gel-sheet or other absorbent was cut to a specific size for these studies. A spill of water, blood, or other liquid (e.g., XG solution) was then made on the countertop. The piece was allowed to contact the spill for a pre-determined period of time (e.g., for sixty seconds (60 s)). Then the piece was held vertically to let the excess (weakly absorbed) liquid drip out. Once the dripping stopped, the soaked piece was weighed to determine the amount of liquid absorbed.

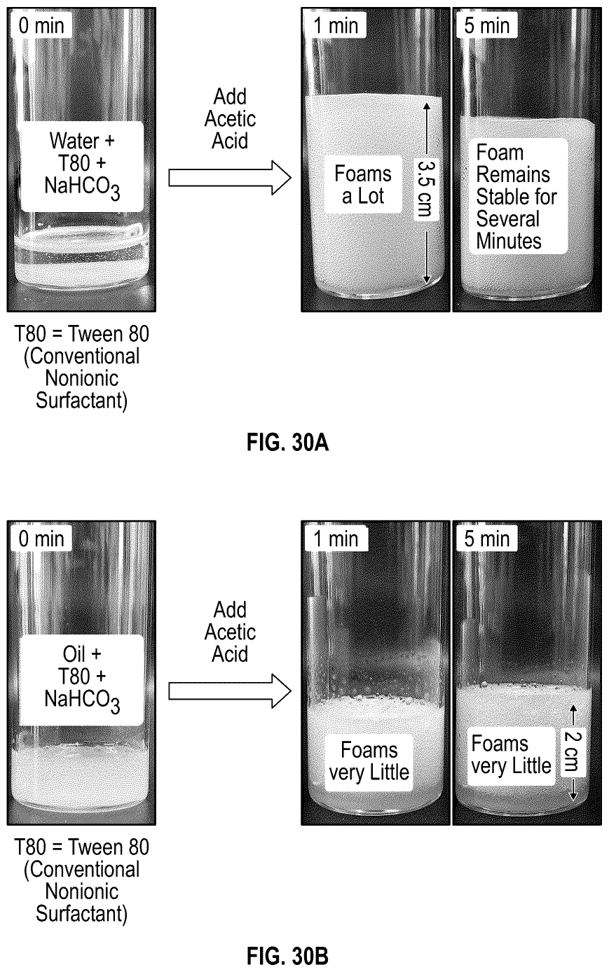

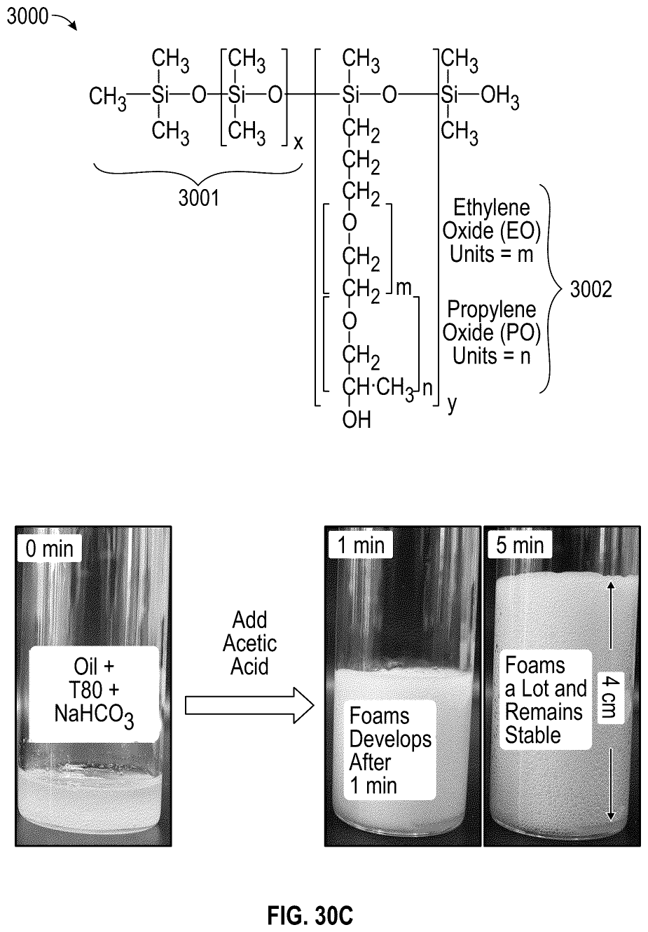

The strategy for synthesizing oleo-sheets involves templating an oil-rich foam. But foaming an oil is much harder than foaming water. This point is shown by FIGS. 30A-30C. Foams are made by mixing an acid like acetic acid (CH₃COOH) and a base like sodium bicarbonate (NaHCO₃), whereby bubbles of CO₂ are formed in situ by the reaction:

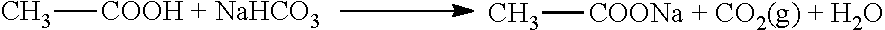

To produce a foam, the gas bubbles must be stabilized by surfactant molecules. In water, this is done easily by a variety of hydrocarbon based surfactants such as the nonionic Tween 80 (T80). For example, FIG. 30A shows a vial containing a solution of T80 in water with undissolved NaHCO₃ particles suspended in the vial. When the acid is added, a foam is quickly generated because T80 molecules adsorb on the gas bubbles and stabilize them against coalescence. Note that the foam expands and rises to a height that is 6× that of the original liquid, and this foam remains stable for several minutes.

For comparison, FIG. 30B shows an analogous scenario with a nonpolar oil, in this case dodecyl acrylate (DDA). T80 is dissolved in this oil and NaHCO₃ particles are suspended, as before. When a solution of CH₃COOH in water is added, a foam is again generated, but the foam height is much lower than in FIG. 30A. This is because T80 is not as surface-active in oil compared to water. Water has a high surface tension γ of 72 mN/m and accordingly, surfactants readily migrate to the gas-water interface, where they reduce γ. In comparison, oils are much lower (˜30 mN/m), and therefore conventional surfactants like T80 are less likely to migrate to the gas-oil interface. To foam the oil, silicone surfactants are used. Although there are far fewer academic studies with these surfactants, they are used as additives in making polyurethane foams. Such surfactants are commercially available from companies like Dow Chemical, but these companies aim to keep the chemical structures of these surfactants proprietary. A structure is shown in FIG. 30C and the photos in this figure further show that when a blend of DDA, a silicone surfactant, and NaHCO₃ particles is combined with aqueous CH₃COOH, the mixture foams appreciably. The height of this oil foam is comparable to that of the aqueous foam in FIG. 30A, and this foam also remains stable for sufficient time to enable its use in the template synthesis.

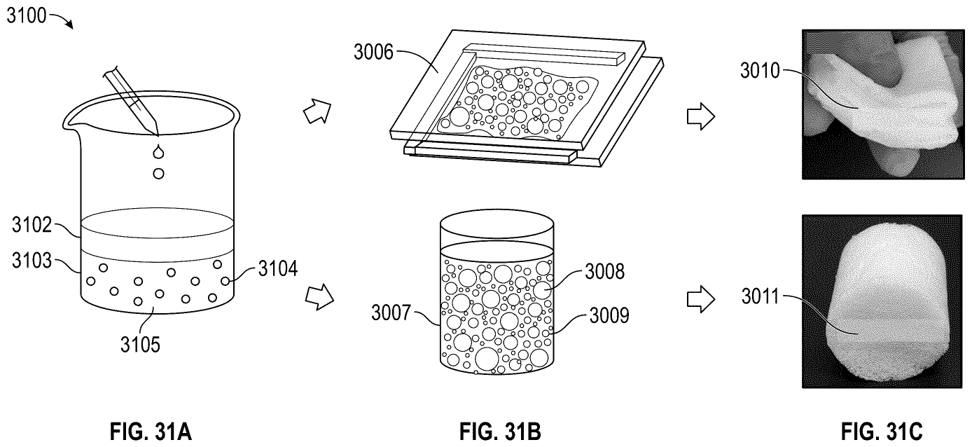

Oleo-sheet synthesis by oil-foam templating is schematically depicted in FIGS. 31A-31C. The oil phase is first made by mixing the monomers diol diacrylate (DDA) and urethane diacrylate (UDA), the initiator benzoyl peroxide (BP), the accelerator N,N′-dimethyl-para-toluidine (DMPT), the silicone surfactant Vorasurf™ DC 5164, and NaHCO₃ particles. Then, aqueous CH₃COOH are added and mixed with a spatula until the aqueous CH₃COOH starts foaming (FIG. 31A). Bubbles of CO₂ are formed in the oil phase when the acid and base come into contact. At the same time, the aqueous phase is emulsified, leading to a water-in-oil emulsion around the gas bubbles. Both the bubbles and the water droplets in the oil phase are stabilized by the silicone surfactant. This flowing foam is then poured into either a sheet or cylindrical mold (FIG. 31B) and allowed to polymerize at room temperature. In about three minutes (3 min), a crosslinked polymer network forms around the bubbles. The rapid polymerization is enabled by the use of the DMPT accelerant, and over the short time of polymerization, the foam remains stable, i.e., the bubbles do not coalesce or dissipate. Thus, a porous organogel is obtained at the end of this synthesis. This gel is washed in ethanol and water and then dried under ambient conditions to give soft solids with a near-white color (FIG. 31C). Both thin sheets, herein called oleo-sheets, as well as thicker cylinders, herein called oleo-sponges, were synthesized.

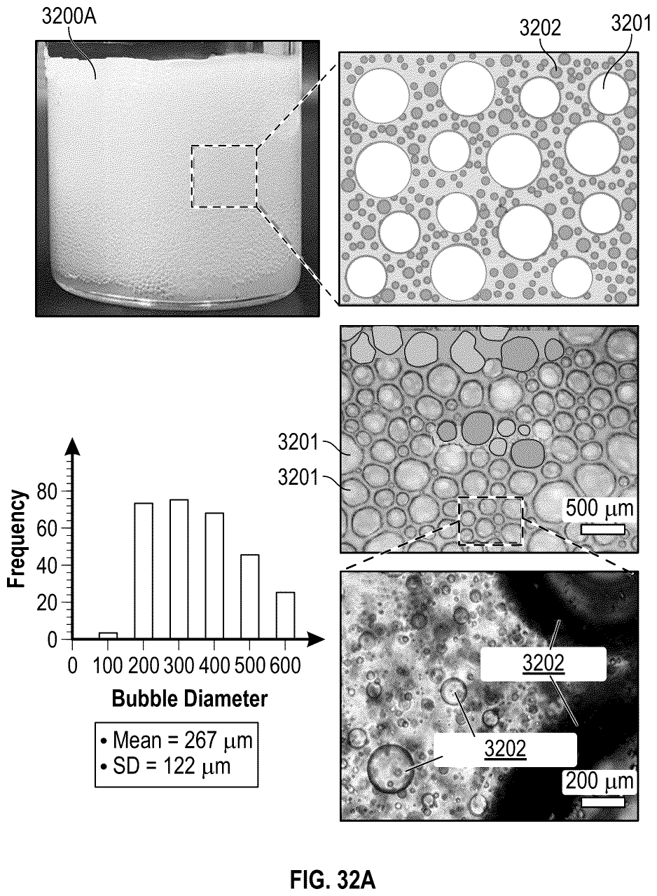

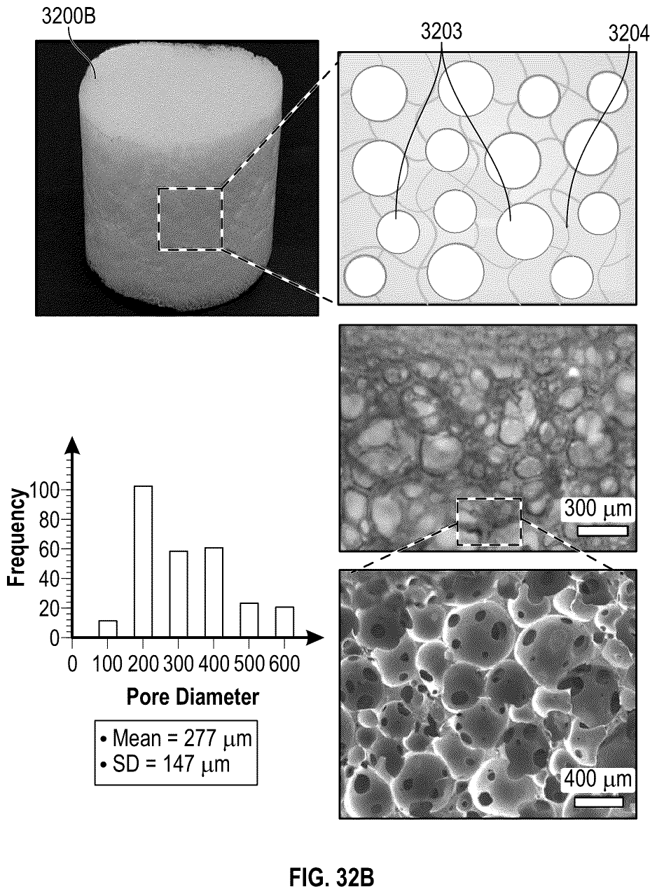

The microstructures of the oil-rich foam and the corresponding templated oleo-sponge/sheet are presented in FIGS. 32A-32C. The oil phase in the foam contains two grams (2 g) of the oily monomer (40/60 ratio DDA/UDA), one-half grams (0.5 g) of surfactant, and 0.2 g of NaHCO₃ particles. When mixed with one-half grams (0.5 g) of the aqueous phase (4.7 M CH₃CO H), the foam is produced. FIG. 32A shows an image of this foam (upper left image) as well as a schematic (upper right image) and optical micrographs (middle right and lower right images). As expected, the foam has a high volume fraction of gas bubbles (middle right image), with the bubble diameter being 267±122 μm (see the size distribution in the lower left bar graph). A closer look around the bubbles (lower right image) reveals the presence of small water droplets in the oily continuous phase. Immiscible oily and aqueous phases are mixed to make the foam; thus, the final sample is a foamed emulsion. Both the smaller droplets and the larger gas bubbles are indicated in the schematic.

After polymerization, washing, and ambient drying, the bubbles are converted to pores in the oleo-sponge. FIG. 32B shows a photo of this sponge (upper left image), a schematic of its structure (upper right image) and micrographs from optical (middle right image) and scanning electron microscopy (SEM) (lower right image). Both the micrographs reveal the porous nature of the sample. The SEM shows that the pores are interconnected, and a size distribution of the pores is shown in the lower left bar graph. Most pores are in the range of 200-400 μm, with the average pore diameter being 277 μm with a standard deviation of 147 μm. Note that the pore sizes are quite comparable to the bubble sizes in FIG. 32B, indicating that the majority of bubbles in the foam have been locked in as pores in the dried sponge. The porosity ε_{sponge} of the dry oleo-sponge can be estimated from density measurements:

$${ε}_{sponge} = 1 - \frac{{ρ}_{sponge}}{{ρ}_{bulk}}$$

where ρ_{sponge} is the density of the dry gel and ρ_{bulk} is the density of the bulk, non-porous solid. E_{sponge} was calculated to be 88%, indicating that the sponge is highly porous.

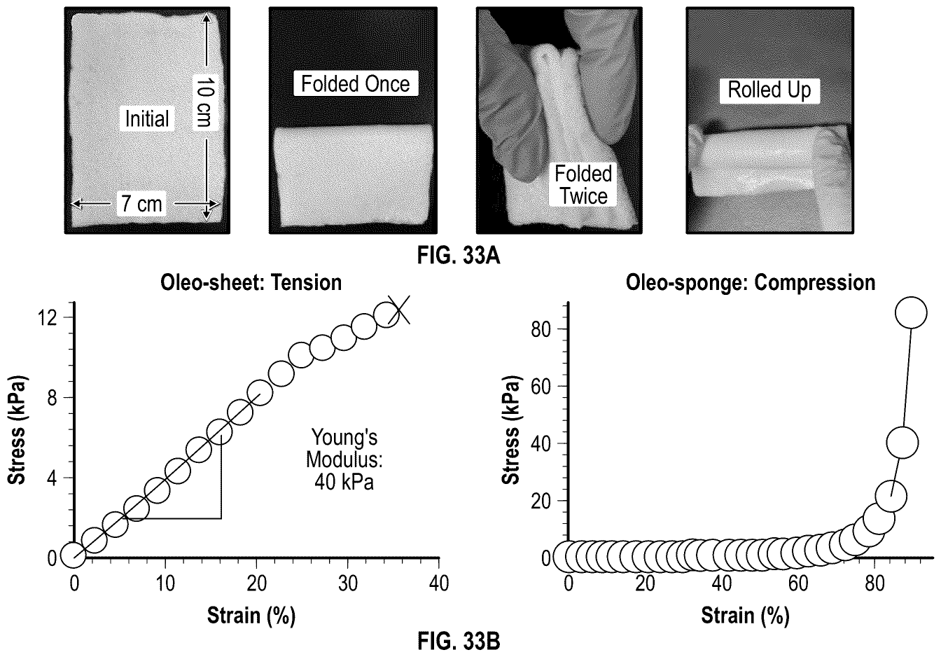

According to some embodiments, the oleo-sheet/sponge's tactile and mechanical properties are described as follows. Both the oleo-sheet and oleo-sponge are soft, yet robust materials, as shown by FIGS. 33A-33B. The oleo-sheets can be ten centimeters by seven centimeters (10 cm×7 cm) in linear dimensions, while their thickness is approximately four millimeters (˜4 mm). As revealed in FIG. 33A, the sheets can be folded, bent, twisted or rolled up multiple times, much like a cloth or paper towel. The mechanical properties of the sheet were measured under tension. The sheet was cut into a dog-bone shape with a width of fourteen millimeters (14 mm) in the narrow region and an inner length of thirty five millimeters (35 mm). The tensile stress versus strain was measured for this sample and the data (FIG. 33B) indicate a tensile strength (i.e., the stress at break) of twelve kilopascals (12 kPa) and a strain at break of thirty five percent (35%). From the slope in the linear portion of the stress-strain curve, the tensile modulus is found to be forty kilopascals (40 kPa).

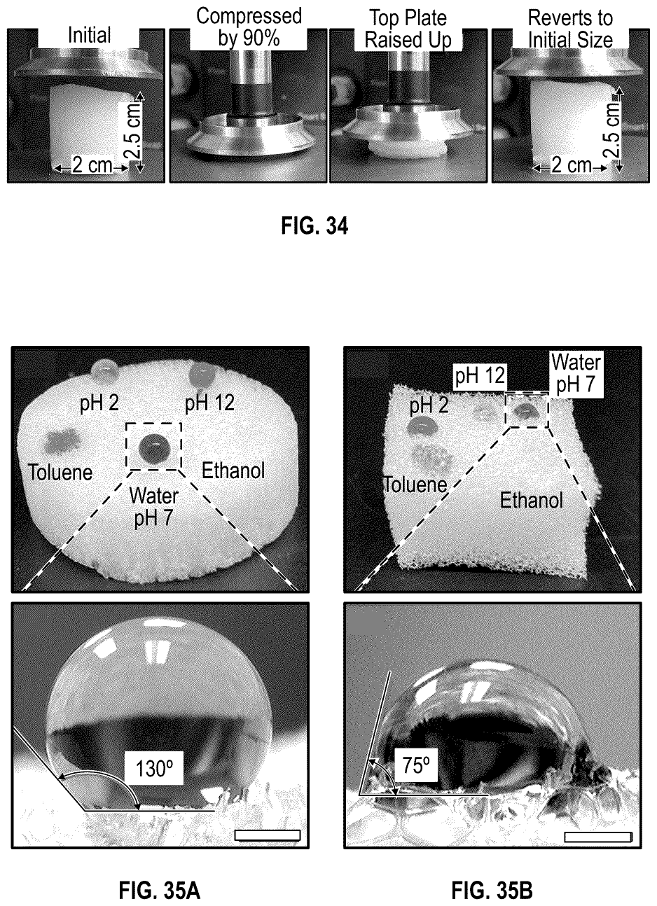

Oleo-sponges can be cylinders of one to four centimeters and between two and five centimeters in length. The mechanical properties of the sponge were tested under compression. A sponge of a diameter of two centimeters (2 cm) and a length of two and a half centimeters (2.5 cm) was compressed at a rate of 50 μm/s and the stress vs strain plot in FIG. 33B shows that the sponge can be compressed by 90% without failure. Moreover, upon releasing the stress, the sponge recovers instantly to the initial dimensions of the sponge. This is also shown visually by the images in FIG. 34. Even after several such compression-release cycles, the material remains intact and unchanged.

The robust mechanical properties measured above are due to the monomers chosen to make the oleo-sheet/sponge. The monomer mixture used is 40/60 DDA/UDA. Both DDA and UDA are oil-like (water-insoluble) liquids. DDA, due to the dodecyl chains, confers oleophilic properties to the network. The UDA molecule has a long urethane mid-segment with a molecular weight (MW) of 4858 Da and acrylate groups at each end—thus the oligomeric UDA acts as a long and flexible cross-linker between the junctions in the polymer network. The DDA/UDA combination thus gives a flexible, elastomeric network around the pores, which is key to the materials reported in this paper.

Oleo-sheet/sponge oleophilicity and selective oil absorption can be described as follows. In FIGS. 35A-35B, the surface properties of the oleo-sponge are compared with a polyurethane (PU) sponge that is commonly used for cleaning. Droplets (5 μL) of various liquids are placed on the oleo-sponge (FIG. 35A) and the PU sponge (FIG. 35B). Each liquid is dyed a different color for easy identification. Deionized (DI) water, acidic (pH 2) water, and basic (pH 12) water were found to bead up on the oleo-sponge, indicating that they are repelled by its surface (upper image of FIG. 35A). A close-up of a DI water droplet (lower image of FIG. 35B) on the sponge shows that the contact angle is 130°, which is much higher than the 90° cut-off at which a surface is deemed hydrophobic (i.e., not wetted by water). Together, the images of FIG. 35B indicate that the oleo-sponge is strongly hydrophobic. On the other hand, toluene (a non-polar liquid) and ethanol (a partially polar liquid) both show strong affinity for the oleo-sponge—both liquids are instantly imbibed into the pores of the sponge and their contact angles cannot be measured. Thus, the oleo-sponge is both oleophilic (oil-loving) and hydrophobic (water-hating). Comparatively, in the case of the PU sponge (upper image of FIG. 35B), toluene and ethanol do wet its surface and get absorbed instantly. However, aqueous droplets also wet its surface and they eventually get absorbed as well. The close-up of a DI water droplet on the PU sponge (lower image of FIG. 35B) shows that its contact angle is 75°, which is below the 90° cut-off. Thus, the PU sponge is both hydrophilic and oleophilic.

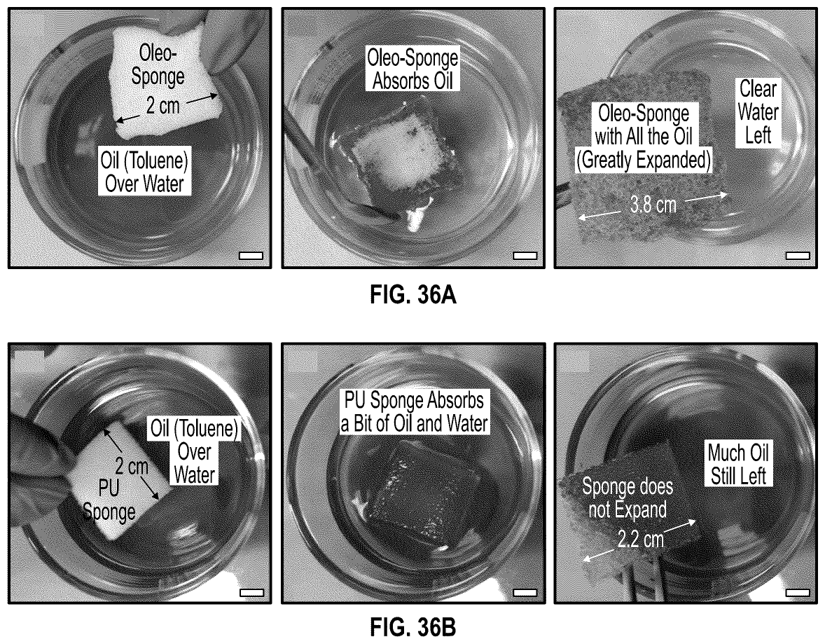

The differences between the oleo-sponge and the PU sponge are brought out clearly by the experiment in FIGS. 36A-36B, where the two are compared for their ability to absorb oil from water. Identical pieces of the two sponges (2×2×0.6 cm) were taken. Fifteen milliliters (15 mL) of a non-polar oil (toluene) colored with Oil Red dye was added to forty milliliters (40 mL) of DI water in a Petri dish. The oil is immiscible with the water forming a distinct red layer on top. FIG. 36A shows the experiment with the oleo-sponge, which is immersed into the liquids in the Petri dish at t=0 (left image of FIG. 36A). Within two seconds (2 s), all of the oil is absorbed by the sponge and removed from the water (middle image of FIG. 36A), and as a result, only the colorless water is left behind (right image of FIG. 36A). For comparison, an identical experiment with the PU sponge is shown in FIG. 36B. In this case, when the sponge is dipped in the liquids (left and middle images of FIG. 36B), the sponge absorbs only some of the oil even after a long time. Thus, the liquid remaining in the Petri dish still has a red oil layer floating atop the water (right image of FIG. 36C).

The above results are consistent with the surface properties of the sponges from FIGS. 35A-35B. The oleo-sponge is strongly hydrophobic and therefore is able to exclude water; at the same time, its oleophilicity and the interconnected pores allow the oleo-sponge to selectively absorb oil. The PU sponge appears similar to the oleo-sponge in texture and mechanical properties, but the PU sponge has an affinity to both water and oil and thus absorbs both kinds of liquids. This is the reason why the PU sponge does not selectively remove the oil from the water in FIGS. 36A-36B, whereas the oleo-sponge does.

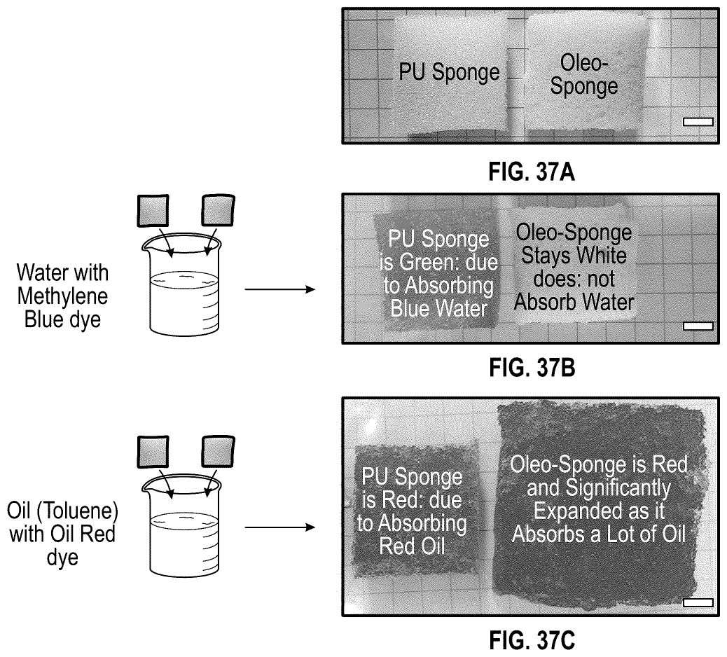

To substantiate this point, both sponges were separately immersed in water dyed with methylene blue. The results are shown in FIGS. 37A-37C. The initial PU sponge is yellow (FIG. 37A). After dipping the sponge in water, the sponge exhibits a green color due to absorption of the blue-colored water (FIG. 37B). The oleo-sponge is white (FIG. 37A). When immersed in blue water, the oleo-sponge does not absorb any of the water and thus it remains white with no blue tinge (FIG. 37B).

The oleo-sponge expands as the oleo-sponge absorbs oil. Each dimension of the oleo-sponge nearly doubles as the oleo-sponge absorbs toluene. For example, the initial width in the left image of FIG. 37A is two centimeters (2 cm), whereas the width after absorbing toluene in the right image of FIG. 37A is three and eight tenths centimeters (3.8 cm). Altogether, the final volume V_{f} of the oil-swollen sponge is six and two tenths (6.2×) its initial volume Vᵢ, i.e., the volume ratio V_{f}/Vᵢ=6.2. Such quick expansion is not possible with sponges known in the art. As a comparison, the PU sponge in FIG. 37B shows only a small change in size upon toluene absorption (compare the left and right images of FIG. 37B), and its volume ratio V_{f}/Vᵢ=1.4. The size difference is also evident from FIG. 37C, where the PU sponge and the oleo-sponge are shown side-by-side after absorbing toluene. The same expansion is also observed with the oleo-sheets and is discussed infra. The expansion in volume (i.e., swelling) of a sponge or sheet after absorbing oil indicates that there are two modes by which liquid (oil) is absorbed by the oleo-sponge. First, the liquid enters the pores by capillary action. Second, the liquid swells the polymer network that exists around the pores in the oleo-sponge. This swelling is osmotically driven, i.e., when a dry network is immersed in a favorable solvent, the osmotic gradient (positive entropy of mixing) induces the solvent to flow into the network. The swelling continues until the chains in the swollen network become too stretched, whereupon the entropic penalty from chain stretching opposes further swelling, and an osmotic equilibrium is then reached.

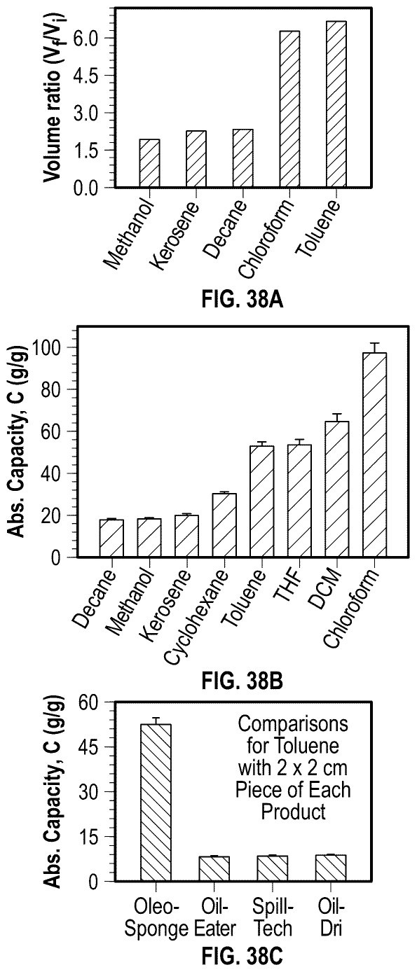

From the above discussion, the extent to which the oleo-sponge swells will depend on the liquid being absorbed. The more favorable the interactions between the liquid and the polymer backbone of the sponge (i.e., the DDA/UDA network), the more the sponge will swell. The oleo-sponge was examined in various liquids. The volume ratio V_{f}/Vᵢ was recorded in each case. In all cases, a two centimeters by two centimeters by six tenths centimeters (2 cm×2 cm×0.6 cm) piece of the oleo-sponge was left to equilibrate in a given liquid and its final volume V_{f} was measured. FIG. 38A shows that the volume ratio is around two (2) in methanol, kerosene and decane, while it is around six (6) in toluene and chloroform. This suggests that the latter two liquids are the most compatible with DDA/UDA, i.e., where the polymer-solvent interaction parameter χ is lower.

When a sponge or other absorbent is used to absorb a liquid, one parameter that is often cited in scientific literature is the gravimetric absorption capacity C, which is the ratio (in g/g) of swollen weight to dry weight. This parameter is shown in FIG. 38B for the oleo-sponge in various liquids. In all cases, a two centimeters by two centimeters by six tenths centimeters (2 cm×2 cm×0.6 cm) piece of the oleo-sponge was equilibrated in a given liquid and the weight of the swollen sponge was measured. The oleo-sponge absorbs around twenty (20) g/g of aliphatic oils like decane and kerosene, while in tetrahydrofuran (THF) and toluene, the capacity C is even higher at approximately fifty five (˜55) g/g. The highest C is for chloroform, at ninety (90) g/g.

The oleo-sponge was compared with commercially available oil absorbents. Absorbent pads or sheets marketed specifically for use with oils were purchased: Oil Eater®, SpillTech®, and Oil-DRI®. The comparison was done with toluene using 2×2 cm pieces cut from the above products (their thicknesses were 0.4 to 0.6 cm). FIG. 38C shows the comparison in terms of the absorption capacity C. While the oleo-sponge absorbs fifty-five (55) g/g of the oil, the three commercial products absorb much less of the same (C<10 g/g). Thus, the absorption is around 5× higher with the oleo-sponge and only the oleo-sponge expands upon oil absorption.

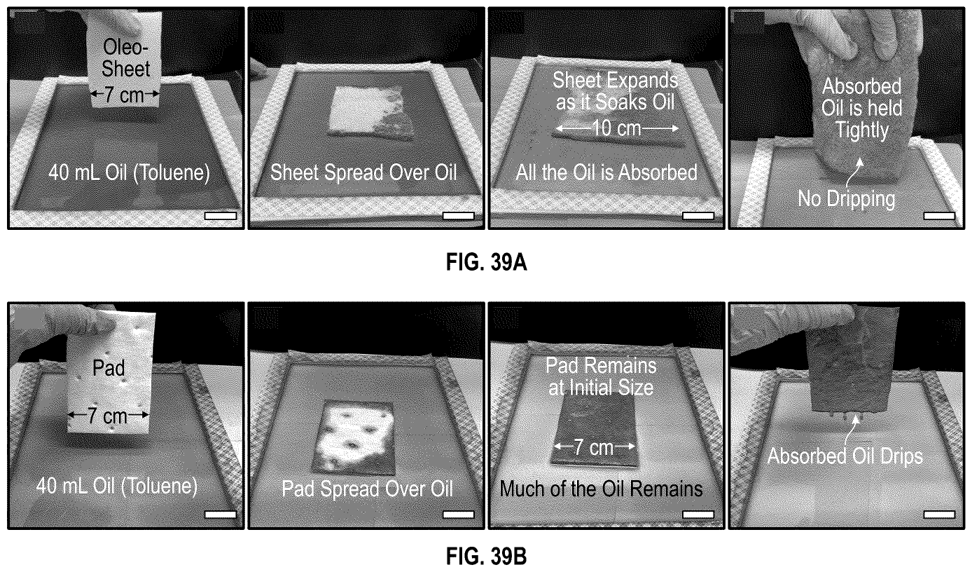

Likewise, a comparison between an oleo-sheet and one of the above products, the Oil Eater® pad was also conducted. Both the oleo-sheet and the Oil Eater® pad are large, thin sheets having dimensions of ten centimeters by seven centimeters by four tenths of a centimeter (10 cm×7 cm×0.4 cm). This comparison is more relevant for clearing a large spill of oil and the results are shown in FIGS. 39A-39B. Forty milliliters (40 mL) of toluene was poured onto a glass trough, thereby creating a pool of oil that is colored red due to Oil Red dye. In FIG. 39A, the oleo-sheet is used to mop up this oil spill. The sheet is spread around the spill and it quickly absorbs all the oil (FIGS. 39A-39C). Note that there is no red liquid remaining in the trough at the end (first three images of FIG. 39A). Thereafter, the swollen sheet is lifted up by hand (fourth image of FIG. 39A): the oleo-sheet is strong even in the swollen state, and moreover, none of the oil drips out of the sheet. When the same experiment is repeated with the Oil Eater® pad (FIG. 39B), the pad only absorbed about forty percent (40%) of the forty milliliter (40 mL) spill (first three images of FIG. 39B). The red liquid remains in the trough in this case (third image of FIG. 39B). Even this much oil is not held tightly: when the pad is lifted up, the oil drips out (fourth image of FIG. 39B). Note also the size difference. The width of the oleo-sheet increases from seven centimeters (7 cm) initially (first image in FIG. 39A) to ten centimeters (10 cm) at the end (third image of FIG. 39A). On the other hand, the Oil Eater® pad has the same width of seven centimeters (7 cm) both initially (first image of FIG. 39B) as well as at the end (third image of FIG. 39B). Thus, the oleo-sheet is the first example of a thin fabric-like material that expands as the oleo-sheet absorbs oil.

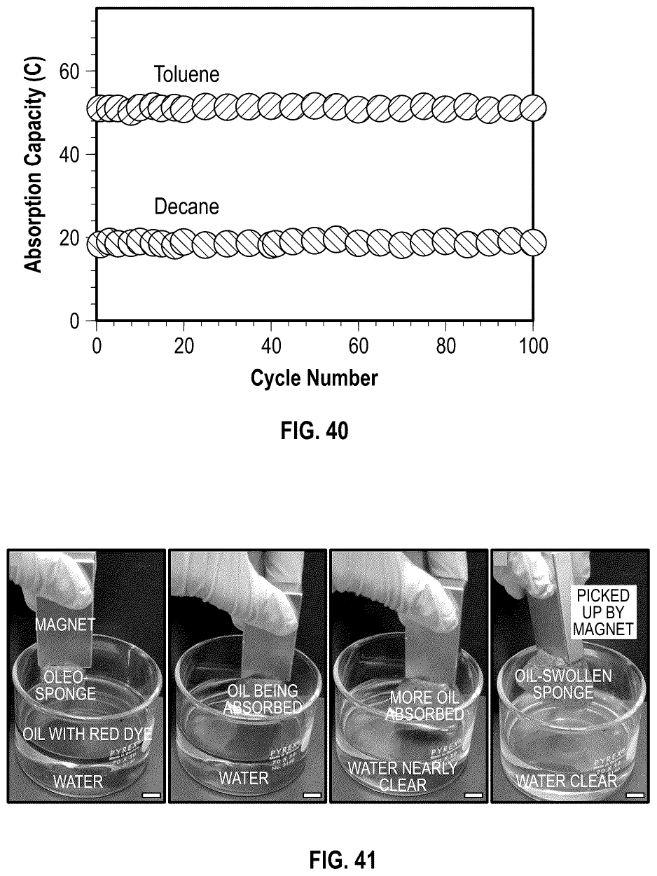

Further aspects relevant to oil absorbents are reusability and recyclability. These aspects were tested with the oleo-sponges and the results are shown in FIG. 40. An oleo-sponge was immersed in toluene, taken out, and the absorption capacity C was measured. Then, the solvent was squeezed out and the experiment repeated. FIG. 40 shows that C remains the same in toluene for one hundred (100) cycles, and this is also the case in decane. Thus, the capacity to absorb oil remains unchanged after repeated use(s). The contact angle with water on the oleo-sponge after one hundred (100) cycles was measured, and the value was again one hundred thirty degrees (130°), which was the same value reported in FIGS. 35A-35B. Thus, the surface properties also remain unchanged after cyclical swelling and squeezing. Also, the oleo-sponge is robust enough to withstand so many squeezing and reswelling cycles.

The oleo-sponges and oleo-sheets can also be endowed with other interesting properties. For example, oleo-materials can be made magnetic. To achieve this, 5% Fe₂O₃ nanoparticles (NPs) were dispersed in the oil phase (DDA/UDA) used in the synthesis. All other compositions and steps remained the same. The resulting oleo-sponge has a brown color and is responsive to an external magnet (FIG. 41), indicating that the ferromagnetic NPs are embedded in the polymer matrix of the sponge. The sponge is then brought into contact with a layer of oil (toluene dyed red with Oil Red) atop water (left image of FIG. 41). The magnetic oleo-sponge absorbs the oil (middle image of FIG. 41) and in the process expands much like the regular oleo-sponge. Once all the oil has been absorbed (no red color in the Petri dish), the swollen sponge is lifted with an external magnet (right image of FIG. 41). The sponge retains all of the oil, i.e., none of the oil drips out. This ability to use an external magnetic field to remove floating oil could be particularly useful if the oil is toxic or hazardous. Oil collection could be done by a machine or robot that could be operated remotely.

In summary of FIG. 30A to FIG. 41, oil-absorbing oleo-sheets and oleo-sponges can be created using templating organofoams. Foam-templating has been used widely with aqueous foams, but the foam templating is difficult to execute with oil-based foams because those cannot be stabilized with ordinary surfactants. Here, a silicone surfactant is used to create a stable organofoam of CO₂ bubbles. Monomers in the oil phase are then polymerized rapidly by UV light around the bubbles, and the resulting materials are then dried at room temperature to produce porous oleo-sheets and oleo-sponges. The ability to make such soft and hydrophobic materials at macroscopic sizes is a key innovation. The oleo-sheets/sponges especially offer fabric-like convenience as they can be folded or rolled up. When contacted with oil in the presence of water, the oleo-sheets/sponges selectively absorb the oil and remove it from the water surface. The materials expand as they absorb oil, which is a remarkable feature not found in any other oil-absorbing pads. A variety of non-polar solvents, including toluene, chloroform, and dichloromethane can be absorbed, and the absorption capacity exceeds 50 g/g. A magnetic oleo-sponge can absorb oil and can be lifted off the surface by a magnet.

The oleo-sheets were compared with commercial products (macroscopic pads) that claim to be effective at absorbing oil. The oil-absorption capacity of the oleo-sheets is five times (5×) those of commercial pads, and absorbed oil is retained in the sheets without dripping. Also, conventional sponges made of polyurethane (PU) as well as towels of paper or cloth are partially hydrophilic and thus not suitable for absorbing oil. Oleo-sheets can therefore be used in homes and labs to clear spills of nonpolar liquids. The approach to making these sheets described herein is scalable. Thus, much larger sheets could be made and those could be applied to remediate oil spills on water bodies, including water tanks, ponds, lakes, and oceans. Current absorbents intended for use with oil spills are in the form of powders, and their practical use is limited by the difficulty of skimming oil-soaked powders off from a water body.

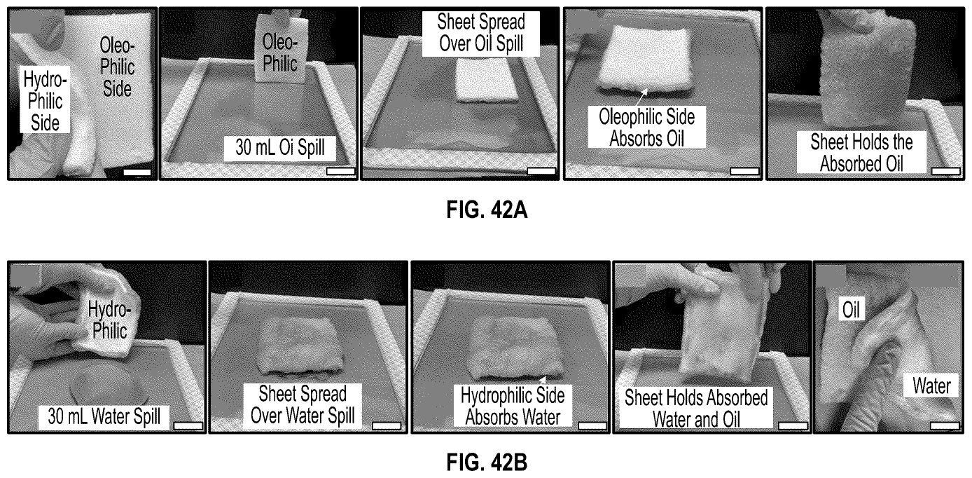

FIGS. 42A-42B show an omni-sheet, which can absorb both oil and water using the aspects discussed supra. The single ‘omni-sheet’ (‘omni’ meaning ‘all’) can be universally used to absorb all kinds of liquids regardless of their polarity. There appear to be no prior attempts in the art to make such a material, even at a length scale smaller than a sheet. Here, FIGS. 42A-42B show a way to make such an omni-sheet by sandwiching together an oleo-sheet and a hydrophilic gel-sheet. The two sides of the omni-sheet were formed using a foam-templating approach similar to that described FIGS. 1A-1C, FIGS. 15A-15C, and FIGS. 31A-31C. For example, at least one of the sides can be synthesized using the hydrophilic monomers acrylamide (AAm), acrylic acid (AAc), and polyethylene glycol diacrylate (PEGDA) were polymerized around the gas bubbles in an aqueous foam. The hydrophilic gel-sheets were effective at absorbing water or aqueous fluids like blood. Here, the oleo-sheet used in FIGS. 37A-37B and a hydrophilic gel-sheet were combined into one material. Each sheet has the same dimensions (10 cm×7 cm×0.4 cm) and the two are glued together using a cyanoacrylate glue. Thus, the overall omni-sheet (see FIG. 42A, first image) has a thickness of eight tenths of a centimeter (0.8 cm) and has two sides or layers, much like a ‘Janus’ material.

The use of this omni-sheet to absorb both oil and water is shown in FIGS. 42A-42B. First, the oleophilic side of the sheet (which has a light orange hue) is put to use (FIG. 42A). This side of the sheet is brought into contact with thirty millimeters (30 mL) of oil (toluene dyed red with Oil Red) (second image of FIG. 42A). The sheet absorbs all of the oil and in the process, the oleophilic side expands (third to fifth images of FIG. 42A). None of the oil goes through to the hydrophilic side, which has a white hue. Also, both sides of the sheet remain attached during this first absorption step. Next, the sheet is flipped and its hydrophilic side is brought into contact with thirty milliliters (30 mL) of water, which is dyed blue with methylene blue (FIG. 42B, first two images of FIG. 42B). The hydrophilic side imbibes all of the water and it too expands during absorption (third and fourth images FIG. 42B). Note that this side now has a blue color due to the dye in the water. Again, the water does not seep through to the oleophilic side. At the end of the experiment, the omni-sheet has one red side (where the oil is absorbed) and one blue side (where the water is absorbed) (fourth and fifth images of FIG. 42B). The whole sheet is lifted by hand and held vertically (fourth image of FIG. 42B), and neither the water nor the oil drip out from the soaked sheet. Also, even after swelling with different solvents, the two layers of the omni-sheet remain adhered. This kind of hybrid sheet could be used for absorbing spills of all different liquids, both polar (like water) and non-polar (like oil). Depending on the polarity of the spilled liquid, the user can try the appropriate side of the sheet for absorbing the spill.

In summary of FIGS. 42A-42B, the omni-sheet or an omni-sponge could substantially revolutionize industries plagued by spills. One side of the omni-sheet or an omni-sponge selectively absorbs non-polar solvents (e.g., oils) while the other absorbs polar solvents (e.g., water). Thus, the omni-sheet can pick up any spilled liquid regardless of polarity. Applications for omni-sheets could extend to the cosmetics, automobile, and chemical industries.

Referring now in the collective to all of the figures from FIG. 30A to FIG. 42B, the materials used in any experiments can be characterized as follows. The materials used include at least monomer dodecyl acrylate (DDA) and the accelerator N,N-dimethyl-para-toluidine (DMPT) from TCI America. The monomer urethane diacrylate (UDA; tradename Ebecryl 230) was from Allnex. UDA has an aliphatic urethane segment of 4858 Da and two acrylate groups at its ends, which allow UDA to function as a crosslinker. The silicone surfactant Vorasurf™ DC 5164 was provided by Dow Chemical. The silicone surfactant is a water-insoluble liquid with a viscosity of approximately two hundred ninety millipascal seconds (290 mPa·s) at twenty five degrees Celsius (25° C.). Magnetic iron oxide (Fe₂O₃) nanoparticles were obtained from Alfa Aesar. All other chemicals were obtained from Sigma-Aldrich, including the monomers acrylamide (AAm), acrylic acid (AAc), and polyethylene glycol diacrylate (PEGDA, 575 Da); the photoinitiators lithium acylphosiphinate (LAP) and benzoyl peroxide (BP); acetic acid (CH₃COOH), sodium bicarbonate (NaHCO₃), sodium hydroxide (NaOH), chloroform, tetrahydrofuran, dichloromethane, toluene, methanol, ethanol, cyclohexane, decane, kerosene, and the dyes Oil Red and methylene blue. The neodymium magnet was obtained from K&J Magnetic. The polyurethane (PU) sponge (Carrand 40102) was obtained from Amazon. Three commercial oil-absorbent products were purchased: Oil-Eater® absorbent pads (made by Kafko International) were obtained from Amazon, and Oil-Dri QuickSorb® spill pads and SpillTech WP-M pads were obtained from Walmart.

Regarding the synthesis of oleo-sponges and oleo-sheets, the monomers DDA and UDA were mixed in a forty/sixty (40:60) ratio by weight. Then three and a half percent (3.5%) of initiator (BP) was dissolved in this mixture. Into two grams (2 g) of the above, two tenths of a gram (0.2 g) of NaHCO₃ and one half of a gram (0.5 g) of the silicone surfactant were added and mixed. The NaHCO₃ powder remains suspended in the viscous nonpolar liquid. Then one half of one milliliter (0.5 mL) of 4.7 M acetic acid and 20 μL of DMPT were added and mixed with a spatula until the sample began to foam. This foam was quickly transferred into either a cylindrical or sheet mold (FIG. 31A). For the cylindrical molds, either vials or small beakers (40 mL) were chosen. The sheet mold was made by sandwiching two rectangular glass slabs with double-sided foam tape ( 1/16 in. thick) on three sides, with the fourth side left open to pour the foam. While in the mold, the sample underwent polymerization, which was completed in approximately three minutes (˜3 min). A polymer network was formed around the gas bubbles in the foam and the liquid thereby turned into a solid. This porous solid was washed once each with water and ethanol to remove any unreacted components. Thereafter it was dried overnight at room temperature. The final dry solids are termed oleo-sponges (if made in a cylindrical mold) and oleo-sheets (if made in a sheet mold). The cylindrical oleo-sponges were one to four centimeters (1 to 4 cm) in diameter and two to five centimeters (2 to 5 cm) in height. The oleo-sheets were formed in sizes of ten centimeters by seven centimeters by four tenths of a centimeter (10 cm×7 cm×0.4 cm).

Regarding the synthesis of omni-sheets, a hydrophobic oleo-sheet and a hydrophilic hydrogel-sheet, each with dimensions of ten centimeters by seven centimeters by four tenths of a centimeter (10 cm×7 cm×0.4 cm) were taken. A cyanoacrylate-based glue (KrazyGlue) was spread on one sheet and the other sheet was pressed on the first to glue the two together. The combination was irreversibly bonded within minutes. Thus, the overall omni-sheet had a thickness of eight tenths of a centimeter (0.8 cm).

Regarding optical microscopy, optical micrographs of the foam (before polymerization) and of the dry oleo-sponge were taken using a Zeiss Axiovert 135 TV inverted microscope at one hundred times (100×) magnification. In the case of the foam, a small quantity of the foam was placed on a glass slide and this was imaged on the microscope. Five (5) such images were analyzed using ImageJ software to obtain the bubble size distribution. In the case of the oleo-sponge, a thin slice was cut using a sharp blade and the exposed surface was examined on the microscope.

Regarding scanning electron microscopy (SEM), a thin slice was cut from an oleo-sponge using a sharp blade and the exposed structure was sputter-coated with gold for one minute (1 min). Images at various magnifications (e.g., 50× to 500×) were captured using a Tescan XEIA FEG SEM. Then using the ImageJ program, five (5) images were analyzed to obtain the pore size distribution.

Regarding tensile testing, tensile tests were conducted on an Instron Model 68SC-05 instrument in accordance with protocols recommended by the American Society for Testing and Materials (ASTM). Oleo-sheets were cut into dog-bone shapes with narrow and overall widths of fourteen millimeters (14 mm) and nineteen (19 mm) respectively and an inner length of thirty five millimeters (35 mm). Each end of the sample was covered with twenty four grit (24-grit) sandpaper and gripped between the jaws of the Instron to avoid any slippage. The sample was then stretched at the rate of two millimeters per minute (2 mm/min) until the sample tore into two pieces. The recorded forces and elongations were converted to stress vs. strain plots. A total of four (4) samples were tested.

Regarding compression testing, compression tests were performed using an AR2000 stress-controlled rheometer (TA Instruments) on a forty millimeter (40 mm) parallel plate geometry in squeeze-test mode. An oleo-sponge (cylinder) of two centimeters (2 cm) diameter and length of two and a half centimeters (2.5 cm) was compressed at a rate of fifty microns per second (50 μm/s) and the normal force was recorded during this process. The normal force was then divided by the initial cross-sectional area to obtain stress. The compressive strain was calculated from the gap between the plates at any instant.

Regarding contact angle measurements, droplets of five microliters (5 μL) of the liquid to be tested were placed on the surfaces of the oleo-sponge and PU sponge. Images of the droplets at high magnification (50×) were captured using a Dino-Lite USB Digital Microscope AM4113T. At least five (5) images were analyzed using ImageJ to obtain the contact angle.

Regarding absorption studies, the solvent absorption studies shown in FIGS. 38A-38C were performed as follows. Dry pieces of the oleo-sponge (2×2×0.6 cm) were used in these experiments. The initial dimensions and weight of the oleo-sponge were recorded first. Then, the oleo-sponge was placed in a given solvent and allowed to swell. The saturated sponge was then taken out and excess solvent was allowed to drip down prior to recording the final dimensions and weight of the sponge. The volume expansion was then calculated by dividing the final volume by the initial volume. The absorption capacity was calculated by dividing the final weight by the initial weight. In each solvent, the experiment was repeated three times (3×).

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 100 | examples of expanding a porous gel to form a construct |
| 101 | water |
| 102 | gel beads (microscale) |
| 103 | swelled gel beads (microscale) |
| 104 | solid gel (macroscale) |
| 105 | swelled solid gel (macroscale) |
| 106 | porous gel (macroscale) |
| 107 | swelled porous gel (macroscale) |
| 200 | double barrel syringe (DBS) |
| 201 | first barrel (e.g., barrel containing |
| | hmC + CH₃COOH + Monomer + Crosslinker) |
| 202 | second barrel (e.g., barrel containing NaHCO₃ + |
| | Initiator) |
| 203 | foam containing monomers |
| 204 | UV light source |
| 205 | UV light |
| 206 | polymer network |
| 207 | gas |
| 208 | hmC chains adsorbed |
| 209 | porous gel |
| 210 | pores of porous gel |
| 300 | precursor foam |
| 301 | interconnected pores of dried porous gel |
| 400 | swelling process |
| 401 | dried gel |
| 402 | water |
| 403 | coin |
| 404 | clock |
| 405 | swelled gel |
| 600 | data regarding swelling ratios for gels |
| 601 | initial gels |
| 602 | swollen gels |
| 700 | data regarding swelling ratios for gels |
| 701 | initial gels |
| 702 | swollen gels |
| 800 | foam |
| 801 | interconnected pores |
| 1100 | syringe |
| 1101 | load |
| 1102 | piston |
| 1103 | initial gel |
| 1104 | expanded gel |
| 1300 | dry gel |
| 1301 | wire mesh |
| 1302 | flow (out) |
| 1303 | expanded gel |
| 1304 | water blockage |
| 1305 | free water |
| 1306 | gel beads |
| 1307 | gel beads thickened from water |
| 1500 | double syringe |
| 1501 | first barrel (e.g., barrel containing |
| | hmC + CH₃COOH + Monomer + Crosslinker) |
| 1502 | second barrel (e.g., barrel containing NaHCO₃ + |
| | Initiator) |
| 1503 | foam containing monomers |
| 1504 | bag |
| 1505 | glass slabs |
| 1506 | UV light source |
| 1507 | UV light |
| 1508 | polymer network |
| 1509 | gas |
| 1510 | hmC chains adsorbed |
| 1511 | wet gel-sheet |
| 1512 | solvent-exchange with glycerol/ethanol 15/85 |
| 1513 | dry gel-sheet |
| 1600 | gel-sheet |
| 1601 | interconnected pores |
| 1700 | gel-sheet |
| 1701 | single fold |
| 1702 | double fold |
| 1703 | triple fold |
| 1704 | unfolded state: no visible cracks or tears |
| 1705 | scissors |
| 1706 | smooth, clean out |
| 1707 | thickness (e.g., 1 mm thick) |
| 1800A | gel-sheet, initial state |
| 1800B | gel-sheet, compressed state |
| 1800C | gel-sheet, released state |
| 1801A | cotton ball, initial state |
| 1801B | cotton ball, compressed state |
| 1801C | cotton ball, released state |
| 1900 | gel-sheet, initial state |
| 1901 | gel-sheet, 85% compressed state |
| 2000 | initial gel-sheet |
| 2001 | break |
| 2002 | pieces |
| 2100 | BIS |
| 2101 | TEGDA |
| 2102 | PEGDA |
| 2103 | volume change vs crosslinker type |
| 2300 | dry gel-sheet |
| 2301 | water |
| 2302 | placed on spill |
| 2303 | water being absorbed |
| 2304 | total absorption |
| 2305 | wet gel-sheet |
| 2306 | water blockage |
| 2307 | incomplete absorption |
| 2308 | pad does not hold the water tightly |
| 2309 | water dripping |
| 2401 | water |
| 2402 | placed on spill |
| 2403 | water being absorbed |
| 2407 | paper towel |
| 2408 | towel does not hold the water tightly |
| 2409 | water dripping |
| 2600 | gel-sheet |
| 2601 | expansion |
| 2602 | expanded size |
| 2607 | gel-sheet |
| 2608 | water |
| 2700 | dry gel-sheet used as gauze |
| 2701 | blood |
| 2702 | blood placed on spill |
| 2703 | blood being absorbed |
| 2704 | near-total blood absorption (99% of blood absorbed |
| | in 60 seconds) |
| 2705 | bloody gel-sheet |
| 2706 | blood blockage |
| 2707 | 55% blood absorption |
| 2708 | bloody gauze |
| 2709 | blood dripping |
| 3000 | structure of with silicone surfactant |
| 3001 | silicone part (hydrophobic) |
| 3002 | polyether part (hydrophilic) |
| 3100 | method(s) of forming oleo absorbent materials |
| | (sheets & sponges) |
| 3101 | CH₃COOH in water |
| 3102 | aqueous phase |
| 3103 | oil phase |
| 3104 | NaHCO₃ particles |
| 3105 | monomers + initiator + silicone surfactant |
| 3106 | glass plates |
| 3107 | polymerization in a cylindrical mold |
| 3108 | air bubbles |
| 3109 | water droplets |
| 3110 | oleo-sheet |
| 3111 | oleo-sponge |
| 3200A | sample of the foam template |
| 3200B | oleo-sponge |
| 3201 | gas bubbles |
| 3202 | water droplets |
| 3203 | pores |
| 3204 | polymer network |

### Glossary

Unless defined otherwise, all technical and scientific terms used above have the same meaning as commonly understood by a person skilled in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

A “sponge-like” texture includes, at least, a texture similar to that of a soft, light, and porous substance.

A “fabric-like” texture includes, at least, a texture similar to that of a woven or felted material made from interconnected fiber-like structures.

The terms “oleo-sheet” and “oleo-sponge” as used herein can be superabsorbent oragnogels. These terms represent example shorthand ways to refer to oleophilic sheets and oleophilic sponges.

The term “incorporated by reference in its entirety” and like equivalents do not incorporate by reference any statements contradictory to the express disclosure herein. To the extent that the incorporated material is inconsistent with the express disclosure herein, the language in this disclosure controls. Incorporation by reference of any such documents shall not be considered an admission that the incorporated materials are prior art to the present disclosure or considered as material to the patentability of the present disclosure.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. An absorbent porous gel comprising:
a foam formed from an acidic solution comprising a monomer, a crosslinker, and a stabilizer and a basic solution comprising a photoinitiator;
gas bubbles; and
wherein the foam is polymerized by light to form the absorbent porous gel around the gas bubbles such that the gas bubbles form an interconnected network of pores; and
wherein the absorbent porous gel has at least one dimension of at least one centimeter and can absorb one or more fluids until an equilibrium is achieved.

2. The absorbent porous gel of claim 1, wherein the absorbent porous gel comprises a sponge-like texture.

3. The absorbent porous gel of claim 2, wherein the absorbent porous gel is a sponge.

4. The absorbent porous gel of claim 1, wherein the absorbent porous gel comprises a fabric-like texture.

5. The absorbent porous gel of claim 4, wherein the absorbent porous gel comprises a sheet.

6. The absorbent porous gel of any one of claims 1-5, wherein the monomer is an ionic monomer.

7. The absorbent porous gel of claim 6, wherein the monomer comprises acrylic acid (AAc) and acrylamide (AAm).

8. The absorbent porous gel 1 of claim 6, wherein the absorbent porous gel comprises a weight ratio of approximately 3:1 AAc:AAm.

9. The absorbent porous gel of claim 6, wherein the absorbent porous gel comprises a weight ratio of approximately 1:0 AAc:AAm.

10. The absorbent porous gel of claim 6, wherein the absorbent porous gel comprises a weight ratio of approximately 1:1 AAc:AAm.

11. The absorbent porous gel of claim 6, wherein the absorbent porous gel comprises a weight ratio of approximately 1:3 AAc:AAm.

12. The absorbent porous gel of any one of claims 1-11, wherein the stabilizer comprises amphiphilic polymer hydrophobically modified chitosan (hmC).

13. The absorbent porous gel of claim 12, wherein the hmC is between 0.1 wt % to 0.5 wt %.

14. The absorbent porous gel of any one of claims 12-13, wherein a time it takes the foam to dissipate to half its initial height (t_{1/2}) as UV polymerization is conducted is equal to or greater than twenty five minutes.

15. The absorbent porous gel of any one of claims 12-14, wherein an average bubble diameter (D_{avg}) of the gas bubbles after polymerization is between 0.5 millimeters and 1.0 millimeters.

16. The absorbent porous gel of any one of claims 1-15, wherein the crosslinker comprises a concentration of 0.2 to 7.5 mol % with respect to total monomer.

17. The absorbent porous gel of any one of claims 1-16, wherein the crosslinker comprises N,N′-methylene(bis)acrylamide (BIS).

18. The absorbent porous gel of claim 17, wherein the concentration of BIS to total monomer is approximately 0.7 mol %.

19. The absorbent porous gel of any one of claims 1-18, wherein the crosslinker comprises tetra(ethylene glycol) (TEGDA).

20. The absorbent porous gel of any one of claims 1-18, wherein the crosslinker comprises poly(ethylene glycol) diacrylate (PEGDA).

21. The absorbent porous gel of claim 20, wherein the concentration of PEGDA to total monomer is approximately 2.5 mol %.

22. The absorbent porous gel of any one of claims 1-21, wherein the absorbent porous gel retains its dry shape achieved after polymerization and at the equilibrium.

23. The absorbent porous gel of claim 22, wherein the shape comprises a cross-section selected from the group consisting of: a rectangle, a square, a triangle, an oval, and a circle.

24. The absorbent porous gel of any one of claims 1-23, wherein the absorbent porous gel weighs more than one hundred times its dry weight at the equilibrium.

25. The absorbent porous gel of claim 24, wherein the absorbent porous gel weighs more than three hundred times its dry weight at the equilibrium.

26. The absorbent porous gel of any one of claims 1-25, wherein the absorbent porous gel is at least two times its dry size at the equilibrium.

27. The absorbent porous gel of claim 26, wherein the absorbent porous gel is at least three times its dry size at the equilibrium.

28. The absorbent porous gel of any one of claims 1-27, wherein the one or more dimensions of the absorbent porous gel increases at least 10% per second until the equilibrium is achieved.

29. The absorbent porous gel of claim 28, wherein the one or more dimensions of the absorbent porous gel increases at least 20% per second until the equilibrium is achieved.

30. The absorbent porous gel of any one of claims 1-29, wherein the absorbent porous gel absorbs water at a rate of at least 10 g/g·s until the equilibrium is achieved.

31. The absorbent porous gel of claim 30, wherein the absorbent porous gel absorbs water at a rate of at least 20 g/g·s until the equilibrium is achieved.

32. The absorbent porous gel of any one of claims 1-31, wherein the absorbent porous gel achieves the equilibrium within one minute of swelling.

33. The absorbent porous gel of claim 32, wherein the absorbent porous gel achieves the equilibrium within twenty seconds of swelling.

34. The absorbent porous gel of any one of claims 1-33, wherein the absorbent porous gel comprises a porosity of more than ninety percent.

35. The absorbent porous gel of any one of claims 1-34, wherein the absorbent porous gel is responsive to pH such that a full cycle of expansion in a fluid of pH 3 and contraction in a fluid of approximately pH 10 or in ethanol can be completed within sixty seconds.

36. The absorbent porous gel of any one of claims 1-35, wherein expansion of the absorbent porous gel produces a power-density of at least 260 mW/kg.

37. The absorbent porous gel of any one of claims 1-36, wherein the absorbent porous gel forms a three-dimensional construct and the at least one dimension comprises a height, a width, and a length.

38. The absorbent porous gel of any one of claims 1-37, wherein the at least one dimension comprises a width of at least one centimeter.

39. The absorbent porous gel of any one of claims 1-38, wherein the at least one dimension is a length of at least one centimeter.

40. The absorbent porous gel of any one of claims 1-39, wherein the at least one dimension is a height of at least one centimeter.

41. The absorbent porous gel of any one of claims 1-40, wherein the at least one dimension is a thickness of at least one tenth of a centimeter.

42. The absorbent porous gel of any one of claims 1-41, wherein the absorbent porous gel has an absorption capacity of greater than 50 g/g·s.

43. The absorbent porous gel of any one of claims 1-42, wherein the absorbent porous gel has a swelling ratio greater than two hundred (R>200).

44. The absorbent porous gel of claim 43, wherein the absorbent porous gel has a swelling ratio greater than three hundred (R>300).

45. The absorbent porous gel of anyone of claims 1-44, wherein the absorbent porous gel comprises a hydrophilic hydrogel.

46. The absorbent porous gel of any one of claims 1-44, wherein absorbent porous gel comprises a hydrophobic organogel.

47. The absorbent porous gel of claim 46, wherein the hydrophobic organogel has a water contact angle of at least 130°.

48. The absorbent porous gel of any one of claims 46-47, wherein the monomer is an organofoam.

49. The absorbent porous gel of anyone of claims 1-48, wherein the absorbent porous gel comprises a hydrophilic hydrogel and a hydrophobic organogel.

50. The absorbent porous gel of any one of claims 1-49, wherein the gas bubbles comprise carbon dioxide.

51. The absorbent porous gel of any one of claims 1-50, wherein the gas bubbles are created in a water-in-oil emulsion.

52. The absorbent porous gel of any one of claims 1-51, further comprising a silicone surfactant that stabilizes the gas bubbles.

53. The absorbent porous gel of any one of claims 1-52, wherein the absorbent porous gel was solvent-exchanged prior to polymerization concluding and later dried under ambient conditions.

54. The absorbent porous gel of claim 53, wherein absorbent porous gel was solvent-exchanged in a glycerol/ethanol solution that has between five and thirty percent glycerol.

55. The absorbent porous gel of claim 54, wherein the glycerol/ethanol solution is a 15/85 glycerol/ethanol solution.

56. The absorbent porous gel of any one of claims 1-55, wherein at least one portion of the absorbent porous gel expands as the absorbent porous gel absorbs an oil.

57. The absorbent porous gel of claim 56, wherein at least one dimension expands to at least one and a half times its dry size as the absorbent porous gel absorbs toluene.

58. The absorbent porous gel of any one of claims 56-57, wherein the absorbent porous gel is magnetic.

59. The absorbent porous gel of claim 58, wherein iron oxide nanoparticles (NPs) were dispersed in an oil phase (DDA/UDA) of polymerization.

60. The absorbent porous gel of claim 59, wherein the iron oxide nanoparticles (NPs) comprise iron(III) oxide (Fe₂O₃) nanoparticles.

61. A absorbent porous gel comprising:
a foam monomer comprising diol diacrylate (DDA) and urethane diacrylate (UDA);
carbon dioxide (CO₂) gas bubbles; and
wherein the foam monomer is polymerized by light to form the absorbent porous gel around the gas bubbles such that the gas bubbles form an interconnected network of pores.

62. The absorbent porous gel of claim 61, wherein there is a forty percent to sixty percent ratio of DDA/UDA.

63. The absorbent porous gel of any one of claims 61-62, wherein an initiator comprising benzoyl peroxide (BP) begins polymerization.

64. The absorbent porous gel of any one of claims 61-63, wherein an accelerator N,N′-dimethyl-para-toluidine (DMPT) accelerates polymerization.

65. The absorbent porous gel of any one of claims 61-64, wherein a silicone surfactant stabilizes the gas bubbles.

66. The absorbent porous gel of any one of claims 61-65, wherein the monomer comprises an acid and a base.

67. The absorbent porous gel of claim 66, wherein the acid comprises acetic acid (CH₃COOH) and the base comprises sodium bicarbonate (NaHCO₃).

68. The absorbent porous gel of any one of claims 61-67, wherein after polymerization, the absorbent porous gel is washed in ethanol and water and then dried.

69. The absorbent porous gel of any one of claims 61-68, wherein the absorbent porous gel comprises an oleo-sheet.

70. The absorbent porous gel of any one of claims 61-68, wherein the absorbent porous gel comprises an oleo-sponge.

71. An absorbent porous gel comprising:
a foam monomer;
gas bubbles; and
wherein the foam monomer is polymerized by light to form the absorbent porous gel around the gas bubbles such that the gas bubbles form an interconnected network of pores;
a first side that selectively absorbs substantially non-polar solvents; and
a second side that selectively absorbs highly polar solvents.

72. The absorbent porous gel of claim 71, wherein the absorbent porous gel is formed into a sheet.

73. The absorbent porous gel of claim 71, wherein the absorbent porous gel is formed into a sponge.

74. The absorbent porous gel of any one of claims 71-73, wherein the highly polar solvents have a surface tension of at least 60 mN/m and the substantially non-polar solvents have surface tension of less than 40 mN/m.

75. The absorbent porous gel of any one of claims 71-74, wherein the highly polar solvents comprise water and the substantially non-polar solvents comprise an oil.

78. A kit comprising a plurality of absorbent porous gels according to any one of claims 1-77.

79. A system comprising a plurality of absorbent porous gels according to any one of claims 1-77, wherein the plurality of absorbent porous gels can expand, contract, and rotate in response to external stimuli.

80. The system of claim 79, wherein the system is an artificial muscle.

81. A method of forming a construct out of a rapidly expanding porous gel comprising:
in situ foaming a monomer solution by mixing an acid and a base, the acid being initially located in a first container, and the base being initially located in a second container;
generating gas at a mixing region located at a common end of the first container and the second container;
stabilizing gas bubbles in one or more of the first container and the second container; and
polymerizing the monomer solution with ultraviolet (UV) light so as to form the porous gel around the gas bubbles.

82. The method of claim 81, wherein the monomer solution comprises acrylic acid and acrylamide.

83. The method of any one of claims 81-82, further comprising expanding the porous gel after polymerization has concluded by allowing the porous gel to absorb a fluid.

84. The method of claim 83, further comprising contracting the porous gel after the porous gel has expanded.

85. The method of claim 84, wherein contracting the porous gel is accomplished by reducing the pH of the expanded, porous gel.

86. The method of claim 85, wherein reducing the pH of the expanded, porous gel is accomplished by placing the porous gel in pH 3 water.

87. The method of any one of claims 84-86, wherein contracting the porous gel is accomplished by placing the porous gel in water (at ambient pH) including a high concentration of salt (NaCl).

88. The method of any one of claims 84-86, wherein contracting the porous gel is accomplished by placing the porous gel in a watermiscible solvent.

89. The method of claim 88, wherein the watermiscible solvent comprises ethanol.

90. The method of any one of claims 81-89, further comprising drying the porous gel.

91. The method of any one of claims 81-90, wherein the first container is a first barrel of a double-barrel syringe and the second container is a second barrel of the double-barrel syringe.

92. The method of claim 91, wherein the mixing region comprises a tip of the double barrel syringe.

93. The method of any one of claims 91-92, wherein gas bubbles are stabilized at the tip of the double barrel syringe.

94. The method of any one of claims 81-93, wherein the gas bubbles are stabilized using an amphiphilic polymer.

95. The method of any one of claims 81-94, wherein the gas is carbon dioxide (CO₂).

96. The method of claim 95, wherein the porous gel is dried under ambient conditions to yield a porous solid.

97. The method of any one of claims 81-96, wherein the polymerization step takes place in a mold.

98. The method of claim 97, wherein the porous gel comprises a sponge.

99. The method of any one of claims 97-98, wherein the mold is cylindrically shaped.

100. The method of any one of claims 81-99, wherein the polymerization step takes place between two transparent plates.

101. The method of claim 100, wherein the transparent plates are glass slabs.

102. The method of any one of claims 100-101, wherein porous gel comprises a sheet.

103. The method of claim 102, further comprising using the sheet as gauze.

104. The method of any one of claims 81-103, further comprising plasticizing the monomer solution with a volatile solvent and a plasticizer.

105. The method of claim 104, wherein the volatile solvent comprises ethanol.

106. The method of any one of claims 104-105, wherein the plasticizer is selected from the group consisting of propylene glycol (PG), ethylene glycol (EG), glycerol, PEG-200 and PEG-400.

107. The method of any one of claims 101-106, wherein the porous gel is an aqueous gel and the method further comprises solvent-exchanging the porous gel in a glycerol/ethanol solution that includes between five and thirty percent glycerol.

108. The method of claim 107, wherein the glycerol/ethanol solution comprises a 15/85 glycerol/ethanol solution.

109. The method of any one of claims 81-108, wherein the acid comprises acetic acid (CH₃COOH) and the base comprises sodium bicarbonate (NaHCO₃).

110. The method of any one of claims 81-108, further comprising synthesizing another construct out of a rapidly expanding porous gel.

111. A method of using an absorbent porous gel comprising:
absorbing one or more fluids with the absorbent porous gel;
wherein the absorbent porous gel comprises the absorbent porous gel according to any one of claims 1-77.

112. The method of claim 111, further comprising allowing the one or more fluids to enter the network of interconnected pores by capillary action.

113. The method of any one of claims 111-112, further comprising swelling a polymer network that exists around the pores.

114. The method of claim 113, wherein the swelling is osmotically driven.

115. The method of any one of claims 111-114, wherein the one or more fluids is a highly polar solvent.

116. The method of any one of claims 111-114, wherein the one or more fluids is a substantially non-polar solvent.

117. The method of any one of claims 111-114, wherein the one or more fluids comprise a highly polar solvent and a substantially non-polar solvent.

118. The method of any one of claims 111-117, wherein the one or more fluids comprise water.

119. The method of any one of claims 111-118, wherein the one or more fluids comprise blood.

120. The method of any one of claims 111-119, wherein the one or more fluids comprise an oil.

121. The method of any one of claims 111-120, wherein the absorbing of the at least one or more fluids continues until an equilibrium is achieved.

122. The method of claim 121, wherein the porous gel retains its dry shape at the equilibrium.

123. The method of claim 122, wherein the shape comprises a cross-section selected from the group consisting of: a rectangle, a square, a triangle, an oval, and a circle.

124. The method of any one of claims 121-123, wherein the absorbent porous gel weighs more than one hundred times its dry weight at the equilibrium.

125. The method of claim 124, wherein the absorbent porous gel weighs more than three hundred times its dry weight at the equilibrium.

126. The method of any one of claims 121-125, wherein the absorbent porous gel is at least two times its dry size at the equilibrium.

127. The method of claim 126, wherein the absorbent porous gel is at least three times its dry size at the equilibrium.

128. The method of any one of claims 121-127, wherein the one or more dimensions of the absorbent porous gel increases at least 10% per second until the equilibrium is achieved.

129. The method of claim 128, wherein the one or more dimensions of the absorbent porous gel increases at least 20% per second until the equilibrium is achieved.

130. The method of any one of claims 121-129, wherein the absorbent porous gel absorbs water at a rate of at least 10 g/g·s until the equilibrium is achieved.

131. The method of claim 130, wherein the absorbent porous gel absorbs water at a rate of at least 20 g/g·s until the equilibrium is achieved.

132. The method of any one of claims 121-131, wherein the absorbent porous gel achieves the equilibrium within one minute of swelling.

133. The method of claim 132, wherein the absorbent porous gel achieves the equilibrium within twenty seconds of swelling.

134. The method of any one of claims 121-133, wherein when swelling continues until chains in the network of interconnected pores become too stretched, whereupon an entropic penalty from chain stretching opposes further swelling, and the equilibrium comprises an osmotic equilibrium.

135. The method of claim 134, wherein at the equilibrium, the absorbent porous gel is at least twice its dry volume and the one or more fluids comprises methanol.

135. The method of claim 134, wherein one or more fluids comprises tetrahydrofuran and the absorbent porous gel comprises a gravimetric absorption capacity of at least 50.

137. The method of claim 134, wherein at the equilibrium, the absorbent porous gel is at least twice its dry volume and the one or more fluids comprises kerosene.

138. The method of claim 137, where the absorbent porous gel comprises a gravimetric absorption capacity of at least 20.

139. The method of claim 134, wherein at the equilibrium, the absorbent porous gel is at least twice its dry volume and the one or more fluids comprises decane.

140. The method of claim 139, where the absorbent porous gel comprises a gravimetric absorption capacity of at least 20.

141. The method of claim 134, wherein at the equilibrium, the absorbent porous gel is at least six times its dry volume and the one or more fluids comprises toluene.

142. The method of claim 141, where the absorbent porous gel comprises a gravimetric absorption capacity of at least 50.

143. The method of claim 142, wherein at the equilibrium, the absorbent porous gel is at least six times its dry volume and the one or more fluids comprises chloroform.

144. The method of claim 143, where the absorbent porous gel comprises a gravimetric absorption capacity of at least 90.

145. The method of any one of claims 111-134, wherein the absorbent porous gel comprises a gravimetric absorption capacity of at least 20.

146. The method of claim 145, wherein the gravimetric absorption capacity is at least 50.

147. The method of claim 146, wherein the gravimetric absorption capacity is at least 90.

148. The method of any one of claims 111-147, further comprising drying the absorbent porous gel after the one or more fluids have been absorbed.

149. The method of any one of claims 111-148, further comprising reusing the absorbent porous gel to absorb up an additional quantity of the one or more fluids and/or to absorb a second fluid from the one or more fluids.

150. The method of any one of claims 111-149, further comprising altering the pH of the absorbent porous gel.
